(19) United States
(12) Patent Application Publication
(10) Pub. No.: US 2026/0012646 A1
(43) Pub. Date: Jan. 8, 2026

(54) SUPPLEMENTAL ENHANCEMENT INFORMATION (SEI) MESSAGE FOR GENERATIVE FACE VIDEO

(71) Applicant: Alibaba (China) Co., Ltd., Hangzhou, Zhejiang (CN)

(72) Inventors: Jie CHEN, Beijing (CN); Bolin CHEN, Kowloon Tong (HK); Yan YE, San Diego, CA (US); Shiqi WANG, Kowloon Tong (HK)

(21) Appl. No.: 19/251,203

(22) Filed: Jun. 26, 2025

Related U.S. Application Data
(60) Provisional application No. 63/667,886, filed on Jul. 5, 2024.
(60) Provisional application No. 63/742,686, filed on Jan. 7, 2025.
(60) Provisional application No. 63/773,636, filed on Mar. 18, 2025.

(51) Int. Cl. H04N 19/70; G06V 40/16; H04N 19/46

(52) U.S. Cl. CPC H04N 19/70; G06V 40/171; H04N 19/46

(57) ABSTRACT

A method for decoding a bitstream includes: receiving a bitstream and decoding, using coded information of the bitstream, one or more pictures. The decoding of the one or more pictures includes: determining whether a generative face video supplemental enhancement information (SEI) message matches with a generative network; and in response to the generative face video SEI message matches with the generative network, decoding the SEI message. The decoding of the SEI message includes: determining a face information parameter and a base picture associated with the SEI message; and reconstructing a face picture based on the face information parameter and the base picture.

### CROSS-REFERENCE TO RELATED APPLICATIONS

The disclosure claims the benefit of priority to U.S. Provisional Application No. 63/667,886, filed on Jul. 5, 2024, 63/742,686, filed on Jan. 7, 2025, and 63/773,636, filed on Mar. 18, 2025, all of which are incorporated herein by reference in their entireties.

### TECHNICAL FIELD

The present disclosure generally relates to video processing, and more particularly, to methods and apparatuses for using supplemental enhancement information (SEI) messages to perform face video generative compression.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering.

The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide methods and apparatuses for processing video data by using generative face video supplemental enhancement information (SEI) messages.

According to some embodiments, a method for decoding a bitstream includes: receiving a bitstream and decoding, using coded information of the bitstream, one or more pictures. The decoding of the one or more pictures includes: determining whether a generative face video supplemental enhancement information (SEI) message matches with a generative network; and in response to the generative face video SEI message matches with the generative network, decoding the SEI message. The decoding of the SEI message includes: determining a face information parameter and a base picture associated with the SEI message; and reconstructing a face picture based on the face information parameter and the base picture.

According to some embodiments, a method for encoding a video sequence into a bitstream includes: receiving a video sequence; and encoding one or more pictures of the video sequence by: encoding one or more face information parameters in a supplemental enhancement information (SEI) message; and encoding an identifying number indicator for identifying the SEI message and indicating whether the SEI message matches with a generative network. At least one of the one or more face information parameters is used for reconstructing a face picture using the generative network.

According to some embodiments, a method of storing a bitstream of a video includes: generating a bitstream based on an input video sequence; and storing the bitstream in a non-transitory computer-readable medium. The bitstream includes: a supplemental enhancement information (SEI) message including one or more face information parameters, in which at least one of the one or more face information parameters is used for reconstructing a face picture using a generative network; and an identifying number indicator for identifying the SEI message and indicating whether the SEI message matches with the generative network.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating an exemplary system for coding image data, according to some embodiments of the present disclosure.

FIG. 2 is a schematic diagram illustrating an exemplary encoding process of a hybrid video coding system, according to some embodiments of the present disclosure.

FIG. 3 is a schematic diagram illustrating an exemplary decoding process of a hybrid video coding system, according to some embodiments of the present disclosure.

FIG. 4 is a block diagram of an exemplary apparatus for encoding or decoding a video, according to some embodiments of the present disclosure.

FIG. 5 is a flowchart of an exemplary method for decoding a bitstream using generative face video SEI messages, according to some embodiments of the present disclosure.

FIG. 6 is a flowchart of an exemplary method for encoding a video sequence into a bitstream using generative face video SEI messages, according to some embodiments of the present disclosure.

FIG. 7 is a flowchart of an exemplary method for generating and signaling face video information, according to some embodiments of the present disclosure.

FIG. 8 is a flowchart of an exemplary method for generating and signaling face video information, according to some embodiments of the present disclosure.

FIG. 9 is a schematic diagram illustrating a neural network for generating a face picture, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) are currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recent, and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof.

The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

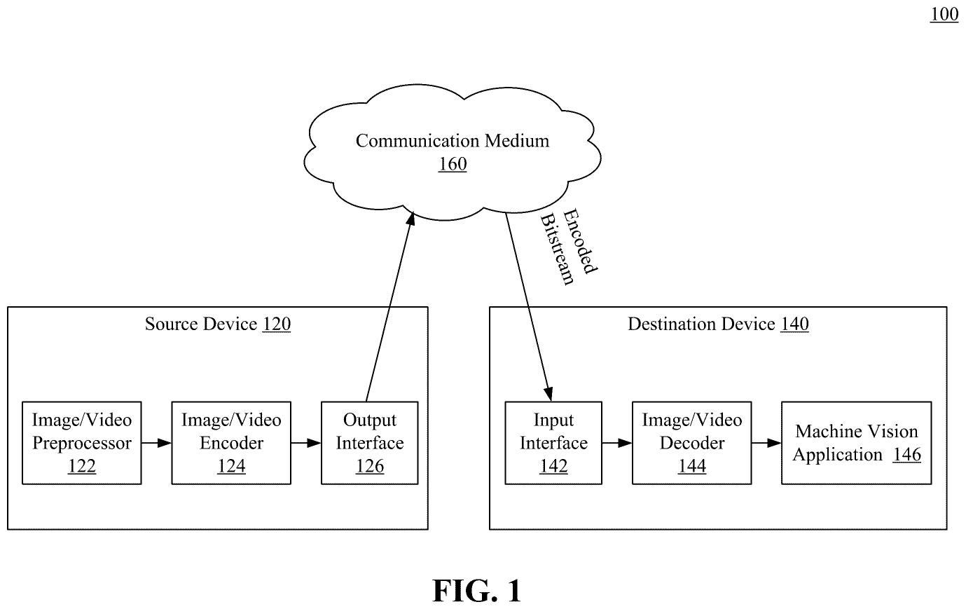

FIG. 1 is a block diagram illustrating a system 100 for preprocessing and coding image data, according to some disclosed embodiments. The image data may include an image (also called a “picture” or “frame”), multiple images, or a video. An image is a static picture. Multiple images may be related or unrelated, either spatially or temporary. A video is a set of images arranged in a temporal sequence.

As shown in FIG. 1, system 100 includes a source device 120 that provides encoded video data to be decoded at a later time by a destination device 140. Consistent with the disclosed embodiments, each of source device 120 and destination device 140 may include any of a wide range of devices, including a desktop computer, a notebook (e.g., laptop) computer, a server, a tablet computer, a set-top box, a mobile phone, a vehicle, a camera, an image sensor, a robot, a television, a camera, a wearable device (e.g., a smart watch or a wearable camera), a display device, a digital media player, a video gaming console, a video streaming device, or the like. Source device 120 and destination device 140 may be equipped for wireless or wired communication.

Referring to FIG. 1, source device 120 may include an image/video preprocessor 122, an image/video encoder 124, and an output interface 126. Destination device 140 may include an input interface 142, an image/video decoder 144, and one or more machine vision applications 146. Image/video preprocessor 122 preprocesses image data, i.e., image(s) or video(s), and generates an input bitstream for image/video encoder 124. Image/video encoder 124 encodes the input bitstream and outputs an encoded bitstream 162 via output interface 126. Encoded bitstream 162 is transmitted through a communication medium 160, and received by input interface 142. Image/video decoder 144 then decodes encoded bitstream 162 to generate decoded data, which can be utilized by machine vision applications 146.

More specifically, source device 120 may further include various devices (not shown) for providing source image data to be preprocessed by image/video preprocessor 122. The devices for providing the source image data may include an image/video capture device, such as a camera, an image/video archive or storage device containing previously captured images/videos, or an image/video feed interface to receive images/videos from an image/video content provider.

Image/video encoder 124 and image/video decoder 144 each may be implemented as any of a variety of suitable encoder or decoder circuitry, such as one or more microprocessors, digital signal processors (DSPs), application specific integrated circuits (ASICs), field programmable gate arrays (FPGAs), discrete logic, software, hardware, firmware, or any combinations thereof.

When the encoding or decoding is implemented partially in software, image/video encoder 124 or image/video decoder 144 may store instructions for the software in a suitable, non-transitory computer-readable medium and execute the instructions in hardware using one or more processors to perform the techniques consistent this disclosure. Each of image/video encoder 124 or image/video decoder 144 may be included in one or more encoders or decoders, either of which may be integrated as part of a combined encoder/decoder (CODEC) in a respective device.

Image/video encoder 124 and image/video decoder 144 may operate according to any video coding standard, such as Advanced Video Coding (AVC), High Efficiency Video Coding (HEVC), Versatile Video Coding (VVC), AOMedia Video 1 (AV1), Joint Photographic Experts Group (JPEG), Moving Picture Experts Group (MPEG), etc. Alternatively, image/video encoder 124 and image/video decoder 144 may be customized devices that do not comply with the existing standards. Although not shown in FIG. 1, in some embodiments, image/video encoder 124 and image/video decoder 144 may each be integrated with an audio encoder and decoder, and may include appropriate MUX-DEMUX units, or other hardware and software, to handle encoding of both audio and video in a common data stream or separate data streams.

Output interface 126 may include any type of medium or device capable of transmitting encoded bitstream 162 from source device 120 to destination device 140. For example, output interface 126 may include a transmitter or a transceiver configured to transmit encoded bitstream 162 from source device 120 directly to destination device 140 in real-time. Encoded bitstream 162 may be modulated according to a communication standard, such as a wireless communication protocol, and transmitted to destination device 140.

Communication medium 160 may include transient media, such as a wireless broadcast or wired network transmission. For example, communication medium 160 may include a radio frequency (RF) spectrum or one or more physical transmission lines (e.g., a cable). Communication medium 160 may form part of a packet-based network, such as a local area network, a wide-area network, or a global network such as the Internet. In some embodiments, communication medium 160 may include routers, switches, base stations, or any other equipment that may be useful to facilitate communication from source device 120 to destination device 140. For example, a network server (not shown) may receive encoded bitstream 162 from source device 120 and provide encoded bitstream 162 to destination device 140, e.g., via network transmission.

Communication medium 160 may also be in the form of a storage media (e.g., non-transitory storage media), such as a hard disk, flash drive, compact disc, digital video disc, Blu-ray disc, volatile or non-volatile memory, or any other suitable digital storage media for storing encoded image data. In some embodiments, a computing device of a medium production facility, such as a disc stamping facility, may receive encoded image data from source device 120 and produce a disc containing the encoded video data.

Input interface 142 may include any type of medium or device capable of receiving information from communication medium 160. The received information includes encoded bitstream 162. For example, input interface 142 may include a receiver or a transceiver configured to receive encoded bitstream 162 in real-time.

Machine vision applications 146 include various hardware and/or software for utilizing the decoded image data generated by image/video decoder 144. For example, machine vision applications 146 may include a display device that displays the decoded image data to a user and may include any of a variety of display devices such as a cathode ray tube (CRT), a liquid crystal display (LCD), a plasma display, an organic light emitting diode (OLED) display, or another type of display device. As another example, machine vision applications 146 may include one or more processors configured to use the decoded image data to perform various machine-vision applications, such as object recognition and tracking, face recognition, images matching, image/video search, augmented reality, robot vision and navigation, autonomous driving, 3-dimension structure construction, stereo correspondence, motion tracking, etc.

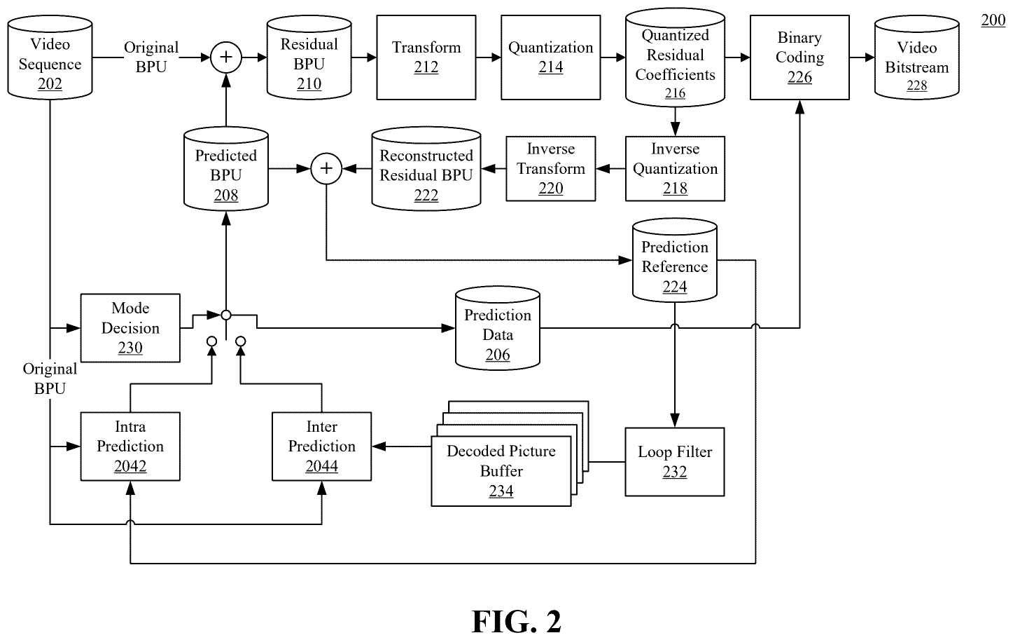

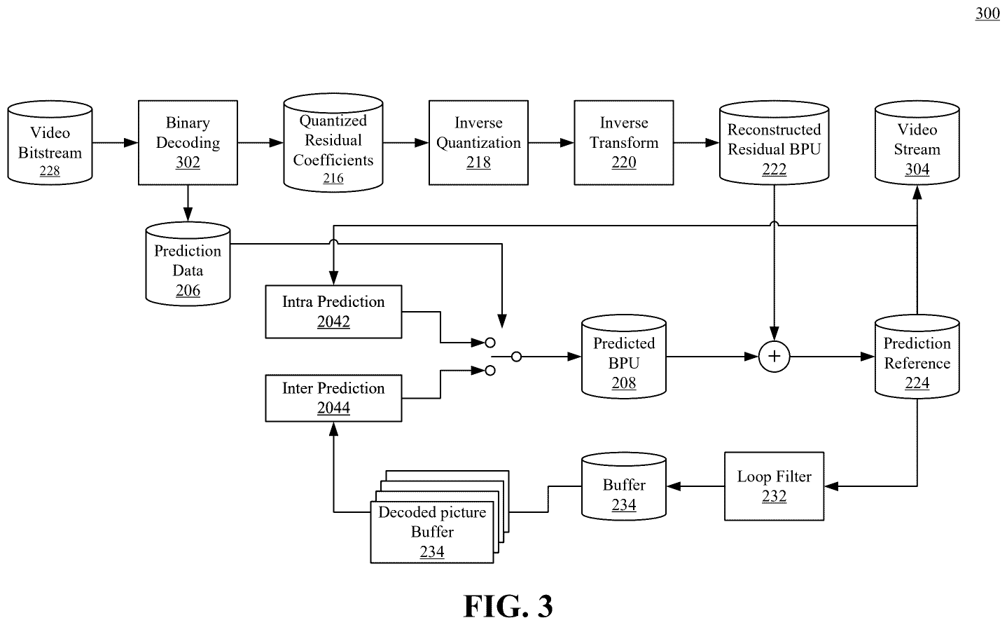

Next, exemplary image data encoding and decoding techniques (such as those implemented by encoder 124 and decoder 144 of FIG. 1) are described in connection with FIG. 2 and FIG. 3.

FIG. 2 illustrates a schematic diagram of an exemplary encoder 200 in a video coding system, (e.g., AVS3 or H.26x series), consistent with some embodiments of the present disclosure. The input video is processed block by block. In the AVS3 standard, a CTU is the largest block unit and can be as large as 128×128 luma samples (plus the corresponding chroma samples depending on the chroma format). One CTU may be further partitioned into CUs using quad-tree, binary tree, or ternary tree. Referring to FIG. 2, encoder 200 can receive video sequence 202 generated by a video capturing device (e.g., a camera). The term “receive” used herein can refer to receiving, inputting, acquiring, retrieving, obtaining, reading, accessing, or any action in any manner for inputting data. Encoder 200 can encode video sequence 202 into video bitstream 228. Video sequence 202 can include a set of pictures (referred to as “original pictures”) arranged in a temporal order. Any original picture of video sequence 202 can be divided by encoder 200 into basic processing units, basic processing sub-units, or regions for processing. In some embodiments, encoder 200 can perform process at the level of basic processing units for original pictures of video sequence 202. For example, encoder 200 can perform process in FIG. 2 in an iterative manner, in which encoder 200 can encode a basic processing unit in one iteration of process. In some embodiments, encoder 200 can perform process in parallel for regions of original pictures of video sequence 202.

Components 202, 2042, 2044, 206, 208, 210, 212, 214, 216, 226, and 228 can be referred to as a “forward path.” In FIG. 2, encoder 200 can feed a basic processing unit (referred to as an “original BPU”) of an original picture of video sequence 202 to two prediction stages, intra prediction (also known as an “intra-picture prediction” or “spatial prediction”) stage 2042 and inter prediction (also known as an “inter-picture prediction,” “motion compensated prediction” or “temporal prediction”) stage 2044 to perform a prediction operation and generate corresponding prediction data 206 and predicted BPU 208. Particularly, encoder 200 can receive the original BPU and prediction reference 224, which can be generated from the reconstruction path of the previous iteration of process.

The purpose of intra prediction stage 2042 and inter prediction stage 2044 is to reduce information redundancy by extracting prediction data 206 that can be used to reconstruct the original BPU as predicted BPU 208 from prediction data 206 and prediction reference 224. In some embodiments, an intra prediction can use pixels from one or more already coded neighboring BPUs in the same picture to predict the current BPU. That is, prediction reference 224 in the intra prediction can include the neighboring BPUs, so that spatial neighboring samples can be used to predict the current block. The intra prediction can reduce the inherent spatial redundancy of the picture.

In some embodiments, an inter prediction can use regions from one or more already coded pictures (“reference pictures”) to predict the current BPU. That is, prediction reference 224 in the inter prediction can include the coded pictures. The inter prediction can reduce the inherent temporal redundancy of the pictures.

In the forward path, encoder 200 performs the prediction operation at intra prediction stage 2042 and inter prediction stage 2044. For example, at intra prediction stage 2042, encoder 200 can perform the intra prediction. For an original BPU of a picture being encoded, prediction reference 224 can include one or more neighboring BPUs that have been encoded (in the forward path) and reconstructed (in the reconstructed path) in the same picture. Encoder 200 can generate predicted BPU 208 by extrapolating the neighboring BPUs. The extrapolation technique can include, for example, a linear extrapolation or interpolation, a polynomial extrapolation or interpolation, or the like. In some embodiments, encoder 200 can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at inter prediction stage 2042, encoder 200 can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, encoder 200 can add reconstructed residual BPU 222 to predicted BPU 208 to generate a reconstructed BPU. When all reconstructed BPUs of the same picture are generated, encoder 200 can generate a reconstructed picture as a reference picture. Encoder 200 can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When encoder 200 identifies (e.g., by using a pel-recursive algorithm, a block-matching algorithm, or the like) a region similar to the original BPU in the search window, encoder 200 can determine such a region as the matching region. The matching region can have different dimensions (e.g., being smaller than, equal to, larger than, or in a different shape) from the original BPU. Because the reference picture and the current picture are temporally separated in the timeline, it can be deemed that the matching region “moves” to the location of the original BPU as time goes by. Encoder 200 can record the direction and distance of such a motion as a “motion vector (MV).” When multiple reference pictures are used, encoder 200 can search for a matching region and determine its associated MV for each reference picture. In some embodiments, encoder 200 can assign weights to pixel values of the matching regions of respective matching reference pictures.

The motion estimation can be used to identify various types of motions, such as, for example, translations, rotations, zooming, or the like. For inter prediction, prediction data 206 can include, for example, reference index, locations (e.g., coordinates) of the matching region, MVs associated with the matching region, number of reference pictures, weights associated with the reference pictures, or other motion information.

For generating predicted BPU 208, encoder 200 can perform an operation of “motion compensation.” The motion compensation can be used to reconstruct predicted BPU 208 based on prediction data 206 (e.g., the MV) and prediction reference 224. For example, encoder 200 can move the matching region of the reference picture according to the MV, in which encoder 200 can predict the original BPU of the current picture. When multiple reference pictures are used, encoder 200 can move the matching regions of the reference pictures according to the respective MVs and average pixel values of the matching regions. In some embodiments, if encoder 200 has assigned weights to pixel values of the matching regions of respective matching reference pictures, encoder 200 can add a weighted sum of the pixel values of the moved matching regions.

In some embodiments, the inter prediction can utilize uni-prediction or bi-prediction and be unidirectional or bidirectional. Unidirectional inter predictions can use one or more reference pictures in the same temporal direction with respect to the current picture. For example, a first picture can be a unidirectional inter-predicted picture, in which the reference picture precedes the first picture. In uni-prediction, only one MV pointing to one reference picture is used to generate the prediction signal for the current block.

On the other hand, bidirectional inter predictions can use one or more reference pictures at both temporal directions with respect to the current picture. For example, a second picture can be a bidirectional inter-predicted picture, in which the reference pictures are at opposite temporal directions with respect to the second picture. In bi-prediction, two MVs, each pointing to its own reference picture, are used to generate the prediction signal of the current block. After video bitstream 228 is generated, MVs and reference indices can be sent in video bitstream 228 to a decoder, to identify where the prediction signal(s) of the current block come from.

For inter-predicted CUs, motion parameters may include MVs, reference picture indices and reference picture list usage index, or other additional information needed for coding features to be used. Motion parameters can be signaled in an explicit or implicit manner. In AVS3, under some specific inter coding modes, such as a skip mode or a direct mode, motion parameters (e.g., MV delta and reference picture index) are not coded and signaled in video bitstream 228.

Instead, the motion parameters can be derived at the decoder side with the same rule as defined in encoder 200.

After intra prediction stage 2042 and inter prediction stage 2044, at mode decision stage 230, encoder 200 can select a prediction mode (e.g., one of the intra prediction or the inter prediction) for the current iteration of process. For example, encoder 200 can perform a rate-distortion optimization method, in which encoder 200 can select a prediction mode to minimize a value of a cost function depending on a bit rate of a candidate prediction mode and distortion of the reconstructed reference picture under the candidate prediction mode. Depending on the selected prediction mode, encoder 200 can generate the corresponding predicted BPU 208 (e.g., a prediction block) and prediction data 206.

In some embodiments, predicted BPU 208 can be identical to the original BPU. However, due to non-ideal prediction and reconstruction operations, predicted BPU 208 is generally slightly different from the original BPU. For recording such differences, after generating predicted BPU 208, encoder 200 can subtract it from the original BPU to generate residual BPU 210, which is also called a prediction residual.

For example, encoder 200 can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

After residual BPU 210 is generated, encoder 200 can feed residual BPU 210 to transform stage 212 and quantization stage 214 to generate quantized residual coefficients 216. To further compress residual BPU 210, at transform stage 212, encoder 200 can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, encoder 200 can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, encoder 200 and a corresponding decoder (e.g., decoder 300 in FIG. 3) can use the same transform algorithm (thus the same base patterns). Thus, encoder 200 can record only the transform coefficients, from which decoder 300 can reconstruct residual BPU 210 without receiving the base patterns from encoder 200. Compared with residual BPU 210, the transform coefficients can have fewer bits, but they can be used to reconstruct residual BPU 210 without significant quality deterioration. Thus, residual BPU 210 is further compressed.

Encoder 200 can further compress the transform coefficients at quantization stage 214. In the transform process, different base patterns can represent different variation frequencies (e.g., brightness variation frequencies). Because human eyes are generally better at recognizing low-frequency variation, encoder 200 can disregard information of high-frequency variation without causing significant quality deterioration in decoding. For example, at quantization stage 214, encoder 200 can generate quantized residual coefficients 216 by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. Encoder 200 can disregard the zero-value quantized residual coefficients 216, by which the transform coefficients are further compressed. The quantization process is also invertible, in which quantized residual coefficients 216 can be reconstructed to the transform coefficients in an inverse operation of the quantization (referred to as “inverse quantization”).

Because encoder 200 disregards the remainders of such divisions in the rounding operation, quantization stage 214 can be lossy. Typically, quantization stage 214 can contribute the most information loss in the encoding process. The larger the information loss is, the fewer bits the quantized residual coefficients 216 can need. For obtaining different levels of information loss, encoder 200 can use different values of the quantization parameter or any other parameter of the quantization process.

Encoder 200 can feed prediction data 206 and quantized residual coefficients 216 to binary coding stage 226 to generate video bitstream 228 to complete the forward path. At binary coding stage 226, encoder 200 can encode prediction data 206 and quantized residual coefficients 216 using a binary coding technique, such as, for example, entropy coding, variable length coding, arithmetic coding, Huffman coding, context-adaptive binary arithmetic coding (CABAC), or any other lossless or lossy compression algorithm.

For example, the encoding process of CABAC in binary coding stage 226 may include a binarization step, a context modeling step, and a binary arithmetic coding step. If the syntax element is not binary, encoder 200 first maps the syntax element to a binary sequence. Encoder 200 may select a context coding mode or a bypass coding mode for coding. In some embodiments, for context coding mode, the probability model of the bin to be encoded is selected by the “context”, which refers to the previous encoded syntax elements. Then the bin and the selected context model is passed to an arithmetic coding engine, which encodes the bin and updates the corresponding probability distribution of the context model. In some embodiments, for the bypass coding mode, without selecting the probability model by the “context,” bins are encoded with a fixed probability (e.g., a probability equal to 0.5). In some embodiments, the bypass coding mode is selected for specific bins in order to speed up the entropy coding process with negligible loss of coding efficiency.

In some embodiments, in addition to prediction data 206 and quantized residual coefficients 216, encoder 200 can encode other information at binary coding stage 226, such as, for example, the prediction mode selected at the prediction stage (e.g., intra prediction stage 2042 or inter prediction stage 2044), parameters of the prediction operation (e.g., intra prediction mode, motion information, etc.), a transform type at transform stage 212, parameters of the quantization process (e.g., quantization parameters), an encoder control parameter (e.g., a bitrate control parameter), or the like. That is, coding information can be sent to binary coding stage 226 to further reduce the bit rate before being packed into video bitstream 228. Encoder 200 can use the output data of binary coding stage 226 to generate video bitstream 228. In some embodiments, video bitstream 228 can be further packetized for network transmission.

Components 218, 220, 222, 224, 232, and 234 can be referred to as a “reconstruction path.” The reconstruction path can be used to ensure that both encoder 200 and its corresponding decoder (e.g., decoder 300 in FIG. 3) use the same reference data for prediction.

During the process, after quantization stage 214, encoder 200 can feed quantized residual coefficients 216 to inverse quantization stage 218 and inverse transform stage 220 to generate reconstructed residual BPU 222. At inverse quantization stage 218, encoder 200 can perform inverse quantization on quantized residual coefficients 216 to generate reconstructed transform coefficients. At inverse transform stage 220, encoder 200 can generate reconstructed residual BPU 222 based on the reconstructed transform coefficients. Encoder 200 can add reconstructed residual BPU 222 to predicted BPU 208 to generate prediction reference 224 to be used in prediction stages 2042, 2044 for the next iteration of process.

In the reconstruction path, if intra prediction mode has been selected in the forward path, after generating prediction reference 224 (e.g., the current BPU that has been encoded and reconstructed in the current picture), encoder 200 can directly feed prediction reference 224 to intra prediction stage 2042 for later usage (e.g., for extrapolation of a next BPU of the current picture). If the inter prediction mode has been selected in the forward path, after generating prediction reference 224 (e.g., the current picture in which all BPUs have been encoded and reconstructed), encoder 200 can feed prediction reference 224 to loop filter stage 232, at which encoder 200 can apply a loop filter to prediction reference 224 to reduce or eliminate distortion (e.g., blocking artifacts) introduced by the inter prediction. Encoder 200 can apply various loop filter techniques at loop filter stage 232, such as, for example, deblocking, sample adaptive offsets (SAO), adaptive loop filters (ALF), or the like. In SAO, a nonlinear amplitude mapping is introduced within the inter prediction loop after the deblocking filter to reconstruct the original signal amplitudes with a look-up table that is described by a few additional parameters determined by histogram analysis at the encoder side.

The loop-filtered reference picture can be stored in buffer 234 (or “decoded picture buffer”) for later use (e.g., to be used as an inter-prediction reference picture for a future picture of video sequence 202). Encoder 200 can store one or more reference pictures in buffer 234 to be used at inter prediction stage 2044. In some embodiments, encoder 200 can encode parameters of the loop filter (e.g., a loop filter strength) at binary coding stage 226, along with quantized residual coefficients 216, prediction data 206, and other information.

Encoder 200 can perform the process discussed above iteratively to encode each original BPU of the original picture (in the forward path) and generate prediction reference 224 for encoding the next original BPU of the original picture (in the reconstruction path). After encoding all original BPUs of the original picture, encoder 200 can proceed to encode the next picture in video sequence 202.

It should be noted that other variations of the encoding process can be used to encode video sequence 202. In some embodiments, stages of process can be performed by encoder 200 in different orders. In some embodiments, one or more stages of the encoding process can be combined into a single stage. In some embodiments, a single stage of the encoding process can be divided into multiple stages. For example, transform stage 212 and quantization stage 214 can be combined into a single stage. In some embodiments, the encoding process can include additional stages that are not shown in FIG. 2. In some embodiments, the encoding process can omit one or more stages in FIG. 2.

For example, in some embodiments, encoder 200 can be operated in a transform skipping mode. In the transform skipping mode, transform stage 212 is bypassed and a transform skip flag is signaled for the TB. This may improve compression for some types of video content such as computer-generated images or graphics mixed with camera-view content (e.g., scrolling text). In addition, encoder 200 can also be operated in a lossless mode. In the lossless mode, transform stage 212, quantization stage 214, and other processing that affects the decoded picture (e.g., SAO and deblocking filters) are bypassed. The residual signal from the intra prediction stage 2042 or inter prediction stage 2044 is fed into binary coding stage 226, using the same neighborhood contexts applied to the quantized transform coefficients. This allows mathematically lossless reconstruction. Therefore, both transform and transform skip residual coefficients are coded within non-overlapped CGs. That is, each CG may include one or more transform residual coefficients, or one or more transform skip residual coefficients.

FIG. 3 illustrates a block diagram of an exemplary decoder 300 of a video coding system (e.g., H.26x series), consistent with some embodiments of the present disclosure. Decoder 300 can perform a decompression process corresponding to the compression process in FIG. 2. The corresponding stages in the compression process and decompression process are labeled with the same numbers in FIG. 2 and FIG. 3.

In some embodiments, the decompression process can be similar to the reconstruction path in FIG. 2. Decoder 300 can decode video bitstream 228 into video stream 304 accordingly. Video stream 304 can be very similar to video sequence 202 in FIG. 2. However, due to the information loss in the compression and decompression process (e.g., quantization stage 214 in FIG. 2), video stream 304 may be not identical to video sequence 202. Similar to encoder 200 in FIG. 2, decoder 300 can perform the decoding process at the level of basic processing units (BPUs) for each picture encoded in video bitstream 228. For example, decoder 300 can perform the process in an iterative manner, in which decoder 300 can decode a basic processing unit in one iteration. In some embodiments, decoder 300 can perform the decoding process in parallel for regions (e.g., slices 114-118) of each picture encoded in video bitstream 228.

In FIG. 3, decoder 300 can feed a portion of video bitstream 228 associated with a basic processing unit (referred to as an “encoded BPU”) of an encoded picture to binary decoding stage 302. At binary decoding stage 302, decoder 300 can unpack and decode video bitstream into prediction data 206 and quantized residual coefficients 216. Decoder 300 can use prediction data 206 and quantized residual coefficients to reconstruct video stream 304 corresponding to video bitstream 228.

Decoder 300 can perform an inverse operation of the binary coding technique used by encoder 200 (e.g., entropy coding, variable length coding, arithmetic coding, Huffman coding, context-adaptive binary arithmetic coding, or any other lossless compression algorithm) at binary decoding stage 302. In some embodiments, in addition to prediction data 206 and quantized residual coefficients 216, decoder 300 can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, decoder 300 can depacketize video bitstream 228 before feeding it to binary decoding stage 302.

Decoder 300 can feed quantized residual coefficients 216 to inverse quantization stage 218 and inverse transform stage 220 to generate reconstructed residual BPU 222. Decoder 300 can feed prediction data 206 to intra prediction stage 2042 and inter prediction stage 2044 to generate predicted BPU 208. Particularly, for an encoded basic processing unit (referred to as a “current BPU”) of an encoded picture (referred to as a “current picture”) that is being decoded, prediction data 206 decoded from binary decoding stage 302 by decoder 300 can include various types of data, depending on what prediction mode was used to encode the current BPU by encoder 200. For example, if intra prediction was used by encoder 200 to encode the current BPU, prediction data 206 can include coding information such as a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by encoder 200 to encode the current BPU, prediction data 206 can include coding information such as a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more MVs respectively associated with the matching regions, or the like.

Accordingly, the prediction mode indicator can be used to select whether inter or intra prediction module will be invoked. Then, parameters of the corresponding prediction operation can be sent to the corresponding prediction module to generate the prediction signal(s). Particularly, based on the prediction mode indicator, decoder 300 can decide whether to perform an intra prediction at intra prediction stage 2042 or an inter prediction at inter prediction stage 2044. The details of performing such intra prediction or inter prediction are described in FIG. 2 and will not be repeated hereinafter. After performing such intra prediction or inter prediction, decoder 300 can generate predicted BPU 208.

After predicted BPU 208 is generated, decoder 300 can add reconstructed residual BPU 222 to predicted BPU 208 to generate prediction reference 224. In some embodiments, prediction reference 224 can be stored in a buffer (e.g., a decoded picture buffer in a computer memory). Decoder 300 can feed prediction reference 224 to intra prediction stage 2042 and inter prediction stage 2044 for performing a prediction operation in the next iteration.

For example, if the current BPU is decoded using the intra prediction at intra prediction stage 2042, after generating prediction reference 224 (e.g., the decoded current BPU), decoder 300 can directly feed prediction reference 224 to intra prediction stage 2042 for later usage (e.g., for extrapolation of a next BPU of the current picture). If the current BPU is decoded using the inter prediction at inter prediction stage 2044, after generating prediction reference 224 (e.g., a reference picture in which all BPUs have been decoded), decoder 300 can feed prediction reference 224 to loop filter stage 232 to reduce or eliminate distortion (e.g., blocking artifacts). In addition, prediction data 206 can further include parameters of a loop filter (e.g., a loop filter strength). Accordingly, decoder 300 can apply the loop filter to prediction reference 224, in a way as described in FIG. 2. For example, loop filters such as deblocking, SAO or ALF may be applied to form the loop-filtered reference picture, which are stored in buffer 234 (e.g., a decoded picture buffer (DPB) in a computer memory) for later use (e.g., to be used at inter prediction stage 2044 for prediction of a future encoded picture of video bitstream 228). In some embodiments, reconstructed pictures from buffer 234 can also be sent to a display, such as a TV, a PC, a smartphone, or a tablet to be viewed by the end-users.

Decoder 300 can perform the decoding process iteratively to decode each encoded BPU of the encoded picture and generate prediction reference 224 for encoding the next encoded BPU of the encoded picture. After decoding all encoded BPUs of the encoded picture, decoder 300 can output the picture to video stream 304 for display and proceed to decode the next encoded picture in video bitstream 228.

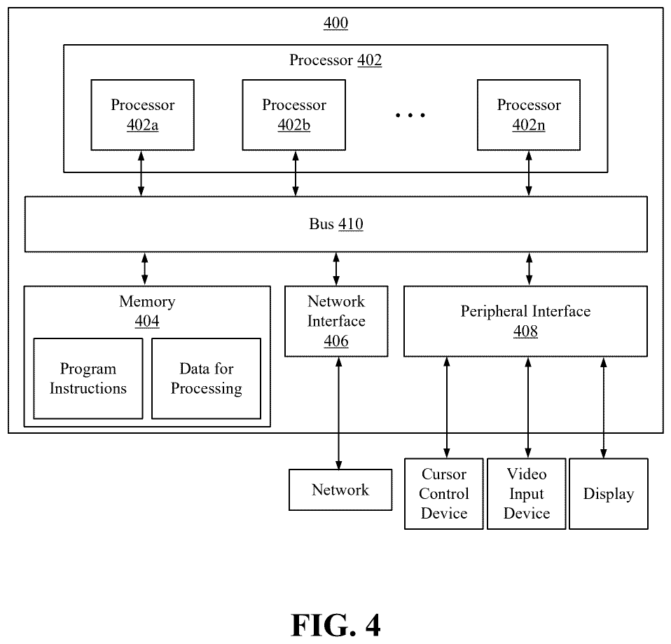

FIG. 4 is a block diagram of an example apparatus 400 for encoding or decoding image data, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200 or 300) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200 or 300) can be implemented as any combination of any software or hardware modules in apparatus 400. For example, some or all stages of process 200 or 300 can be implemented as one or more software modules of apparatus 400, such as program instructions that can be loaded into memory 404. For another example, some or all stages of process 200 or 300 can be implemented as one or more hardware modules of apparatus 400, such as a specialized data processing circuit (e.g., an FPGA, an ASIC, an NPU, or the like).

Supplemental enhancement information (SEI) messages are intended to be conveyed within coded video bitstream in a manner specified in a video coding specification or to be conveyed by other means determined by the specifications for systems that make use of such coded video bitstream. SEI messages can contain various types of data that indicate the timing of the video pictures or describe various properties of the coded video or how it can be used or enhanced. SEI messages are also defined that can contain arbitrary user-defined data. SEI messages do not affect the core decoding process but can indicate how the video is recommended to be post-processed or displayed.

With the emergence of deep generative models including Variational Auto-Encoding (VAE) and Generative Adversarial Networks (GAN), the facial video compression has achieved promising performance improvement. For example, X2Face can be used to control face generation via images, audio, and pose codes. Besides, realistic neural talking head models can be used via few-shot adversarial learning. For Video-to-video synthesis tasks, Face-vidtovid (a.k.a., “Face_vid2vid”) can be used. Moreover, schemes that leverage compact 3D keypoint representation to drive a generative model for rendering the target frame can also be used. Moreover, mobile-compatible video chat systems based on FOMM can be used. VSBNet that utilizes the adversarial learning to reconstruct origin frames from the landmarks can also be used. In addition, an end-to-end talking-head video compression framework based upon compact feature learning (CFTE), designed for high efficiency talking face video compression towards ultra low bandwidth scenarios can be used. The CFTE scheme leverages the compact feature representation to compensate for the temporal evolution and reconstruct the target face video frame in an end-to-end manner. Moreover, the CFTE scheme can be incorporated into the video coding framework with the supervision of rate-distortion objective. In addition, facial semantics can be utilized via the 3DMM template to character the face video and endow the face video coding with the face manipulation ability.

The following Table 1 summarizes facial representations for generative face video compression algorithms. In particular, the face images exhibit strong statistical regularities, which can be economically characterized with 2D landmarks, 2D keypoints, region matrix, 3D keypoints, compact feature matrices, and/or facial semantics. Such facial description strategies can lead to reduced coding bit-rate and improve the coding efficiency, thus applicable to video conferencing and live entertainment.

TABLE 1
Examples of facial representations for generative face video compression algorithms

| Facial | |
|---|---|
| Representation | Interpretation |
| 2D landamrks | VSBNet is a representative model which can ulitize 98 groups of 2D |
| | facial landmarks [symbol] ^{2×98} to depict the key structure information of |
| | human face, where the total number of encoding parameters for each |
| | inter frame is 196. |
| 2D keypoints + affine | FOMM is a representative model which adopts 10 groups of learned |
| transformation matrix | 2D keypoints [symbol] ^{2×10} along with their local affine transformations |
| | [symbol] ^{2×2×10} to characterize complex motions. The total number of |
| | encoding parameters for each inter frame is 60. |
| region matrix | MRAA is a representative model which extracts consistent regions of |
| | talking face to describe locations, shape, and pose, mainly represented |
| | with shift matrix [symbol] ^{2×10}, covar matrix [symbol] ^{2×2×10} and affine matrix |
| | [symbol] ^{2×2×10}. As such, the total number of encoding parameters for each |
| | inter frame is 100. |
| 3D keypoints | Face_vid2vid is a representative model which can estimate 12- |
| | dimension head parameters (i.e., rotation matrix [symbol] ^{3×3} and translation |
| | parameters [symbol] ^{3×1}) and 15 groups of learned 3D keypoint |
| | perturbations [symbol] ^{3×15} due to facial expressions, where the total number |
| | of encoding parameters for each inter frame is 57. |
| compact feature | CFTE is a representative model which can model the temporal |
| martix | evolution of faces into learned compact feature representation with the |
| | matrix [symbol] ^{4×4}, where the total number of encoding parameters for each |
| | inter frame is 16. |
| facial semantics | IFVC is a representative model which adopts a collection of |
| | transmitted facial semantics to represent the face frame, including |
| | mouth parameters [symbol] ⁶, eye parameter [symbol] ¹, rotation parameters [symbol] ³, |
| | translation parameters [symbol] ³ and location parameter [symbol] ¹. Totally, the |
| | number of encoding parameters for each inter frame is 14. |

In the 29th meeting of Joint Video Experts Team (JVET), a generative face video SEI message was proposed. The generative face video SEI message can employ a series of facial semantic information to represent the status of head posture and face expression. The initially proposed SEI message only considered one facial representation in face generative compression. However, face video can be described by the variations of feature structures with strong priors, such as landmarks, 2D keypoints, region matrix, 3D keypoints, compact feature matrix, facial semantics, and/or other formats. These facial representations can provide a great freedom to implement the syntax design and semantic description of SEI message for face video compression. It is desirable for the SEI messages in the VVC standard to consider different facial representations at the task of face video compression.

In addition, face video communication has called for more common use cases, such as face video retargeting or animation, except face video reconstruction. For example, with the popularity of metaverse-activities, real-world facial movement may need to be transferred to the virtual metaverse world and represented by another person. Moreover, the reconstruction of face video is expected to be more in line with the real situation and make corresponding retargeting. Therefore, there is a need to define face video compression SEI messages that can contain various types of data for indicating the timing of the video pictures and/or describing various properties of the coded video or how it can be used or enhanced. As such, the post-processing or displaying of the reconstructed face video can satisfy the users' actual needs in a user-friendly manner.

To solve the above problems, a new SEI message called generative face video SEI message is proposed in this disclosure. The proposed SEI can work with different facial representations, such as 2D keypoints, 2D landmarks, 3D keypoints, facial semantics and other formats, which can be utilized to reconstruct high-quality talking face video at ultra-low bitrate or to manipulate the talking face video towards personalized characterization. As such, the proposed generative face video SEI message can be applicable to video conferencing, live entertainment, face animation and metaverse-related functionalities.

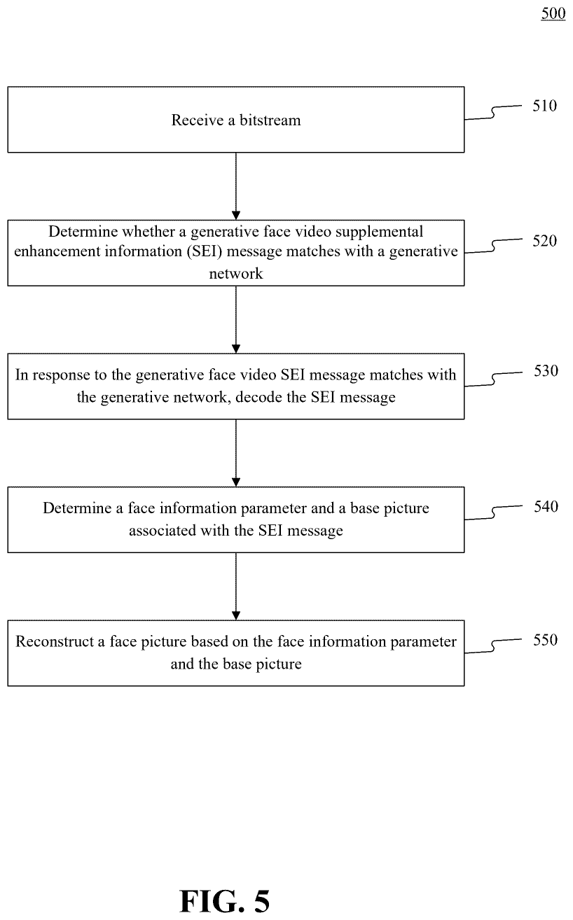

FIG. 5 illustrates a flowchart for a method 500 for decoding a bitstream, according to some embodiments consistent with the present disclosure. The method 500 can be performed by a decoder (e.g., image/video decoder 144 in FIG. 1 or decoder 300 in FIG. 3) to decode video bitstream 228 in FIG. 3. For example, the decoder can be implemented as one or more software or hardware components of an apparatus (e.g., apparatus 400 in FIG. 4) for decoding the bitstream (e.g., video bitstream 228 in FIG. 3) to reconstruct a video frame or a video sequence (e.g., video stream 304 in FIG. 3) of the bitstream. For example, a processor (e.g., processor 402 in FIG. 4) can perform the method 500. As shown in FIG. 5, the method 500 includes the following steps 510-550.

In step 510, the decoder receives a bitstream (e.g., video bitstream 228 in FIG. 3). The bitstream received from the encoder side includes one or more CUs of a video frame, and the index of the selected motion candidate for CU(s) coded in the skip mode or the direct mode.

In steps 520-550, the decoder decodes, using coded information of the bitstream, one or more pictures. In some embodiments, step 520 of the method 500 involves determining whether a generative face video supplemental enhancement information (SEI) message matches with a generative network. This step can be performed to ensure that the SEI message can be properly interpreted and utilized by the decoder.

If the SEI message matches with the generative network, the method 500 proceeds to step 530. In this step, the SEI message may be decoded. This decoding process may involve extracting various types of information from the SEI message. For example, the decoding may include decoding a syntax element of the SEI message signaling one or more normalized values of one or more keypoint coordinates. In some cases, the decoding may involve decoding a syntax element of the SEI message signaling a difference between a first coordinate of a first keypoint and a second coordinate of a second keypoint.

The decoding process may also include decoding a first syntax element of the SEI message signaling an integer part of a matrix element in a facial matrix and a second syntax element of the SEI message signaling a decimal part of the matrix element in the facial matrix. In some implementations, the method 500 may decode a syntax element of the SEI message signaling one or more keypoint coordinates using exponential-golomb code.

Additionally, the decoding may involve decoding a syntax element of the SEI message signaling a flag indicating whether a current output picture corresponds to a base picture. This information may be used in subsequent steps of the method 500.

The base picture is a picture can be coded with a conventional coding method. For example, it could be with H.264, H.265 and H.266. The base picture provides the texture information of the human face and based on this picture, the generative network can generate the additional face pictures with the help of parameters and these parameters indicate the differences among the pictures to be generated and the base picture. The base picture is usually the first picture of a video sequence, and the following picture are generated with the network. The parameters needed to generate the following pictures are signaled in the proposed SEI message. One SEI message contains the parameters needed for generating one picture or multiple pictures.

In step 540, the decoder determines a face information parameter and a base picture associated with the SEI message. The face information parameter may be representative of a face feature. In some cases, the face feature may include at least one of a 2D keypoint, a 2D landmark, a 3D keypoint, or a facial semantics.

In step 550, the decoder reconstructs a face picture based on the face information parameter and the base picture. This reconstruction process may utilize various pieces of information extracted from the SEI message. For example, the face picture may be reconstructed based on one or more normalized keypoint coordinates in the SEI message, a picture width, a picture height, and a maximum z-axis value inputted to the generative network.

Throughout the execution of the method 500, one or more pictures may be decoded using coded information from the received bitstream. This decoding process may work in conjunction with the SEI message decoding and face picture reconstruction to produce the final video output.

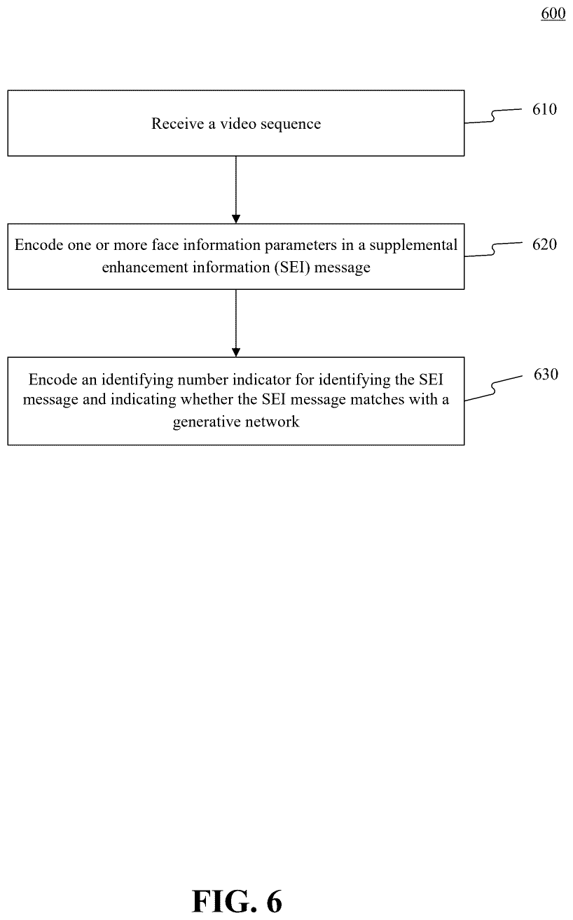

FIG. 6 illustrates a flowchart for a method 600 for encoding a video sequence into a bitstream using SEI messages, according to some embodiments consistent with the present disclosure. The method 600 can be performed by an encoder (e.g., image/video encoder 124 in FIG. 1 or encoder 200 in FIG. 2) to generate video bitstream associated with a video frame. For example, the encoder can be implemented as one or more software or hardware components of an apparatus (e.g., apparatus 400 in FIG. 4) for encoding or transcoding a video sequence (e.g., video sequence 202 in FIG. 2) to generate the bitstream (e.g., video bitstream 228 in FIG. 2) for the video frame or the video sequence including one or more CUs. For example, a processor (e.g., processor 402 in FIG. 4) can perform the method 600.

As shown in FIG. 6, the method 600 corresponding to method 500 in FIG. 5 may include the following steps 610-630. As explained above, video bitstream 228 generated by encoder 200 using method 600 can be decoded by decoder 300 by an inverse operation.

In step 610, the encoder receives a video sequence.

Following the reception of the video sequence, the method 600 may proceed to encode one or more pictures of the video sequence. This encoding process may involve several sub-steps, as illustrated in steps 620 and 630.

In step 620, the encoder encodes one or more face information parameters in a supplemental enhancement information (SEI) message. These face information parameters may be used for reconstructing a face picture using a generative network. The encoding of these parameters may involve various techniques.

In some embodiments, the encoding may include coding a syntax element of the SEI message signaling one or more normalized values of one or more keypoint coordinates. This approach may allow for efficient representation of facial features.

In some embodiments, the encoding may involve coding a syntax element of the SEI message signaling a difference between a first coordinate of a first keypoint and a second coordinate of a second keypoint. This differential coding technique may provide a compact representation of facial landmarks.

The encoding process may also include coding a first syntax element of the SEI message signaling an integer part of a matrix element in a facial matrix and a second syntax element of the SEI message signaling a decimal part of the matrix element in the facial matrix. This approach may allow for precise representation of facial transformations or deformations.

In some embodiments, the encoding may involve coding a syntax element of the SEI message signaling one or more keypoint coordinates using exponential-golomb code. This coding technique may provide efficient compression for coordinate values.

Additionally, the encoding may include coding a syntax element of the SEI message signaling a flag indicating whether a current output picture corresponds to a base picture. This information may be used in subsequent decoding and face reconstruction processes.

In step 630, the encoder encodes an identifying number indicator may for identifying the SEI message and indicating whether the SEI message matches with a generative network. This step can be performed for ensuring that the SEI message can be properly interpreted and utilized during the decoding process at the decoder side.

Through these encoding steps, the encoder may generate a bitstream that contains the necessary information for reconstructing face pictures using a generative network. The encoded face information parameters and identifying number indicator may enable efficient transmission and subsequent decoding of facial video data.

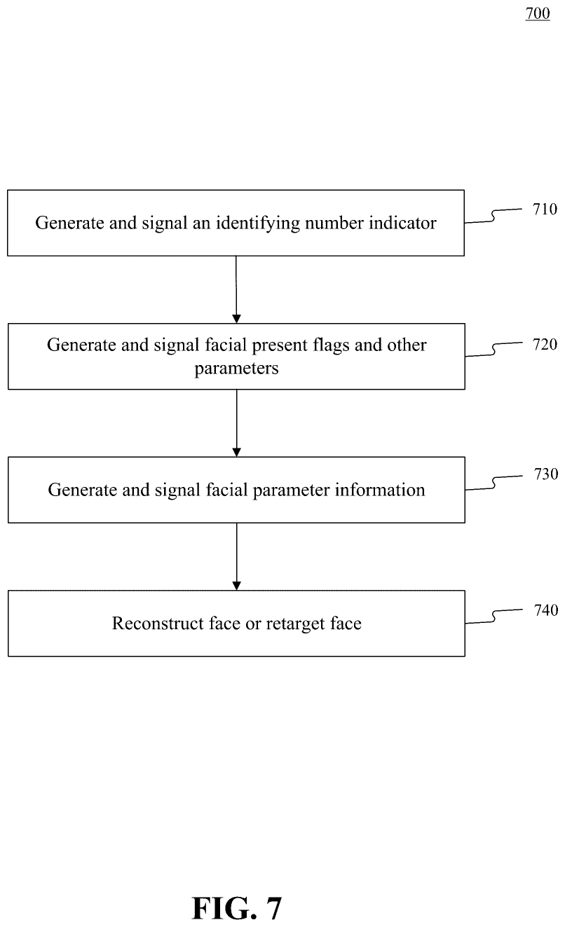

FIG. 7 illustrates a flowchart for a method 700 of for processing video based on generative face video supplemental enhancement information (SEI) messages, according to some embodiments of the present disclosure. The method 700 may be implemented in an encoding process (e.g., the encoding process shown in FIG. 2) or in a decoding process (e.g., the decoding process shown in FIG. 3). Accordingly, the method 700 may be performed by an encoder (e.g., image/video encoder 124 in FIG. 1) or a decoder (e.g., image/video decoder 144 in FIG. 1). As shown in FIG. 7, the method 700 describes the general syntax structure and syntax element order of the generative face video SEI message, and may include the following steps 710-740.

In step 710, an encoder (e.g., image/video encoder 124 in FIG. 1 or apparatus 400 in FIG. 4) may generate and signal an identifying number indicator in the SEI message to a decoder (e.g., image/video decoder 144 in FIG. 1 or apparatus 400 in FIG. 4). The identifying number indicator may be used to identify the supplemental enhancement information (SEI) message and indicate whether the current generative face video SEI message matches with the generative network in the decoder.

In step 720, the encoder may generate multiple (e.g., three) facial information type present flags and other parameters and signal them to indicate the presence and the length of certain syntax elements associated with the face video generative compression scheme, when the identifying number indicator indicates that the face video generative compression scheme is used. These flags and parameters may be part of the one or more face information parameters encoded in the SEI message. As explained above, in some cases, the flags may indicate the presence and length of certain syntax elements associated with the face video generative compression scheme.

In step 730, the encoder may generate the corresponding facial parameter information to the facial present flags generated in step 720 and signal it to the decoder. The facial parameter information may include various types of data used for face reconstruction or retargeting. For example, the facial parameter information may include one or more normalized values of one or more key point coordinates. These normalized values may be coded as syntax elements in the SEI message.

The facial parameter information may also include data that can be used by a generative network for face reconstruction. In some implementations, the generative network may include a first sub-network and a second sub-network. The first sub-network may be configured to transfer the face information parameter into a flow map. The second sub-network may be configured to generate a picture based on an output of the flow map.

In some embodiments, the first sub-network may be configured to translate the face information parameter into a predetermined type of parameter or a predetermined format of parameter. The second sub-network is configured to generate a picture based on the predetermined type or format of parameter. For example, the predetermined format of parameter may include at least one of: a predetermined number of the keypoints used for describing a face feature, a predetermined number of matrices used for describing the face feature, or a predetermined size of a matrix used for describing the face feature.

In step 740, the decoder may use the signaled corresponding facial parameter information to reconstruct or retarget the related face image based on a base picture. This step may correspond to the reconstruction of a face picture based on the face information parameter and the base picture.

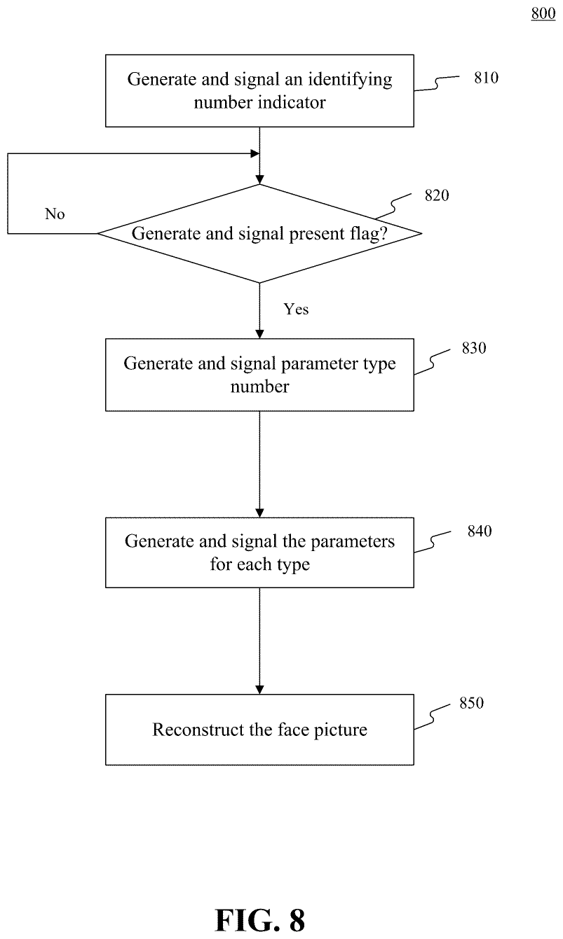

FIG. 8 illustrates a flowchart for a method 800 for processing video based on generative face video SEI messages, according to some embodiments consistent with the present disclosure. The method 800 may be implemented in an encoding process (e.g., the encoding process shown in FIG. 2), or in a decoding process (e.g., the decoding process shown in FIG. 3). Accordingly, the method 800 may be performed by an encoder (e.g., image/video encoder 124 in FIG. 1), or a decoder (e.g., image/video decoder 144 in FIG. 1). As shown in FIG. 8, the method 800 describes the general syntax structure and an order for generating some syntax elements of the generative face video SEI message, and may include the following steps 810-850.

In step 810, an encoder (e.g., image/video encoder 124 in FIG. 1) may generate and signal an identifying number indicator. This step may correspond to the encoding of an identifying number indicator. The identifying number indicator may be used to identify the supplemental enhancement information (SEI) message and indicate whether the SEI message matches with a generative network. For example, a key indicator can be generated and signaled to identify the analysis network used to generate the syntax elements of the current generative face video SEI message. The value of key indicator (e.g., gfv_key as described below) may be used to determine whether the analysis network at the encoder matches with the generative network at a decoder (e.g., image/video decoder 144 in FIG. 1). In addition, a picture order count that specifies the display order count modulo 1<<31 of the picture generated with the current SEI message. In some embodiments, as the analysis network at the encoder is also expected to be the generative network at the decoder for decoding the bitstream sent by the encoder, the analysis network at the encoder is also referred to as a target (neural) network.

In step 820, the encoder may determine whether to generate and signal a parameter present flag for the current parameter group (mode). This decision step may be part of the process of encoding one or more face information parameters in the SEI message. The present flag may indicate the presence of certain types of facial information in the SEI message. In addition, the following parameters can be generated and signaled to the decoder in subsequent steps only if the flag is true. If the flag is false, the parameters of the current group (mode) will not be generated and signaled. As shown in FIG. 8, step 820 can be implemented in polling form for each mode until finding a true flag.

In step 830, if the present flag is determined to be generated and signaled, the encoder may generate and signal the number of parameter types first when signaling the current group of the parameters.

Following step 830, in step 840, for each parameter type, the encoder can generate and signal the detailed parameters accordingly. These parameters may include various facial features or characteristics, such as the normalized values of keypoint coordinates.

In step 850, after receiving the SEI message, the decoder may decode the parameters to reconstruct the face picture. This reconstruction may be based on the parameters and information signaled in the previous steps. This step may correspond to the reconstruction of a face picture based on the face information parameter and the base picture.

In some embodiments, the base picture is a picture that can be coded with a conventional coding method. For example, it could be with H.264, H.265 and H.266. The base picture provides the texture information of the human face and based on this picture, the generative network can generate the additional face pictures with the help of parameters indicating the differences among the pictures to be generated and the base picture. The base picture is usually the first picture of a video sequence, and the following picture can be generated by the neural network. The parameters needed to generate the following pictures are signaled in the SEI message. One SEI message contains the parameters needed for generating one picture or multiple pictures. In some embodiments, the method 800 may include applying color calibration to the generated face picture. This color calibration may be based on parameters signaled in the SEI message or derived from a decoded picture. For example, the decoder may decode syntax elements from the SEI message that specify color calibration parameters such as mean and variance values for each color component. Alternatively, the decoder may analyze a decoded picture to derive these color calibration parameters. The color calibration may then be applied to adjust the color distribution of the reconstructed face picture, potentially improving its visual quality and accuracy.

The method 800 illustrates a structured approach for generating, signaling, and using facial information in video processing. The method 800 demonstrates a sequence of decisions and actions that lead from initial identification to the final reconstruction of a face picture, incorporating various aspects of the encoding and decoding processes described in the claims.

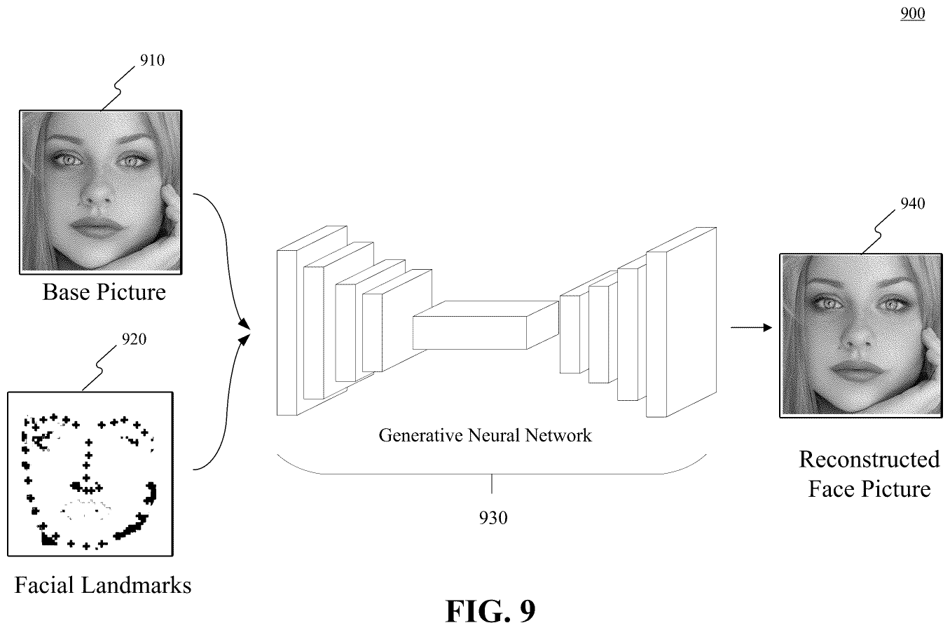

FIG. 9 is a schematic diagram illustrating a generative neural network for generating a face picture, according to some embodiments of the present disclosure. As shown in FIG. 9, a base picture 910 and a face information parameter (e.g., facial landmarks 920) can be input into the generative neural network 930 of the decoder. The generative neural network 930 will produce a reconstructed face picture 940 as an output. As appreciated, a face picture is coded as the face information parameter with respect to the base picture 910. Compared with transmitting the entire face picture, the proposed approach of solely exchanging coded face information parameter proves advantageous for the bandwidth.

In the following, two different solutions of generative face video SEI messages are described in detail.

Table 2 shows an exemplary syntax for the first solution. The process can be performed as follows.

First, the generative face video SEI message contains an identifying number that may be used to identify the current.

Second, a mode index gfv_feature_mode is signaled in the SEI message to determine which representation is used and then according to the representation method used, the corresponding parameters are signaled.

Third, after receiving and decoding the SEI message, the face video can be reconstructed towards high-quality or user-friendly manner via the strong generation ability of generative adversial network with the parameters signaled in the SEI message and the base picture decoded previously as input.

TABLE 2
Exemplary syntax of disclosed generative face video SEI message

| | Descriptor |
|---|---|
| Generative_face_video ( payloadSize ) { | |
| gfv_id | ue(v) |
| gfv_feature_mode | ue(v) |
| if(gfv_feature_mode == 0){ | |
| 2d_landmark_quantization_factor | ue(v) |
| 2d_landmark_num | ue(v) |
| for(i=0; i< 2d_landmark_num;i++){ | |
| x[i] | ue(v) |
| y[i] | ue(v) |
| } | |
| } | |
| else if(gfv_feature_mode == 1){ | |
| 2d_keypoint_quantization_factor | ue(v) |
| 2d_keypoint_num | ue(v) |
| is_affine_transformation_matrix_flag | u(1) |
| for(i=0; i< 2d_keypoint_num;i++){ | |
| x[i] | ue(v) |
| y[i] | ue(v) |
| if(is_affine_transformation_matrix_flag){ | |
| for(j=0; j< 2;j++){ | |
| for(k=0;k<2;k++){ | |
| affine_ transformation _matrix[i][j][k] | ue(v) |
| } | |
| } | |
| } | |
| } | |
| } | |
| else if(gfv_feature_mode == 2){ | |
| region_quantization_factor | ue(v) |
| region_keypoint_num | ue(v) |
| is_affine_ transformation_matrix_flag | u(1) |
| is_covariance_matrix_flag | u(1) |
| for(i=0; i< region_keypoint_num;i++){ | |
| x[i] | ue(v) |
| y[i] | ue(v) |
| if(is_affine_transmation_matrix_flag){ | |
| for(j=0; j< 2;j++){ | |
| for(k=0;k<2;k++){ | |
| affine_ transformation_matrix[i][j][k]; | ue(v) |
| } | |
| if( is_covariance_matrix_flag){ | |
| for(m=0;m< 2;m++){ | |
| for(n=0;n<2;n++){ | |
| covariance_matrix[i][m][n]; | ue(v) |
| } | |
| } | |
| } | |
| } | |
| } | |
| else if(gfv_feature_mode == 3){ | |
| 3d_keypoint_quantization_factor | ue(v) |
| 3d_keypoint_num | ue(v) |
| is_rotation_matrix_flag | u(1) |
| is_translation_matrix_flag | u(1) |
| for(i=0; i< 3d_keypoint_num;i++){ | |
| x[i] | ue(v) |
| y[i] | ue(v) |
| z[i] | ue(v) |
| } | |
| if(is_rotation_matrix_flag){ | |
| for(j=0; j< 3;j++){ | |
| for(k=0;k<3;k++){ | |
| rotation_matrix[j][k]; | ue(v) |
| } | |
| } | |
| if(is_translation_matrix_flag){ | |
| for(l=0; l< 3;l++){ | |
| translation_matrix[l]; | ue(v) |
| } | |
| } | |
| } | |
| else if(gfv_feature_mode == 4){ | |
| compact_feature_quantization_factor | ue(v) |
| matrix_channel | ue(v) |
| matrix_width | ue(v) |
| matrix_height | ue(v) |
| for(k=0; k< matrix_channel; k++){ | |
| for(m=0; m< matrix_height;m++){ | |
| for(n=0;n<matrix_width;n++){ | |
| compact_feature_matrix_element[k][m][n]; | ue(v) |
| } | |
| } | |
| } | |
| } | |
| else if(gfv_feature_mode == 5){ | |
| semantic_quantization_factor | ue(v) |
| semantic_type_num | ue(v) |
| for(l=0; l<semantic_type_num;l++){ | |
| semantic_idx[l] | ue(v) |
| semantic_width[l] | ue(v) |
| semantic_height[l] | ue(v) |
| for(y=0; y< semantic_width[l];y++){ | |
| for(z=0; z< semantic_height[l];z++){ | |
| semantic_element[l][y][z]; | ue(v) |
| } | |
| } | |
| } | |
| } | |
| else if(gfv_feature_mode>5 && gfv_feature_mode <128){ | |
| data_quantization_factor | ue(v) |
| data_length | ue(v) |
| for(i=0;i<data_length;i++){ | |
| data_element[i] | ue(v) |
| } | |
| } | |
| } | |

The semantics for the above syntax are described as follows.

This SEI message carries facial parameters for different feature representations, such as 2D keypoints, 2D landmarks, 3D keypoints, facial semantics and other formats, which may be used for face generative compression. For these facial representations, they can be categorized into different types, and use the gfv_feature_mode to determine which type of facial representation is utilized. Based on the base picture, the facial parameters in the SEI message can be used to reconstruct face picture, and each SEI message is used to generate one face picture.

gfv_id contains an identifying number that may be used to identify a generative face video SEI message. The value of gfv_id shall be in the range of 0 to 2³²−2, inclusive.

gfv_feature_mode, the value shall be in the range of 0 to 5, inclusive, in bitstreams conforming to this edition of this document. Values of 6 to 128, inclusive, for feature code are reserved for future use by ITU-T|ISO/EC and shall not be present in bitstreams conforming to this edition of this document. Decoders conforming to this edition of this document shall ignore GFV SE messages with gfv_feature_mode in the range of 6 to 128, inclusive. Values of feature code greater than 1023 shall not be present in bitstreams conforming to this edition of this document and are not reserved for future use.

TABLE 3
Definition of gfv_feature_mode

| Value | Interpretation |
|---|---|
| 0 | Choose 2D facial landmarks as feature mode in the GFV SEI messages. Herein, |
| | VSBNet [1] is the representative model which can ulitize 98 groups of 2D facial |
| | landmarks [symbol] ^{2×98} to depict the key structure information of human face, where the |
| | total number of encoding parameters for each inter frame is 196. |
| 1 | Choose 2D keypoints as feature mode in the GFV SEI messages. Herein, FOMM [2] |
| | is the representative model which adopts 10 groups of learned 2D keypoints |
| | [symbol] ^{2×10} along with their local affine transformations [symbol] ^{2×2×10} to characterize complex |
| | motions. The total number of encoding parameters for each inter frame is 60. |
| 2 | Choose consistent regions as feature mode in the GFV SEI messages. Herein, MRAA |
| | [3] is the representative model which extracts consistent regions of talking face to |
| | describe locations, shape, and pose, mainly represented with shift matrix [symbol] ^{2×10}, |
| | covar matrix [symbol] ^{2×2×10} and affine matrix [symbol] ^{2×2×10}. As such, the total number of |
| | encoding parameters for each inter frame is 100. |
| 3 | Choose 3D keypoint as feature mode in the GFV SEI messages. Herein, |
| | Face_vid2vid [4] is the representative model which can estimate 12-dimension head |
| | parameters (i.e., rotation matrix [symbol] ^{3×3} and translation parameters [symbol] ^{3×1} ) and 15 |
| | groups of learned 3D keypoint perturbations [symbol] ^{3×15} due to facial expressions, where |
| | the total number of encoding parameters for each inter frame is 57. |
| 4 | Choose compact feature as feature mode in the GFV SEI messages. Herein, CFTE |
| | [5] is the representative model which can model the temporal evolution of faces into |
| | learned compact feature representation with the matrix [symbol] ^{4×4} , where the total number |
| | of encoding parameters for each inter frame is 16. |
| 5 | Choose facial semantics as feature mode in the GFV SEI messages. Herein, IFVC [6] |
| | is the representative model which adopts a collection of transmitted compact facial |
| | semantics to represent the face frame, including mouth parameters [symbol] ⁶, eye parameter |
| | [symbol] ¹, rotation parameters [symbol] ³, translation parameters [symbol] ³ and location parameter [symbol] ¹. |
| | Totally, the number of encoding parameters for each inter frame is 14. |

Regarding the definition of gfv_feature_mode in Table 3, if there are other facial feature modes that are different from the given six types, the gfv_feature_mode can be further expanded. In addition, when there are other generative compression models that can show better rate-distortion performance than the representative models given in every feature mode, these existing models can be replaced.

2d_landmark_quantization_factor specifies quantization factor to process the facial semantic parameters (i.e., x[i] and y[i]) in the mode 0. The values of parameters used for face generation are equal to the values of corresponding syntax elements divided by 2d_landmark_quantization_factor.

2d_landmark_num specifies the number of facial landmarks in the 2D coordinate.

x[i] specifies the quantized x-axis value for i_th point in the 2D coordinate.

y[i] specifies the quantized y-axis value for i_th point in the 2D coordinate.

2d_keypoint_quantization_factor specifies quantization factor to process the facial semantic parameters (i.e., x[i], y[i] and affine_transmation_matrix[i][j][k]) in the mode 1. The values of parameters used for face generation are equal to the values of corresponding syntax elements divided by 2d_keypoint_quantization_factor.

2d_keypoint_num specifies the number of facial keypoints in the 2D coordinate.

is_affine_transformation_matrix_flag equal to 1 indicates the SEI message carries the affine transformation parameters. is_affine_transformation_matrix_flag equal to 0 indicates the SEI message dose not carry the affine transformation matrix parameters.

affine_transformation_matrix[i][j][k] specifies the quantized element value from the corresponding affine transformation matrix.

region_quantization_factor specifies quantization factor to process the facial semantic parameters (i.e., x[i], y[i], affine_transmation_matrix[i][j][k] and covariance_matrix[i][m][n]) in the mode2. The values of parameters used for face generation are equal to the values of corresponding syntax elements divided by region_quantization_factor.

region_keypoint_num specifies the number of facial keypoints in the 2D coordinate.

is_covariance_matrix_flag equal to 1 indicates the SEI message carries the covariance matrix parameters. is_covariance_matrix_flag equal to 0 indicates the SEI message dose not carry the covariance matrix parameters.

covariance_matrix[i][m][n] specifies the quantized element value from the corresponding covariance matrix.

3d_keypoint_quantization_factor specifies quantization factor to process the facial semantic parameters (in the mode 3. The values of parameters used for face generation are equal to the values of corresponding syntax elements divided by 3d_keypoint_quantization_factor.

3d_keypoint_num specifies the number of facial keypoints in the 3D coordinate.

is_rotation_matrix_flag equal to 1 indicates the SEI message carries the rotation matrix parameters. is_rotation_matrix_flag equal to 0 indicates the SEI message dose not carry the rotation matrix parameters.

is_translation_matrix_flag equal to 1 indicates the SEI message carries the translation matrix parameters. is_translation_matrix_flag equal to 0 indicates the SEI message dose not carry the translation matrix parameters.

z[i] specifies the quantized z-axis value for i_th point in the 3D coordinate.

rotation_matrix[j][k] specifies the quantized element value from the corresponding rotation matrix.

translation_matrix[l] specifies the quantized element value from the corresponding translation matrix.

compact_feature_quantization_factor specifies quantization factor to process the facial semantic parameters (i.e., compact_feature_matrix_element[k][m][n]) in the mode 4. The values of parameters used for face generation are equal to the values of corresponding syntax elements divided by compact_feature_quantization_factor.

matrix_channel specifies the channel of compact feature and matrix_channel must be equal to or larger than 1.

matrix_width specifies the width (the number of row) of compact feature and matrix_width must be equal to or larger than 1.

matrix_height specifies the height (the number of column) of compact feature and matrix_height must be equal to or larger than 1.

compact_feature_matrix_element specifies the quantized element value from the corresponding facial compact feature.

semantic_quantization_factor specifies quantization factor to process the facial semantic parameters (i.e., semantic_element[l][y][z]) in the mode 5. The values of parameters used for face generation are equal to the values of corresponding syntax elements divided by semantic_quantization_factor.

semantic_type_num specifies the number of facial semantic type in the SEI message. The value of semantic_type_num shall be in the range of 0 to 2⁶, inclusive. It should be mentioned that in our proposed SEI message, the facial semantic type can be categized into mouth parameters, eye parameters, head rotation parameters, head translation parameters and head location parameters.

semantic_idx contains an identifying number regarding which facial semantic may be used in the SEI message.

TABLE 4
Definition of semantic_idx

| Value | Interpretation |
|---|---|
| 0 | Mouth parameters with 1*6 dimension |
| 1 | Eye parameters with 1*1 dimension, |
| | representing the open-close status. |
| 2 | Head rotation parameters with 1*3 dimension, |
| | including yaw, roll and pitch |
| 3 | Head translation parameters with 1*3 |
| | dimension, including x-axis, y-axis |
| | and z-axis |
| 4 | Head location index with 1*1 dimension used |
| | for locate the face from the input image |

Regarding the definition of gfv_feature_mode in Table 4, if there are other facial semantic representations that are different from the given semantic types, the semantic_idx can be further expanded.

semantic_width[l] specifies the width (the number of row) of the l_th semantic type and semantic_width[l] must be equal to or larger than 1.

semantic_height[l] specifies the height (the number of column) of the l_th semantic type and semantic_height[l] must be equal to or larger than 1.

semantic_element[l][y][z] specifies the quantized element value from the corresponding facial semantic.

data_quantization_factor specifies quantization factor to process the facial semantic parameters (i.e., data_element[i]) in the other potential mode. The values of parameters used for face generation are equal to the values of corresponding syntax elements divided by data_quantization_factor.

data_length specifies the length of feature parameters that may be used in other gfv_feature_mode except the given modes.

data_element[i] specifies the quantized value for i_th feature in the data_length.

Table 5 shows an exemplary syntax for the first solution. The process can be preformed as follows.

First, the generative face video SEI message contains an identifying number that may be used to identify the generative face video SEI message.

Second, the parameter present flags for different parameter types are signaled. If a parameter present flag shows the parameters of a current type is present, then the corresponding parameters are signaled. otherwise, the signaling of the parameters of the current type is skipped. In this example, the parameters are categorized into three types: keypoints, matrice and semantics. The semantic type includes parameters indicating the status, motion or location of mouth, eye and head. And the matrix type include affine translation matrix, covariance matrix, translation matrix, rotation matrix, and compact feature matrix.

Third, after receiving and decoding the SEI message, the face video can be reconstructed towards high-quality or user-friendly manner via the strong generation ability of generative adversial network with the parameters signaled in the SEI and the base picture decoded previously as input.

TABLE 5
Exemplary syntax of the proposed generative face video SEI message

| | Descriptor |
|---|---|
| Generative_face_video ( payloadSize ) { | |
| gfv_id | ue(v) |
| coordinate_present_flag | u(1) |
| if(coordinate_present_flag){ | |
| coordinate_quantization_factor | ue(v) |
| is_3D_coordinate_flag | u(1) |
| coordinate_point_num | ue(v) |
| for(i=0; i< coordinate_point_num;i++){ | |
| x[i] | ue(v) |
| y[i] | ue(v) |
| if(is_3D_coordinate_flag){ | |
| z[i] | ue(v) |
| } | |
| } | |
| } | |
| matrix_present_flag | u(1) |
| if(matrix_present_flag){ | |
| matrix_quantization_factor | ue(v) |
| matrix_type_num | ue(v) |
| for(j=0; j<matrix_type_num;j++){ | |
| matrix_idx[j] | ue(v) |
| if(coordinate_present_flag){ | |
| matrix_num_equal_to_coordinate_point _flag[j] | u(1) |
| if(! coordinate_present_flag ∥ ! | |
| matrix_num_equal_to_coordinate_flag[j]){ | |
| matrix_num[j] | ue(v) |
| MatrixNum[j]=matrix_num[j] | |
| } | |
| else{ | |
| MatrixNum[j]= coordinate_point_num | |
| } | |
| } | |
| matrix_width[j] | ue(v) |
| matrix_height[j] | ue(v) |
| for(k=0; k<MatrixNum[j]; k++){ | |
| for(m=0; m< matrix_height[j];m++){ | |
| for(n=0;n<matrix_width[j];n++){ | |
| matrix_element[j][k][m][n]; | ue(v) |
| } | |
| } | |
| } | |
| } | |
| } | |
| semantic_present_flag | u(1) |
| if(semantic_present_flag){ | |
| semantic_quantization_factor | ue(v) |
| semantic_type_num | ue(v) |
| for(l=0; l<semantic_type_num;l++){ | |
| semantic_idx[l] | ue(v) |
| semantic_width[l] | ue(v) |
| semantic_height[l] | ue(v) |
| for(y=0; y< semantic_width[l];y++){ | |
| for(z=0; z< semantic_height[l];z++){ | |
| semantic_element[l][y][z]; | ue(v) |
| } | |
| } | |
| } | |
| } | |
| } | |

The semantics for the above syntax are described as follows.

This SEI message carries facial parameters for different feature representations, such as 2D keypoints, 2D landmarks, 3D keypoints, facial semantics and other formats, which may be used for face generative compression. For these facial representations, they can be categorized into three types, including coordinate parameters, matrix parameters and semantic parameters. Based on the base picture, the facial parameters in the SEI message can be used to reconstruct face picture, and each SEI message is used to generate one face picture.

gfv_id contains an identifying number that may be used to identify a generative face video SEI message. The value of gfv_id shall be in the range of 0 to 2³²−2, inclusive.

coordinate_present_flag equal to 1 indicates the SEI message carries the coordinate parameters. coordinate_present_flag equal to 0 indicates the SEI message dose not carry the coordinate parameters.

coordinate_quantization_factor specifies the quantization factor to process the facial coordinate parameters (i.e., x[i], y[i] and z[i]). The values of parameters used for face generation are equal to the values of corresponding syntax elements divided by coodrinate_quantization_factor.

is_3D_coordinate_flag equal to 1 indicates the coordinate parameters belong to three dimensional space, which can be represented with (x[i], y[i], z[i]). is_3D_coordinate_flag equal to 0 indicates the coordinate parameters belong to two dimensional space, which can be represented with (x[i], y[i]).

coordinate_point_num specifies the number of facial coordinate parameter set in the SEI message. One set of parameters represents one point in the coordinate. The value of coordinate_point_num shall be in the range of 0 to 2¹⁰, inclusive.

x[i] specifies the quantized x-axis value for i_th keypoint.

y[i] specifies the quantized y-axis value for i_th keypoint.

z[i] specifies the quantized z-axis value for i_th keypoint.

matrix_present_flag equal to 1 indicates the SEI message carries the matrix parameters. matrix_present_flag equal to 0 indicates the SEI message dose not carry the matrix parameters.

matrix_quantization_factor specifies the quantization factor to process the facial matrix parameters (i.e., matrix_element[j][k][m][n]). The values of parameters used for face generation are equal to the values of corresponding syntax elements divided by matrix_quantization_factor.

matrix_type_num specifies the number of facial matrix type in the SEI message. The value of matrix_type_num shall be in the range of 0 to 2⁶, inclusive. It should be mentioned that in our proposed SEI message, the facial matrix type can be categized into affine translation matrix, covariance matrix, rotation matrix, translation matrix and compact feature matrix. And these matrices can be further distinguished whether is related with the points in the coordinate.

matrix_idx contains an identifying number regarding which facial matrix may be used in the SEI message.

TABLE 6
Definition of matrix_idx

| matrix_idx | Interpretation |
|---|---|
| 0 | Affine translation matrix corresponding |
| | to the coordinate_point_num. |
| | Every keypoint in the coordinate may |
| | have a group of 2*2 affine translation matrix. |
| 1 | Covariance matrix corresponding to the |
| | coordinate_point_num. Every keypoint in the |
| | coordinate may have a group of 2*2 covariance matrix. |
| 2 | Rotation matrix with 3*3 dimension |
| | to represent the head rotation |
| 3 | Tranlation matrix with 1*3 dimension |
| | to represent the head translation |
| 4 | Compact feature matrix with 4*4 dimension |

Regarding the definition of matrix_idx in Table 6, if there are other facial matrix representations that are different from the given matrix types, the matrix_idx can be further expanded.

matrix_num_equal_to_coordinate_point_flag[j] equal to 1 indicates the number of facial matrices is equal to coordinate_point_num.

matrix_num[j] specifies the number of facial matrix when coordinate_present_flag or matrix_num_equal_to_coordinate_point_flag[j] do not exist. Otherwise, if these two flags both exist, the number of facial matrices is equal to coordinate_point_num.

matrix_width[j] specifies the width (the number of row) of the j_th facial matrix and matrix_width[j] must be equal to or larger than 1.

matrix_height[j] specifies the height (the number of column) of the j_th facial matrix and matrix_height[j] must be equal to or larger than 1.

matrix_element[j][k][m][n] specifies the quantized element value from the corresponding facial matrix.

semantic_present_flag equal to 1 indicates the SEI message carries the semantic parameters. semantic_present_flag equal to 0 indicates the SEI message dose not carry the semantic parameters.

semantic_quantization_factor specifies quantization factor to process the facial semantic parameters (i.e., semantic_element[l][y][z]). The values of parameters used for face generation are equal to the values of corresponding syntax elements divided by semantic_quantization_factor.

semantic_type_num specifies the number of facial semantic type in the SEI message. The value of semantic_type_num shall be in the range of 0 to 2⁶, inclusive. It should be mentioned that in our proposed SEI message, the facial semantic type can be categized into mouth parameters, eye parameters, head rotation parameters, head translation parameters and head location parameters.

semantic_idx contains an identifying number regarding which facial semantic may be used in the SEI message.

TABLE 7
Definition of semantic_idx

| semantic_idx | Interpretation |
|---|---|
| 0 | Mouth parameters with 1*6 dimension |
| 1 | Eye parameters with 1*1 dimension, |
| | representing the open-close status. |
| 2 | Head rotation parameters with 1*3 dimension, |
| | including yaw, roll and pitch |
| 3 | Head translation parameters with 1*3 dimension, |
| | including x-axis, y-axis and z-axis |
| 4 | Head location index with 1*1 dimension |
| | used for locate the face from the input image |

Regarding the definition of semantic_idx in Table 7, if there are other facial semantic representations that are different from the given semantic types, the semantic_idx can be further expanded.

semantic_width[l] specifies the width (the number of row) of the l_th semantic type and semantic_width[l] must be equal to or larger than 1.

semantic_height[l] specifies the height (the number of column) of the l_th semantic type and semantic_height[l] must be equal to or larger than 1.

semantic_element[l][y][z] specifies the quantized element value from the corresponding facial semantic.

An example of the proposed syntax of the common SEI message for generative face video is shown in Table 8. The process can be seen as follows.

First, a key gfv_key that may be used to determine whether the current generative face video SEI message matches with the generative network is signaled. The decoder or the post-processor may generate the face pictures with the received SEI message only if it contains a known gfv_key that is specified in the application; otherwise the parameters in the received SEI message may be extracted with a network that is not matched with the generative network in the decoder or the post-processor and the decoder or the post-process should ignore the received SEI message and not to generate the face pictures. And then the picture order count gfv_pic_order_cnt is signaled to indicate the order of the picture generated by this SEI message.

Second, the parameter present flags for different parameter types are signaled. If a parameter present flag shows the parameters of the current type is present, then the corresponding parameters are signaled. Otherwise, the signaling of the parameters of the current type is skipped. In the disclosed embodiments, the parameters are categorized into two types: keypoints and matrice. Compared with the embodiment associated with Table 5, the semantic type is merged into matrix type. In one example, the matrix type includes affine translation matrix, covariance matrix, mouth matrix, eye matrix, head rotation matrix, head translation matrix, head location matrix and compact feature matrix. In another example, the matrix type includes affine translation matrix, covariance matrix, compact feature matrix and semantic matrix. The semantic matrix type further includes mouth parameter matrix, eye parameter matrix, head rotation parameter matrix, head translation matrix and head location matrix.

Third, after receiving and decoding the SEI message, the face video can be reconstructed towards high-quality or user-friendly manner via the strong generation ability of generative adversial network with the parameters signaled in the SEI and the base picture decoded previously as input.

TABLE 8
Exemplary syntax of the proposed generative face video SEI message

| | Descriptor |
|---|---|
| generative_face_video ( payloadSize ) { | |
| gfv_key | u(32) |
| gfv_pic_order_cnt | u(32) |
| coordinate_present_flag | u(1) |
| if ( coordinate_present_flag ) { | |
| coordinate_precision_factor_minus1 | ue(v) |
| num_coordinates_minus1 | ue(v) |
| coordinate_z_present_flag | u(1) |
| if ( coordinate_z_present_flag ) | |
| coordinate_z_max_value_minus1 | ue(v) |
| for ( i=0; i< num_coordinates_minus1; i++ ) { | |
| coordinate_x_abs[ i ] | u(v) |
| if ( coordinate_x_abs[ i ] ) | |
| coordinate_x_sign_flag[ i ] | u(1) |
| coordinate_y_abs[ i ] | u(v) |
| if ( coordinate_y_abs[ i ] ) | |
| coordinate_y_sign_flag[ i ] | u(1) |
| if ( coordinate_z_present_flag ) { | |
| coordinate_z_abs[ i ] | u(v) |
| if ( coordinate_z_abs[ i ] ) | |
| coordinate_z_sign_flag[ i ] | u(1) |
| } | |
| } | |
| } | |
| matrix_present_flag | u(1) |
| if ( matrix_present_flag ) { | |
| matrix_element_precision_factor_minus1 | ue(v) |
| num_matrix_types_minus1 | ue(v) |
| for ( i=0; i <= num_matrix_types_minus1; i++ ) { | |
| matrix_type_idx[ i ] | u(6) |
| if ( matrix_type_idx[ i ] == 0 ∥ matrix_type_idx[ i ] == 1) { | |
| if ( coordinate_present_flag ) | |
| num_matrices_equal_to_num_coordinates_flag[ i ] | u(1) |
| if ( !coordinate_present_flag | |
| ∥ !num_matrix_equal_to_num_coordinates_flag[ i ] ) | |
| num_matrices_info[ i ] | ue(v) |
| } | |
| else if ( matrix_type_idx[ i ] == 2 ∥ matrix_type_idx[ i ] == 3 ∥ | |
| matrix_type_idx[ i ] >= 7 ) { | |
| if ( matrix_type_idx[ i ] >= 7 ) | |
| num_matrices_minus1[ i ] | u(1) |
| matrix_width_minus1[ i ] | ue(v) |
| matrix_height_minus1[ i ] | ue(v) |
| } | |
| else if ( matrix_type_idx[ i ] >= 4 && matrix_type_idx[ i ] <= 6 | |
| && !coordinate_present_flag ) | |
| matrix_for_3D_space_flag[ i ] | u(1) |
| for ( j=0; j<= numMatrices[ i ]; j++ ) { | |
| for ( k=0; k<= matrix_height_minus1[ i ]; k++) { | |
| for ( l=0;l<=matrix_width_minus1[ i ]; l++ ) { | |
| matrix_element_int[ i ][ j ][ k ][ l ] | ue(v) |
| matrix_element_dec[ i ][ j ][ k ][ l ] | u (v) |
| if ( matrix_element_int[ i][ j ][ k ][ l ] ∥ | |
| matrix_element_dec[ i ][ j ][ k ][ l ] ) | |
| matrix_element_sign_flag[ i ][ j ][ k ][ l ] | u(1) |
| } | |
| } | |
| } | |
| } | |
| } | |
| } | |

This SEI message specifies the syntax and semantics of a variety of facial representations that may be used by a deep generative network to generate pictures based on a base picture. The base picture is a picture that provides the texture information needed by the deep generative network. The base picture may be coded as a bitstream conforming to Rec. ITU-T H.264, Rec. ITU-T H.265, Rec. ITU-T H.266, etc. Decoder may decode the base picture from the conforming bitstream as the first picture of the sequence and the following pictures may be generated with a deep generative network using syntax elements signaled in generative face video SEI message. Or the decoder may decode the base picture from the conforming bitstream periodically. Based on the base picture, a number of subsequent pictures may be generated with a deep generative network using syntax elements signaled in the generative face video SEI message. The texture of the base picture and the additionally generated pictures are expected to mainly contain talking face.

Use of this SEI message requires the definition of the following variables:
Cropped decoded output base picture width and height in units of luma samples, denoted herein by CroppedWidth and CroppedHeight, respectively.
Luma sample array CroppedYPic and chroma sample arrays CroppedCbPic and CroppedCrPic of the cropped decoded output base picture.
A chroma format indicator, denoted herein by ChromaFormatId.

The variables SubWidthC and SubHeightC derived from ChromaFormatIdc.

gfv_key indicates a key that may be used to identify the analysis network used to generate the syntax elements of the current generative face video SEI message. The value of gfv_key may be used to determine whether the analysis network at the encoder matches with the generative network at the decoder.

The generative network at the decoder may use the SEI message to generate the video pictures only if it recognizes the value of gfv_key. The value of gfv_key may be specified by the applications that rely on matching networks at the encoder and the decoder. For such applications, if the parameters in the received SEI message are extracted with an analysis network that is not matched with the generative network at the decoder, the generative network should ignore the received SEI message.

gfv_pic_order_cnt specifies the display order count modulo 1<<31 of the picture generated with the current SEI message.

coordinate_present_flag equal to 1 indicates that the coordinate information of keypoints is present. coordinate_present_flag equal to 0 indicates coordinate information of keypoints is not present.

It is a requirement of bitstream conformance that when matrix_type_idx[i] for any i from 0 to num_matrix_types_minus1 is equal to 0 or 1, the value of coordinate_present_flag shall be equal to 1

coordinate_precision_factor_minus1 plus 1 indicates the length, in bits, of coordinate_x, coordinate_y and coordinate_z.

In some embodiments, the low bound of precision can be larger than 1. for example, it may be k and the syntax element can be changed to coordinate_precision_factor_minusk. coordinate_precision_factor_minusk plus k indicates the length, in bits, of coordinate_x, coordinate_y and coordinate_z.

num_coordinates_minus1 plus 1 indicates the number of keypoint coordinates. The value of num_coordinates_minus1 shall be in the range of 0 to 210-1, inclusive.

coordinate_z_present_flag equal to 1 indicates z-axis coordinate information of the keypoints is present. coordinate_z_present_flag equal to 0 indicates that the z-axis coordinate information of the keypoints is not present. When coordinate_z_present_flag is not present, it is inferred to be 0.

coordinate_z_max_value_minus1 plus 1 indicates the maximum absolute value of z-axis coordinates of keypoints.

In some embodiments, the lower bound of maximum value of z-axis coordinate may be greater than 1. for example, it can be k and the syntax element signaled is changed to coordinate_z_max_value_minusk. coordinate_z_max_value_minusk plus k indicates the maximum absolute value of z-axis coordinates of keypoints.

coordinate_x_abs[i] specifies the normalized absolute value of x-axis coordinate of the i-th keypoint.

coordinate_x_sign_flag[i] specifies the sign of x-axis coordinate of the i-th keypoint. When coordinate_x_sign_flag[i] is not present, it is inferred to be equal to 0.

coordinate_y_abs[i] specifies the normalized absolute value of y-axis coordinate of i-th keypoint.

coordinate_y_sign_flag[i] specifies the sign of y-axis coordinate of i-th keypoint. When coordinate_y_sign_flag[i] is not present, it is inferred to be equal to 0.

coordinate_z_abs[i] specifies the normalized absolute value of z-axis coordinate of i-th keypoint.

coordinate_z_sign_flag[i] specifies the sign of z-axis coordinate of i-th keypoint. When coordinate_z_sign_flag[i] is not present, it is inferred to be equal to 0.

The variable coordiateX[i], coordiateY[i] and coordiateZ[i] indicating the x-axis coordinate, y-axis coordinate and z-axis coordinate of the i-th keypoint respectively are derived as follows:

$$coordiateX [ i ] = \frac{\begin{matrix}( 1 - 2 * coordinate\_x \_sign \_flag [ i ] ) * \\ coordinate\_x \_abs [ i ] * CroppedWidth\end{matrix}}{1 ≪ ( coordinate\_precision \_factor \_minus1 + 1 )}$$

$$coordiateY [ i ] = \frac{\begin{matrix}( 1 - 2 * coordinate\_y \_sign \_flag [ i ] ) * \\ coordinate\_y \_abs [ i ] * CroppedHeight\end{matrix}}{1 ≪ ( coordinate\_precision \_factor \_minus1 + 1 )}$$

$$coordiateZ [ i ] = \frac{\begin{matrix}( 1 - 2 * coordinate\_z \_sign \_flag [ i ] ) * coordinate\_z \_abs [ i ] * \\ ( coordinate\_z \_max \_value \_minus1 + 1 )\end{matrix}}{1 ≪ ( coordinate\_precision \_factor \_minus1 + 1 )}$$

matrix_present_flag equal to 1 indicates that matrix parameters are present. matrix_present_flag equal to 0 indicates that matrix parameters are not present.

matrix_element_precision_factor_minus1 plus 1 indicates the length, in bits, of matrix_element_dec[i][j][k][l].

num_matrix_types_minus1 plus 1 indicates the number of matrix types signaled in the SEI message. The value of matrix_type_num_minus1 shall be in the range of 0 to 26−1, inclusive.

matrix_type_idx[i] indicates the index of the i-th matrix type as specified in Table 9.

TABLE 9
Specification of matrix_type_idx

| Value | Specification |
|---|---|
| 0 | Affine translation matrix with the size of 2*2 or 3*3. |
| 1 | Covariance matrix with size of 2*2 or 3*3. |
| 2 | Mouth matrix representing mouth motion. |
| 3 | Eye matrix representing the open-close |
| | status and level of the eyes. |
| 4 | Head rotation parameters with the size |
| | of 2*2 or 3*3 representing the head |
| | rotation in 2D space or 3D space. |
| 5 | Head translation matrix with the size |
| | of 1*2 or 1*3 representing head |
| | translation in 2D space or 3D sapce. |
| 6 | Head location matrix with size of 1*2 or |
| | 1*3 to representing the head |
| | location in 2D space or 3D space. |
| 7 | Compact feature matrix with the size being specified |
| | by matrix_width_minus1[i] and |
| | matrix_height_minus1[i]. |
| 8 . . . 31 | Other undefined matrix with the size being specified |
| | by matrix_width_minus1[i] and |
| | matrix_height_minus1[i]. |
| 32 . . . 63 | Reserverd |

The undefined matrxi type is used to represent the matrxi type rather than affine translation matrix, covariance matrix, rotation matrix, translation matrix and compact feature matrix. It is may be used by the user to extend the matrix type.

num_matrices_equal_to_num_coordinates_flag[i] equal to 1 indicates the number of matrices of the i-th matrix type is equal to num_coordinates_minus1+1. num_matrices_equal_to_num_coordinates_flag[i] equal to 0 indicates the number of matrices of the i-th matrix type is not equal to num_coordinates_minus1+1.

num_matrices_info[i] provides information to derive the number of the matrices of the i-th matrix type.

matrix_width_minus1[i] plus 1 indicates the width of the matrix of i-th matrix type.

When matrix_width_minus1[i] is not present, it is inferred as follows. If matrix_type_idx[i] is equal to 0, 1 or 4, and coordinate_z_present_flag is 1, matrix_width_minus1[i] is inferred to be equal to 2. Otherwise, if matrix_type_idx[i] is equal to 0, 1 or 4, and coordinate_z_present_flag is 0, matrix_width_minus1[i] is inferred to be equal to 1. Otherwise (matrix_type_idx[i] is equal to 5 or 6), matrix_width_minus1[i] is inferred to be equal to 0.

matrix_height_minus1[i] plus 1 indicates the height of the matrix of the i-th matrix type. When matrix_height_minus1[i] is not present, it is inferred as follows. If matrix_type_idx is equal to 0, 1, 4, 5 or 6, and coordinate_z_present_flag is 1, matrix_height_minus1[i] is inferred to be equal to 2. Otherwise (matrix_type_idx is equal to 0, 1, 4, 5 or 6, and coordinate_z_present_flag is 0), matrix_height_minus1[i] is inferred to be equal to 1.

num_matrices_minus1[i] plus 1 indicates the number of matrices of the i-th matrix type.

matrix_for_3D_space_flag[i] equal to 1 indicates the matrix of the i-th matrix type is a matrix for three-dimension space. matrix_size_flag[i] equal to 0 indicates the matrix of the i-th matrix type is a matrix for two-dimension space.

The variable numMatrices[i] indicating the number of the matrices of the i-th matrix type is derived as follows:

```
if ( matrix_type_idx[ i ] == 0 ∥ matrix_type_idx[ i ] == 1 ) {
  if ( coordinate_present_flag )
      numMatrices[ i ] = num_matrices_equal_to_num_coordinates_flag[ i ] ?
num_coordinates_minus1 + 1 : ( num_matrices_idc[ i ] < num_coordinates_minus1 ?
num_matrices_idc[ i ] + 1 : num_matrices_idc[ i ] + 2 )
  else
    numMatrices[ i ] = num_matrices_idc[ i ] + 1
}
else if ( matrix_type_idx[ i ] >= 2 && matrix_type_idx[ i ] < 7)
  numMatrices[ i ] = 1
else
  numMatrices[i] = num_matrices_minus1[i] + 1
```

matrix_element_int[i][j][k][l] indicates the integer part of the value of the matrix element at position (k, l) of the j-th matrix of the i-th matrix type.

matrix_element_dec[i][j][k][l] indicates the decimal part of the value of the matrix element at position (k, l) of the j-th matrix of the i-th matrix type.

matrix_element_sign_flag[i][j][k][l] indicates the sign of the matrix element at position (k, l) of the j-th matrix of the i-th matrix type. When matrix_element_sign_flag[i][j][k][l] is not present, it is inferred to be equal to 0.

The variable MatrixElementVal[i][j][k][l] representing the value of the matrix element at position (k, l) of the j-th matrix of the i-th matrix type is derived as follows:

$$matrixElementVal [ i ] [ j ] [ k ] [ l ] = ( 1 - 2 * matrix\_element \_sign \_flag [ i ] [ j ] [ k ] [ l ] ) * ( matrix\_element \_int [ i ] [ j ] [ k ] [ l ] + \frac{matrix\_element \_dec [ i ] [ j ] [ k ] [ l ]}{1 << ( matrix\_element \_precision \_factor \_minus1 + 1 )} )$$

The process DeriveInputTensors( ), for deriving the input tensor inputTensorImgY, inputTensorImgCb, inputTesnsorImgCr, inputTensorKeyPoint, inputTensorMatrix is specified as follows:

```
Initialize inputTensorImgY, inputTensorImgCb, inputTesnsorImgCr, inputTensorKeyPoint
and inputTensorMatrix with 0.
for ( x = 0; x< CroppedWidth; x++ ) {
  for ( y = 0; y< CroppedHeight; y++ ) {
      inputTsensorImgY[ x ][ y ] = CroppedYPic[ x ][ y ]
    }
}
for ( x=0; x< CroppedWidth/ SubWidthC; x++ ) {
  for ( y=0; y< CroppedHeight/ SubHeightC; y++ ) {
      inputTsensorImgCb[ x][ y ] = CroppedCbPic[ x][ y ]
      inputTsensorImgCr[ x][ y ] = CroppedCrPic[ x ][ y ]
    }
}
if ( coordinate_present_flag ) {
    for ( i=0; i< =num_coordinates_minus1; i++ ) {
        inputTensorKeyPoint[ i ][ 0 ] = coordiateX[ i ]
        inputTensorKeyPoint[ i ][ 1 ] = coordiateY[ i ]
        if ( coordinate_z_present_flag )
          inputTensorKeyPoint[ i ][ 2 ] = coordiateZ[ i ]
    }
}
if ( matrix_present_flag ) {
    for ( i=0; i<=num_matrix_types_minus1; i++ ) {
        for ( j=0; j< numMatrices[ i ]; j++ ) {
          for( k=0; k<= matrix_height_minus1[ i ]; k++ ) {
            for ( l=0;l<=matrix_width_minus1[ i ]; l++) {
            inputTensorMatrix[ i ][ j ][ k ][ l ] = matrixElementVal[ i ][ j][ k][ l ]
            }
          }
        }
    }
        }
```

The process StoreOutputTensors( ), for deriving output sample arrays OutputYPic, OutputCbPic, and OutputCrPic from the output tensor outputTensorY, outputTensorCb and outputTensorCr is specified as follows:

```
for(x=0; x< CroppedWidth; x++){
  for(y=0; y< CroppedHeight; y++){
      OutputYPic[ x ][ y ] = outputTensorY[ x ][ y ]
    }
}
for(x=0; x< CroppedWidth/ SubWidthC; x++){
  for(y=0; y< CroppedHeight/ SubHeightC; y++){
      OutputCbPic[ x ][ y ] = outputTensorCb[ x ][ y ]
      OutputCdPic[ x][ y ] = outputTensorCr[ x ][ y ]
}
```

The following process is used to generate a video picture, where PictureGeneration( ) is a deep generative network based process to output the picture sample values with parameters signaled in the face generation SEI message and the decoded base picture as input.

```
{
  DeriveInputTensors( )
  outputTensor = PictureGeneration ( inputTensorImgY,
inputTensorImgCb, inputTesnsorImgCr, inputTensorKeyPoint,
inputTensorMatrix)
  StoreOutputTensors( )
}
```

In some embodiments, to solve the interoperability issue, the generative neural network is divided into two sub-networks.

As an example, the first sub-network is a flow translator network which transfers the parameters signaled in SEI message into flow map and the second sub-network is a generative network which generates the pictures based on the flow map output by the first sub-network. The flow translator network could support different types of facial representations for different algorithms and transfer all these facial representation parameters into a flow map. Thus, the generative network can be fixed regardless of the facial representation signaled in the SEI message, as the input of the generative network is always a flow map.

As another example, the first sub-network is a parameter translator network which translates the facial representation parameters signaled in the SEI message into a specified type of parameters. and the second sub-network is a generative network which generates the picture based on the specified type of facial representation parameters. In this case, the generative network is also fixed as it only supports the specified type of parameters as input.

In the above embodiments, the SEI message can directly signal the network or can provide a URI for the sub-network. to indicate what type of network is signaled in the SEI message. For example, a network indicator can be signaled to indicate what type of network is signaled in the SEI message.

The network signaled or indicated in the SEI message can be updated. The first SEI message in the current CLVS signals or indicates a network as a base GFV and the subsequent SEI message can update the base GFV by signaling or indicating a updated network.

In the following description, the syntax and semantics changed from the current technique are italicized.

TABLE 10
An example of syntax of the proposed face
video generative compression SEI message

| | Descriptor |
|---|---|
| generative_face_video ( payloadSize ) { | |
| gfv_{—}id | ue(v) |
| gfv_{—}key_{—}present_{—}flag | |
| if( gfv_{—}key_{—}present_{—}flag ) { | |
| gfv_{—}key | u(32) |
| else { | |
| gfv_{—}nn_{—}mode_{—}idc | ue(v) |
| gfv_{—}nn_{—}type_{—}idc | |
| if( gfv_{—}nn_{—}mode_{—}idc = = 1 ) { /*specify the complete decoder ( )*/ | |
| while( !byte_{—}aligned( ) ) | |
| gfv_{—}nn_{—}reserved_{—}zero_{—}bit_{—}a | u(l) |
| gfv_{—}nn_{—}tag_{—}uri | st(v) |
| gfv_{—}nn_{—}uri | st(v) |
| } | |
| } | |
| coordinate_present_flag | u(1) |
| if ( coordinate_present_flag ) { | |
| coordinate_precision_factor_minus1 | ue(v) |
| num_coordinates_minus1 | ue(v) |
| coordinate_z_present_flag | u(1) |
| if ( coordinate_z_present_flag ) | |
| coordinate_z_max_value_minus1 | ue(v) |
| for ( i=0; i< num_coordinates_minus1; i++ ) { | |
| coordinate_x_abs[ i ] | u(v) |
| if ( coordinate_x_abs[ i ] ) | |
| coordinate_x_sign_flag[ i ] | u(1) |
| coordinate_y_abs[ i ] | u(v) |
| if ( coordinate_y_abs[ i ] ) | |
| coordinate_y_sign_flag[ i ] | u(1) |
| if ( coordinate_z_present_flag ) { | |
| coordinate_z_abs[ i ] | u(v) |
| if ( coordinate_z_abs[ i ] ) | |
| coordinate_z_sign_flag[ i ] | u(1) |
| } | |
| } | |
| } | |
| matrix_present_flag | u(1) |
| if ( matrix_present_flag ) { | |
| matrix_element_precision_factor_minus1 | ue(v) |
| num_matrix_types_minus1 | ue(v) |
| for ( i=0; i <= num_matrix_types_minus1; i++ ) { | |
| matrix_type_idx[ i ] | u(6) |
| if ( matrix_type_idx[ i ] == 0 ∥ matrix_type_idx[ i ] == 1) { | |
| if ( coordinate_present_flag ) | |
| num_matrices_equal_to_num_coordinates_flag[ i ] | u(1) |
| if ( !coordinate_present_flag | |
| ∥ !num_matrix_equal_to_num_coordinates_flag[ i ] ) | |
| num_matrices_info[ i ] | ue(v) |
| } | |
| else if ( matrix_type_idx[ i ] == 2 ∥ matrix_type_idx[ i ] == 3 ∥ | |
| matrix_type_idx[ i ] >= 7 ) { | |
| matrix_width_minus1[ i ] | ue(v) |
| matrix_height_minus1 [ i ] | ue(v) |
| if ( matrix_type_idx[ i ] >= 7 ) | |
| num_matrices_minus1 [ i ] | |
| } | |
| for ( j=0; j<= num_matrices_minus1[ i ]; j++ ) { | |
| for ( k=0; k<= matrix_height_minus1[ i ]; k++ ) { | |
| for ( l=0;l<=matrix_width_minus1[ i ]; 1++ ) { | |
| matrix_element_int[ i ][ j ][ k ][ l ] | ue(v) |
| matrix_element_dec[ i ][ j ][ k ][ l ] | u (v) |
| if ( matrix_element_int[ i][ j ][ k ][ l ] ∥ | |
| matrix_element_dec[ i ][ j ][ k ][ l ] ) | |
| matrix_element_sign_flag[ i ][ j ][ k ][ l ] | u(1) |
| } | |
| } | |
| } | |
| } | |
| } | |
| if(gfv_{—}nn_{—}mode_{—}idc = = 0 ) { | |
| while( !byte_{—}aligned( ) ) | |
| gfv_{—}nn_{—}reserved_{—}zero_{—}bit_{—}b | u(1) |
| for( i = 0; more_{—}data_{—}in_{—}payload( ); i++ ) | |
| gfv_{—}nn_{—}payload_{—}byte [ i ] | b(8) |
| } | |
| } | |

The generative face video (GFV) SEI message indicates facial parameters and specifies a neural network, denoted as Generator( ), which may be used to generate novel output pictures using the indicated facial parameters and previously decoded output pictures. The network Generator( ) is further divided into a translator sub-network Translator( ) and a picture generation network Decoder( ). In one example, Translator( ) converts the facial parameters into a flow-map and Decoder( ) generates pictures based on the flow-map output by Translator( ). In another example, Translator( ) translates the facial parameters signaled in the SEI message into a specified type of parameters and Decoder( ) generates pictures based on specified type of facial parameters output by Translator( ).

It is noted that facial parameters can be determined from source pictures prior to encoding.

It is also noted that when the current picture is not a base picture, the GFV SEI message may be used to generate a novel face picture based on the previously decoded base picture, the facial parameters conveyed by the GFV SEI message, and/or, optionally, the fusion picture. Base and fusion pictures may be coded conforming to Rec. ITU-T H.264, Rec. ITU-T H.265, Rec. ITU-T H.266, etc.

Use of this SEI message requires the definition of the following variables:
Input picture width and height in units of luma samples, denoted herein by CroppedWidth and CroppedHeight, respectively.
Luma sample array baseCroppedYPic and chroma sample arrays baseCroppedCbPic and baseCroppedCrPic for a decoded output picture, denoted as BasePicture, corresponding to a source base picture.
Luma sample array driveCroppedYPic and chroma sample arrays driveCroppedCbPic and driveCroppedCrPic for a decoded output picture, denoted as DrivePicture, corresponding to a source driving picture.
Bit depth BitDepthY for the luma sample array of the input pictures.
Bit depth BitDepthC for the chroma sample arrays, if any, of the input pictures.

gfv_id contains an identifying number that may be used to identify face feature information and specify a neural network that may be used as Generator( ). The value of gfv_id shall be in the range of 0 to 232-−2, inclusive. Values of gfv_id from 256 to 511, inclusive, and from 231 to 232-−2, inclusive, are reserved for future use by ITU-T|ISO/IEC. Decoders conforming to this edition of this document encountering a GFV SEI message with gfv_id in the range of 256 to 511, inclusive, or in the range of 231 to 232-−2, inclusive, shall ignore the SEI message.

It is noted that different values of gfv_id in different GFV SEI messages can be used to identify different faces when more than one face is present in an output picture, for example.

gfv_key_present_flag equal to 1 indicates that the syntax element gfv_key is present and the syntax elements gfv_nn_mode_idc, gfv_nn_reserved_zero_bit_a, gfv_nn_tag_uri, gfv_nn_uri, gfv_nn_payload_byte[i] are not present. gfv_key_present_flag equal to 0 indicates that the syntax element gfv_key is not present and the syntax elements gfv_nn_mode_idc, gfv_nn_reserved_zero_bit_a, gfv_nn_tag_uri, gfv_nn_uri, gfv_nn_payload_byte[i].

gfv_key indicates a key that may be used to identify the analysis network used to generate the syntax elements of the current generative face video SEI message.

It is noted that the value of gfv_key may be used to determine whether the analysis network at the encoder matches with the generative network at the decoder. The generative network at the decoder may use the SEI message to generate the video pictures only if it recognizes the value of gfv_key. The value of gfv_key may be specified by the applications that rely on matching networks at the encoder and the decoder. For such applications, if the parameters in the received SEI message are extracted with an analysis network that is not matched with the generative network at the decoder, the generative network can ignore the received SEI message.

gfv_nn_mode_idc, when equal to 0, indicates that the neural network information is contained in the GFV SEI message, and the neural network information is in the format of an ISO/IEC 15938-17 bitstream. gfv_nn_mode_idc equal to 1 indicates that the neural network information is identified by the URI indicated by gfv_nn_uri with the format identified by the tag URI gfv_nn_tag_uri.

The value of gfv_nn_mode_idc is in the range of 0 to 255, inclusive. Values of 2 to 255, inclusive, for gfv_nn_mode_idc are reserved for future use by ITU-T|ISO/IEC and is not present in bitstreams conforming to ITU-T|ISO/IEC. Decoders conforming to ITU-T|ISO/IEC can ignore GFV SEI messages with gfv_nn_mode_idc in the range of 2 to 255, inclusive.

gfv_nn_type_idc indicates the type of network contained or indicated by the GFV SEI message.

When gfv_nn_type_idc equal to 0, the Generator( ) is contained or indicated in the GFV SEI message. The network is a complete picture generator with a motion estimation module for converting facial parameters into flow map and a frame generation module for reconstructing face image.

When gfv_nn_type_idc equal to 1, the Translator( ) is contained or indicated in the GFV SEI message. And the Translator( ) is a network converting the different types of facial parameters signaled in the SEI message into a flow-map for picture generation.

When gfv_nn_type_idc equal to 2, the Translator ( ) is contained or indicated in the GFV SEI message. And the Translator( ) is a network converting the different types of facial parameters into a specified type of facial parameters.

When gfv_nn_type_idc equal to 3, the Decoder ( ) is contained or indicated in the GFV SEI message. Decoder ( ) generates the pictures based on the flow-map or a specified type of facial parameters as input.

gfv_nn_reserved_zero_bit_a is equal to 0.

gfv_nn_tag_uri contains a tag URI with syntax and semantics as specified in IETF RFC 4151 identifying the format and associated information about the neural network used as a base GFV or an update relative to the base GFV with the same gfv_id value specified by gfv_nn_uri.

gfv_nn_tag_uri equal to “tag:iso.org,2023:15938-17” indicates that the neural network data identified by gfv_nn_uri conforms to ISO/IEC 15938-17.

gfv_nn_uri contains a URI with syntax and semantics as specified in IETF Internet Standard 66 identifying the neural network used as a base GFV or an update relative to the base GFV with the same gfv_id value.

coordinate_present_flag equal to 1 indicates that the coordinate information of keypoints is present. coordinate_present_flag equal to 0 indicates coordinate information of keypoints is not present.

coordinate_precision_factor_minus1 plus 1 indicates the length, in bits, of coordinate_x, coordinate_y and coordinate_z.

In some embodiments, the low bound of precision can be larger than 1. For example, it may be k and the syntax element can be changed to coordinate_precision_factor_minusk. coordinate_precision_factor_minusk plus k indicates the length, in bits, of coordinate_x, coordinate_y and coordinate_z.

num_coordinates_minus1 plus 1 indicates the number of keypoint coordinates. The value of num_coordinates_minus1 is in the range of 0 to 210−1, inclusive.

coordinate_z_present_flag equal to 1 indicates z-axis coordinate information of the keypoints is present. coordinate_z_present_flag equal to 0 indicates that the z-axis coordinate information of the keypoints is not present. When coordinate_z_present_flag is not present, it is inferred to be 0.

coordinate_z_max_value_minus1 plus 1 indicates the maximum absolute value of z-axis coordinates of keypoints.

In some embodiments, the lower bound of maximum value of z-axis coordinate may be greater than 1. for example, it can be k and the syntax element signaled is changed to coordinate_z_max_value_minusk. coordinate_z_max_value_minusk plus k indicates the maximum absolute value of z-axis coordinates of keypoints.

coordinate_x_abs[i] specifies the normalized absolute value of x-axis coordinate of the i-th keypoint.

coordinate_x_sign_flag[i] specifies the sign of x-axis coordinate of the i-th keypoint. When coordinate_x_sign_flag[i] is not present, it is inferred to be equal to 0.

coordinate_y_abs[i] specifies the normalized absolute value of y-axis coordinate of i-th keypoint.

coordinate_y_sign_flag[i] specifies the sign of y-axis coordinate of i-th keypoint. When coordinate_y_sign_flag[i] is not present, it is inferred to be equal to 0.

coordinate_z_abs[i] specifies the normalized absolute value of z-axis coordinate of i-th keypoint.

coordinate_z_sign_flag[i] specifies the sign of z-axis coordinate of i-th keypoint. When coordinate_z_sign_flag[i] is not present, it is inferred to be equal to 0.

The variable coordiateX[i], coordiateY[i] and coordiateZ[i] indicating the x-axis coordinate, y-axis coordinate and z-axis coordinate of the i-th keypoint respectively are derived as follows:

$$coordiateX [ i ] = \frac{\begin{matrix}( 1 - 2 * coordinate\_x \_sign \_flag [ i ] ) * \\ coordinate\_x \_abs [ i ] * CroppedWidth\end{matrix}}{1 ≪ ( coordinate\_precision \_factor \_minus1 + 1 )}$$

$$coordiateY [ i ] = \frac{\begin{matrix}( 1 - 2 * coordinate\_y \_sign \_flag [ i ] ) * \\ coordinate\_y \_abs [ i ] * CroppedHeight\end{matrix}}{1 ≪ ( coordinate\_precision \_factor \_minus1 + 1 )}$$

$$coordiateZ [ i ] = \frac{\begin{matrix}( 1 - 2 * coordinate\_z \_sign \_flag [ i ] ) * coordinate\_z \_abs [ i ] * \\ ( coordinate\_z \_max \_value \_minus1 + 1 )\end{matrix}}{1 ≪ ( coordinate\_precision \_factor \_minus1 + 1 )}$$

matrix_present_flag equal to 1 indicates that matrix parameters are present. matrix_present_flag equal to 0 indicates that matrix parameters are not present.

matrix_element_precision_factor_minus1 plus 1 indicates the length, in bits, of matrix_element_dec[i][j][k][l].

num_matrix_types_minus1 plus 1 indicates the number of matrix types signaled in the SEI message. The value of matrix_type_num_minus1 is in the range of 0 to 26-1, inclusive.

matrix_type_idx indicates the index of matrix type as specified in Table 11.

TABLE 11
Specification of matrix_type_idx

| Value | Specification |
|---|---|
| 0 | Affine translation matrix with the size of 2*2 or 3*3. |
| 1 | Covariance matrix with size of 2*2 or 3*3. |
| 2 | Mouth matrix representing mouth motion. |
| 3 | Eye matrix representing the open-close status and level of the eyes. |
| 4 | Head rotation paramters with the size of 2*2 or 3*3 representing the head |
| | rotation in 2D space or 3D space. |
| 5 | Head translation matrix with the size of 1*2 or 1*3 representing head |
| | translation in 2D space or 3D sapce. |
| 6 | Head location matrix with size of 1*2 or 1*3 to locate the face in 2D space |
| | or 3D space. |
| 7 | Compact feature matrix with the size being specified by |
| | matrix_width_minus1[i] and matrix_height_minus1[i]. |
| 8 . . . 31 | Other undefined matrix with the size being specified by |
| | matrix_width_minus1[i] and matrix_height_minus1[i]. |
| 32 . . . 63 | Reserverd |

It is noted that the undefined matrxi type is used to represent the matrxi type rather than affine translation matrix, covariance matrix, rotation matrix, translation matrix and compact feature matrix. It may be used by the user to extend the matrix type.

num_matrix_equal_to_num_coordinates_flag[i] equal to 1 indicates the number of matrices of the i-th matrix type is equal to num_coordinates_minus1+1. num_matrix_equal_to_num_coordinates_flag[i] equal to 0 indicates the number of matrices of i-th matrix is not equal to num_coordinates_minus1+1.

num_matrices_info[i] provides the information to the number of the matrices of the i-th matrix type.

matrix_width_minus1[i] plus 1 indicates the width of the matrix of i-th matrix type.

When matrix_width_minus1[i] is not present, it is inferred as follows. If matrix_type_idx[i] is equal to 0, 1 or 4, and coordinate_z_present_flag is 1, matrix_width_minus1[i] is inferred to be equal to 2. Otherwise, if matrix_type_idx[i] is equal to 0, 1 or 4, and coordinate_z_present_flag is 0, matrix_width_minus1[i] is inferred to be equal to 1. Otherwise (matrix_type_idx[i] is equal to 5 or 6), matrix_width_minus1[i] is inferred to be equal to 0.

matrix_height_minus1[i] plus 1 indicates the height of the matrix of the i-th matrix type.

When matrix_height_minus1[i] is not present, it is inferred as follows. If matrix_type_idx is equal to 0, 1, 4, 5 or 6, and coordinate_z_present_flag is 1, matrix_height_minus1[i] is inferred to be equal to 2. Otherwise (matrix_type_idx is equal to 0, 1, 4, 5 or 6, and coordinate_z_present_flag is 0), matrix_height_minus1[i] is inferred to be equal to 1.

num_matrices_minus1[i] plus 1 indicates the number of matrices of the i-th matrix type.

The variable numMatrice[i] indicating the number of the matrices of the i-th matrix type is derived as follows:

```
if ( matrix_type_idx[ i ] == 0 ∥ matrix_type_idx[ i ] == 1 ) {
  if ( coordinate_present_flag )
      numMatrice[ i ] = num_matrices_equal_to_num_coordinates_flag[ i ] ?
num_coordinates_minus1 + 1 : ( num_matrices_idc[ i ] < num_coordinates_minus1 ?
num_matrices_idc[ i ] + 1 : num_matrices_idc[ i ] + 2 )
  else
    numMatrice[ i ] = num_matrices_idc[ i ] + 1
}
else if ( matrix_type_idx[ i ] >= 2 && matrix_type_idx[ i ] < 7)
  numMatrice[ i ] = 1
else
  numMatrice[i] = num_matrices_minus1[i] + 1
```

matrix_element_int[i][j][k][l] indicates the integer part of the value of the matrix element at position (k, l) of the j-th matrix of the i-th matrix type.

matrix_element_dec[i][j][k][l] indicates the decimal part of the value of the matrix element at position (k, l) of the j-th matrix of the i-th matrix type.

matrix_element_sign_flag[i][j][k][l] indicates the sign of the matrix element at position (k, l) of the j-th matrix of the i-th matrix type. When matrix_element_sign_flag[i][j][k][l] is not present, it is inferred to be equal to 0.

The variable MatrixElementVal[i][j][k][l] representing the value of the matrix element at position (k, l) of the j-th matrix of the i-th matrix type is derived as follows:

$$matrixElementVal [ i ] [ j ] [ k ] [ l ] = ( 1 - 2 * matrix\_element \_sign \_flag [ i ] [ j ] [ k ] [ l ] ) * ( matrix\_element \_int [ i ] [ j ] [ k ] [ l ] + \frac{matrix\_element \_dec [ i ] [ j ] [ k ] [ l ]}{1 << ( matrix\_element \_precision \_factor \_minus1 + 1 )} )$$

The process DeriveInputTensors( ), for deriving the input tensor inputTensorImgY, inputTensorImgCb, inputTesnsorImgCr, inputTensorKeyPoint, inputTensorMatrix is specified as follows:

```
Initialize inputTensorImgY, inputTensorImgCb, inputTesnsorImgCr, inputTensorKeyPoint
and inputTensorMatrix with 0.
for ( x = 0; x< CroppedWidth; x++ ) {
  for ( y = 0; y< CroppedHeight; y++ ) {
      inputTsensorImgY[ x ][ y ] = CroppedYPic[ x ][ y ]
    }
}
for ( x=0; x< CroppedWidth/ SubWidthC; x++ ) {
  for ( y=0; y< CroppedHeight/ SubHeightC; y++ ) {
      inputTsensorImgCb[ x][ y ] = CroppedCbPic[ x][ y ]
      inputTsensorImgCr[ x][ y ] = CroppedCrPic[ x ][ y ]
    }
}
if ( coordinate_present_flag ) {
    for ( i=0; i< =num_coordinates_minus1; i++ ) {
        inputTensorKeyPoint[ i ][ 0 ] = coordiateX[ i ]
        inputTensorKeyPoint[ i ][ 1 ] = coordiateY[ i ]
        if ( coordinate_z_present_flag )
          inputTensorKeyPoint[ i ][ 2 ] = coordiateZ[ i ]
    }
}
if ( matrix_present_flag ) {
    for ( i=0; i<=num_matrix_types_minus1; i++ ) {
        for ( j=0; j< numMatrice[ i ]; j++ ) {
          for( k=0; k<= matrix_height_minus1[ i ]; k++ ) {
            for ( l=0;l<=matrix_width_minus1[ i ]; l++) {
            inputTensorMatrix[ i ][ j ][ k ][ l ] = MatrixElementVal[ i ][ j][ k][ l ]
            }
          }
        }
    }
}
```

When gfv_nn_type_idc is equal to 1, the process TranslateTensors ( ) is used to derive input sensor TransTensorFlow for Decoder( ) from the output of Translator( ); when gfv_nn_type_idc is equal to 2, the process TranslateTensors( ) is to derive input sensor TransTensorKeyPoint and TransTensorMatrix for Decoder( ) from the output of Translator( ). The process can be specified as follows:

```
  if ( gfv_{—}nn_{—}type_{—}idc == 1 ) {
    for(x=0; x< CroppedWidth/ SubWidthC; x++){
      for(y=0; y< CroppedHeight/ SubHeightC; y++){
          TransTensorFlow [ x ][ y ][0] = outputensorFlow[ x ][ y ] [0]
          TransTensorFlow [ x ][ y ][1] = outputensorFlow[ x ][ y ] [1]
    }
  }
  if ( gfv_{—}nn_{—}type_{—}idc == 2 ) {
    if ( coordinate_{—}present_{—}flag ) {
        for ( i=0; i< =num_{—}coordinates_{—}minus1; i++ ) {
            TransTensorKeyPoint [ i ][ 0 ] = outputensorKeyPoint [ i ] [ 0 ]
            TransTensorKeyPoint [ i ][ 1 ] = outputensorKeyPoint [ i ] [ 1 ]
            if ( coordinate_{—}z_{—}present_{—}flag )
                TransTensorKeyPoint [ i ][ 2 ] = outputensorKeyPoint [ i ] [ 2 ]
        }
    }
    if ( matrix_{—}present_{—}flag ) {
        for ( i=0; i<=num_{—}matrix_{—}types_{—}minus1; i++ )
            for ( j=0; j< numMatrice[ i ]; j++ )
              for( k=0; k<= matrix_{—}height_{—}minus1[ i ]; k++ )
                  for ( l=0;l<=matrix_{—}width_{—}minus1[ i ]; l++)
                TransTensorMatrix [ i ][ j ][ k ][ l ] = outputensorMatrix [ i ][ j][ k][ l ]
    }
}
```

The process StoreOutputTensors( ), for deriving sample values in the generated output sample arrays OutputYPic, OutputCbPic, and OutputCrPic from the output tensor outputTensorY, outputTensorCb and outputTensorCr is specified as follows:

```
for(x=0; x< CroppedWidth; x++){
  for(y=0; y< CroppedHeight; y++){
      OutputYPic[ x ][ y ] = outputTensorY[ x ][ y ]
    }
}
for(x=0; x< CroppedWidth/ Sub WidthC; x++){
  for(y=0; y< CroppedHeight/ SubHeightC; y++){
      OutputCbPic[ x ][ y ] = outputTensorCb[ x ][ y ]
      OutputCdPic[ x][ y ] = outputTensorCr[ x ][ y ]
}
```

The following process is used to generate a video picture. Generator( ) is used to output the picture sample values with parameters signaled in the GFV SEI message and the decoded base picture as inputs. Translator( ) is used to convert the facial parameters signaled in the SEI message into a flow-map or convert the facial parameters signaled in the SEI message into a specified type of facial parameters.

```
  if(gfv_nn_mode_idc==0)
  {
      DeriveInputTensors( )
      Generator ( inputTensorImgY, inputTensorImgCb, inputTesnsorImgCr,
  inputTensorKeyPoint, inputTensorMatrix)
      StoreOutputTensors( outputTensor)
    }
    else if (gfv_nn_mode_idc == 1)
    {
      DeriveInputTensors( )
      Translator (inputTensorKeyPoint, inputTensorMatrix)
      TranslateTensors(outputensorFlow)
      outputTensor = Decoder ( inputTensorImgY, inputTensorImgCb,
  inputTesnsorImgCr, TransTensorFlow)
      StoreOutputTensors( )
    }
    else if (gfv_nn_mode_idc == 2)
    {
      DeriveInputTensors( )
      Translator (inputTensorKeyPoint, inputTensorMatrix)
      TranslateTensors(outputensorKeyPoint, outputensorMatrix)
      outputTensor = Decoder ( inputTensorImgY, inputTensorImgCb,
  inputTesnsorImgCr, TransTensorFlow)
      StoreOutputTensors( )
}
```

Although the disclosed face video compression and generation method is described above in connection with the SEI message, it is not limited to the SEI message. Rather, it may be realized in other ways. For example, an extension of the current video coding standard or a new standard may be defined to support the proposed generative video compression. The videos may be encoded with the proposed method in a base layer or a high layer. And all the syntax elements, semantic and decoding methods described above are applicable to the extension or new standard.

In some embodiments, the first sub-network is a parameter translator network that translates the facial representation parameters signaled in the SEI message into a fixed format of parameters. and the second sub-network is a generative network that generates the picture based on the fixed format of parameters.

The first sub-network (i.e., the parameter translator network), which is denoted as TranslatorNN( ), may be signaled in the SEI message or indicated by the URI contained in SEI message. A flag is signaled to indicate whether the translator network is signaled or indicated by the SEI message. Additionally, the information on the fixed parameter format (e.g., the number of the keypoints, the number of the matrices and the size of each matrice) output by the parameter translator can also signaled in the SEI message or output by the translator itself.

Moreover, for the signalling of the coordinates of the key-points and the elements of the matrices, the predictive signalling way is supported. That is, the differences between the coordinates of the key-point or the elements of matrices of the current frame and those of the base picture are signaled. Also, a flag is signaled to indicate whether the difference values or the absolute values are signaled.

The syntax of these embodiments is shown in the following Table 12 and the semantics are given below Table 12. In the following description, the syntax and semantics changed from the current technique are italicized.

TABLE 12
An example of syntax of the proposed face video generative compression SEI message

| | Descriptor |
|---|---|
| generative_face_video ( payloadSize ) { | |
| gfv_id | ue(v) |
| gfv_base_pic_flag /*indicate if current decoded output picture is a base | u(1) |
| picture*/ | |
| if( gfv_base_pic_flag ) { /*specify TranslatorNN( )*/ | |
| gfv_nn_present_flag | u(1) |
| if( gfv_nn_present_flag ) { | |
| gfv_nn_base_flag | u(1) |
| gfv_nn_mode_idc | ue(v) |
| if( gfv_nn_mode_idc = = 1 ) { | |
| while( !byte_aligned( ) ) | |
| gfv_nn_reserved_zero_bit_a | u(1) |
| gfv_nn_tag_uri | st(v) |
| gfv_nn_uri | st(v) |
| } | |
| } | |
| } else /* current decoded output picture is a driving picture*/ | |
| gfv_drive_pic_fusion_flag /*indicate if DrivePicture is input to | ue(v) |
| GenerativeNN( )*/ | |
| gfv_coordinate_present_flag | u(1) |
| if( gfv_coordinate_present_flag ) { | |
| gfv_coordinate_precision_factor_minus1 | ue(v) |
| gfv_num_kp_minus1 | ue(v) |
| gfv_kp_pred_flag | u(1) |
| gfv_coordinate_z_present_flag | u(1) |
| if(gfv_coordinate_z_present_flag ) | |
| gfv_coordinate_z_max_value_minus1 | ue(v) |
| for( i = 0; i <= num_kp_minus1; i++ ) { | |
| if(!gfv_kp_pred_flag) { | |
| gfv_coordinate_x_abs[ i ] | u(v) |
| if( gfv_coordinate_x_abs[ i ] ) | |
| gfv_coordinate_x_sign_flag[ i ] | u(1) |
| gfv_coordinate_y_abs[ i ] | u(v) |
| if( gfv_coordinate_y_abs[ i ] ) | |
| gfv_coordinate_y_sign_flag[ i ] | u(1) |
| if( gfv_coordinate_z_present_flag ) { | |
| gfv_coordinate_z_abs[ i ] | u(v) |
| if( gfv_coordinate_z_abs[ i ] ) | |
| gfv_coordinate_z_sign_flag[ i ] | u(1) |
| } | |
| } else { | |
| gfv_coordinate_dx_abs[ i ] | u(v) |
| if(gfv_coordinate_dx_abs[ i ] ) | |
| gfv_coordinate_dx_sign_flag[ i ] | u(1) |
| gfv_coordinate_dy_abs[ i ] | u(v) |
| if( gfv_coordinate_dy_abs[ i ] ) | |
| gfv_coordinate_dy_sign_flag[ i ] | u(1) |
| if( gfv_coordinate_z_present_flag ) { | |
| gfv_coordinate_dz_abs[ i ] | u(v) |
| if( gfv_coordinate_dz_abs[ i ] ) | |
| gfv_coordinate_dz_sign_flag[ i ] | u(1) |
| } | |
| } | |
| } | |
| } | |
| gfv_matrix_present_flag | u(1) |
| if(gfv_matrix_present_flag ) { | |
| gfv_matrix_element_precision_factor_minus1 | ue(v) |
| gfv_num_matrix_types_minus1 | ue(v) |
| if( !gfv_base_pic_flag ) | |
| gfv_matrix_pred_flag | u(1) |
| for( i = 0; i <= num_matrix_types_minus1; i++ ) { | |
| gfv_matrix_type_idx[ i ] | u(6) |
| if( gfv_matrix_type_idx[ i] = = 0 \| \| gfv_matrix_type_idx[ i ] = = 1) { | |
| if( gfv_coordinate_present_flag ) | |
| gfv_num_matrices_equal_to_num_kps_flag[ i ] | u(1) |
| if( !gfv_coordinate_present_flag \| \| !gfv_num_matrix_equal_to_num_kps_flag[ i ] ) | |
| gfv_num_matrices_info[ i ] | ue(v) |
| }else | |
| if( gfv_matrix_type_idx[ i] = = 2 \| \| gfv_matrix_type_idx[ i] = = 3 \| \| | |
| gfv_matrix_type_idx[ i ] >= 7 ){ | |
| if( gfv_matrix_type_idx[ i] >= 7) | |
| gfv_num_matrices_minus1[ i ] | ue(v) |
| gfv_matrix_width_minus1[ i ] | ue(v) |
| gfv_matrix_height_minus1[ i ] | ue(v) |
| }else | |
| if( gfv_matrix_type_idx[ i ] >= 4 && gfv_matrix_type_idx[ i] <= 6 && | |
| !gfv_coordinate_present_flag ){ | |
| gfv_matrix_for_3D_space_flag[ i ] | u(1) |
| for( j = 0; j < numMatrices[ i ]; j++ ) | |
| for( k = 0; k < matrixHeight[ i ]; k++ ) | |
| for( m = 0; m <matrix Width[ i ]; m++ ) { | |
| if( !gfv_matrix_pred_flag ) { | |
| gfv_matrix_element_int[ i ][ j ][ k ][ m ] | ue(v) |
| gfv_matrix_element_dec[ i ][ j ][ k ][ m ] | u (v) |
| if( gfv_matrix_element_int[ i][ j ][ k ][ m ] \| \| gfv_matrix_element_dec[ i ][ j ] | |
| [ k ][ m ] ) | |
| gfv_matrix_element_sign_flag[ i ][ j ][ k ][ m ] | u(1) |
| } | |
| else { | |
| gfv_matrix_delta_element_int[ i ][ j ][ k ][ m ] | |
| gfv_matrix_delta_element_dec[ i ][ j ][ k ][ m ] | |
| if( gfv_matrix_element_int[ i][ j ][ k ][ m ] \| \| gfv_matrix_element_dec[ i ][ j ] | |
| [ k ][ m ]) | |
| gfv_matrix_delta_element_sign_flag[ i ][ j ][ k ][ m ] | |
| } | |
| } | |
| } | |
| } | |
| } | |
| if( gfv_nn_present_flag ) { | |
| gfv_nn_output_info_present_flag | |
| if( gfv_nn_output_info_present_flag { | |
| gfv_nn_output_num_kps | ue(v) |
| gfv_nn_output_num_matrices | ue(v) |
| for( i=0; i< gfv_nn_output_matrix_num; i++) { | |
| gfv_nn_output_matrix_width_minus1 [ i ] | ue(v) |
| gfv_nn_output_matrix_height_minus1 [ i ] | ue(v) |
| } | |
| } | |
| } | |
| if( gfv_nn_present_flag ) | |
| if( gfv_nn_mode_idc = = 0 ) { | |
| while( !byte_aligned( ) ) | |
| gfv_nn_reserved_zero_bit_b | u(1) |
| for( i = 0; more_data_in_payload( ); i++ ) | |
| gfv_nn_payload_byte[ i ] | b(8) |
| } | |
| } | |

The generative face video (GFV) SEI message indicates facial parameters and specifies a facial parameter translator network, denoted as TranslatorNN(, that may be used to convert various formats of facial parameters signaled in the SEI message into a fixed format of parameters, and a face picture generator neural network, denoted as GenerativeNN( ), that may be used to generate output pictures using the fixed format of facial parameters and previously decoded output pictures.

It is noted that facial parameters could be determined from source pictures prior to encoding. Such source pictures may be referred to as driving pictures.

Moreover, previously, decoded output pictures input to GenerativeNN( ) may be a base picture (a decoded output picture that provides the reference texture from which the face pictures may be generated) and, optionally, a picture that can be fused by GenerativeNN( ) to improve background texture and facial details. When the current picture is not a base picture, the GFV SEI message may be used to generate a face picture based on the previously decoded base picture, the facial parameters conveyed by the GFV SEI message, and, optionally, the current decoded picture for fusion purpose.

Use of this SEI message requires the definition of the following variables:
Input picture width and height in units of luma samples, denoted herein by CroppedWidth and CroppedHeight, respectively.
Luma sample array baseCroppedYPic and chroma sample arrays baseCroppedCbPic and baseCroppedCrPic for a decoded output picture, denoted as BasePicture, corresponding to a source base picture.
Luma sample array driveCroppedYPic and chroma sample arrays driveCroppedCbPic and driveCroppedCrPic for a decoded output picture, denoted as DrivePicture, corresponding to a source driving picture.
Bit depth BitDepth_{Y} for the luma sample array of the input pictures.
Bit depth BitDepth_{C} for the chroma sample arrays, if any, of the input pictures.
A chroma format indicator, denoted herein by ChromaFormatIdc, as described in subclause 7.3.
   The variables SubWidthC and SubHeightC are derived from ChromaFormatIdc.

gfv_id contains an identifying number that may be used to identify face feature information and specify a neural network that may be used as GenerativeNN( ). The value of gfv_id shall be in the range of 0 to 2³²-−2, inclusive. Values of gfv_id from 256 to 511, inclusive, and from 2³¹ to 2³²-−2, inclusive, are reserved for future use by ITU-T|ISO/IEC. Decoders conforming to this edition of this document encountering a GFV SEI message with gfv_id in the range of 256 to 511, inclusive, or in the range of 2³¹ to 2³²-−2, inclusive, shall ignore the SEI message.

It is noted that different values of gfv_id in different GFV SEI messages could be used to identify different faces when more than one face is present in an output picture, for example.

gfv_base_pic_flag equal to 1 indicates the current decoded output picture corresponds to a base picture. gfv_base_pic_flag equal to 0 indicates the current decoded output picture does not correspond to a base picture.

The following constraints apply to the value of gfv_base_pic_flag. When a GFV SEI message is the first GFV SEI message, in decoding order, that has a particular gfv_id value within the current CLVS, the value of gfv_base_pic_flag shall be equal to 1. When a GFV SEI message that has a particular gfv_id value has gfv_base_pic_flag being equal to 0, this SEI message pertains to the current decoded picture and all subsequent decoded pictures of the current layer, in output order, until the end of the current CLVS or up to but excluding the decoded picture that follows the current decoded picture in output order within the current CLVS and is associated with a subsequent GFV SEI message, in decoding order, having gfv_base_pic_flag equal to 0 and that particular gfv_id value within the current CLVS, whichever is earlier.

gfv_nn_present_flag equal to 1 indicates a neural network that may be used as a TranslatorNN( ) is contained or indicated by the SEI message. gfv_nn_present_flag equal to 0 indicates a neural network that may be used as a TranslatorNN( ) is not contained or indicated by the SEI message.

gfv_nn_base_flag, gfv_nn_mode_idc, gfv_nn_reserved_zero_bit_a, gfv_nn_tag_uri, gfv_nn_uri, gfv_nn_payload_byte[i] specify a neural network that may be used as a TranslatorNN( ). gfv_nn_base_flag, gfv_nn_mode_idc, gfv_nn_reserved_zero_bit_a, gfv_nn_tag_uri, gfv_nn_uri, gfv_nn_payload_byte[i] have the same syntax and semantics as nnpfc_base_flag, nnpfc_mode_idc, nnpfc_reserved_zero_bit_a, nnpfc_tag_uri, nnpfc_uri, nnpfc_payload_byte[i], respectively.

gfv_drive_pic_fusion_flag, when present, equal to 1 indicates the current decoded picture, which corresponds to a driving picture that may be used for fusion, may be input to GenerativeNN( ). gfv_drive_pic_fusion_flag equal to 0 indicates the current decoded picture should not be input to GenerativeNN( ).

It is noted that a gfv_drive_pic_fusion_flag value of 1 can be used, for example, to indicate that the current decoded picture can be used to improve face details or handle background changes.

It is noted that fusion takes the three inputs: the base picture, features from keypoints and/or matrices carried in the GFV SEI message, and the current decoded picture, and outputs a picture.

It is noted that when current decoded picture corresponds to a driving picture, it should be marked as not for output purpose.

gfv_coordinate_present_flag equal to 1 indicates that coordinate information of keypoints is present. gfv_coordinate_present_flag equal to 0 indicates that coordinate information of keypoints is not present.

It is a requirement of bitstream conformance that when gfv_matrix_type_idx[i] for any i from 0 to gfv_num_matrix_types_minus1 is equal to 0 or 1, the value of gfv_coordinate_present_flag shall be equal to 1.

gfv_coordinate_precision_factor_minus1 plus 1 indicates the length, in bits, of gfv_coordinate_x_abs[i], gfv_coordinate_y_abs[i] and gfv_coordinate_z_abs[i].

gfv_num_kps_minus1 plus 1 indicates the number of keypoints. The value of gfv_num_kp_minus1 shall be in the range of 0 to 2¹⁰−1, inclusive.

gfv_kp_pred_flag equal to 1 indicates syntax elements gfv_coordinate_dx_abs[i], gfv_coordinate_dy_abs[i], and gfv_coordinate_dz_abs[i] are present and syntax elements gfv_coordinate_dx_sign_flag[i], gfv_coordinate_dy_sign_flag[i] and gfv_coordinate_dz_sign_flag[i] may be present. gfv_kp_pred_flag equal to 0 indicates gfv_coordinate_x_abs[i],gfv_coordinate_y_abs[i], and gfv_coordinate_z_abs[i] are present and syntax elements gfv_coordinate_x_sign_flag[i], gfv_coordinate_y_sign_flag[i] and gfv_coordinate_z_sign_flag[i] may be present.

gfv_coordinate_z_present_flag equal to 1 indicates that z-axis coordinate information of the keypoints is present. coordinate_z_present_flag equal to 0 indicates that the z-axis coordinate information of the keypoints is not present.

gfv_coordinate_z_max_value_minus1 plus 1 indicates the maximum absolute value of z-axis coordinates of keypoints.

gfv_coordinate_x_abs[i] indicates the normalized absolute value of the x-axis coordinate of the i-th keypoint.

gfv_coordinate_x_sign_flag[i] specifies the sign of the x-axis coordinate of the i-th keypoint. When gfv_coordinate_x_sign_flag[i] is not present, it is inferred to be equal to 0.

gfv_coordinate_y_abs[i] specifies the normalized absolute value of y-axis coordinate of i-th keypoint.

gfv_coordinate_y_sign_flag[i] specifies the sign of the y-axis coordinate of the i-th keypoint. When gfv_coordinate_y_sign_flag[i] is not present, it is inferred to be equal to 0.

gfv_coordinate_z_abs[i] specifies the normalized absolute value of z-axis coordinate of the i-th keypoint.

gfv_coordinate_z_sign_flag[i] specifies the sign of the z-axis coordinate of the i-th keypoint. When gfv_coordinate_z_sign_flag[i] is not present, it is inferred to be equal to 0.

gfv_coordinate_dx_abs[i] indicates the absolute difference value of the normalized value of the x-axis coordinate of the i-th keypoint.

gfv_coordinate_dx_sign_flag[i] specifies the sign of the difference value of the x-axis coordinate of the i-th keypoint. When gfv_coordinate_dx_sign_flag[i] is not present, it is inferred to be equal to 0.

gfv_coordinate_dy_abs[i] specifies the absolute difference value of the normalized y-axis coordinate of the i-th keypoint.

gfv_coordinate_dy_sign_flag[i] specifies the sign of the difference value of the y-axis coordinate of the i-th keypoint. When gfv_coordinate_yd_sign_flag[i] is not present, it is inferred to be equal to 0.

gfv_coordinate_dz_abs[i] specifies the absolute difference value of the normalized z-axis coordinate of the i-th keypoint.

gfv_coordinate_dz_sign_flag[i] specifies the sign of the difference value of the z-axis coordinate of the i-th keypoint. When gfv_coordinate_dz_sign_flag[i] is not present, it is inferred to be equal to 0.

The variables coordinateDeltaX[i], coordinateDeltaY[i] and coordinateDeltaZ[i] indicating the delta x-axis coordinate, delta y-axis coordinate and delta z-axis coordinate of the i-th keypoint, respectively, are derived as follows:

$$coordiateDeltaX [ i ] = \frac{\begin{matrix}( 1 - 2 * gfv\_coordinate \_dx \_sign \_flag [ i ] ) * \\ gfv\_coordinate \_dx \_abs [ i ] * CroppedWidth\end{matrix}}{1 ≪ ( gfv\_coordinate \_precision \_factor \_minus1 + 1 )}$$

$$coordiateDeltaY [ i ] = \frac{\begin{matrix}( 1 - 2 * gfv\_coordinate \_dy \_sign \_flag [ i ] ) * \\ gfv\_coordinate \_dy \_abs [ i ] * CroppedHeight\end{matrix}}{1 ≪ ( gfv\_coordinate \_precision \_factor \_minus1 + 1 )}$$

$$coordiateDeltaZ [ i ] = \frac{\begin{matrix}( 1 - 2 * gfv\_coordinate \_dz \_sign \_flag [ i ] ) * \\ gfv\_coordinate \_dz \_abs [ i ] * \\ ( gfv\_coordinate \_z \_max \_value \_minus1 + 1 )\end{matrix}}{1 ≪ ( gfv\_coordinate \_precision \_factor \_minus1 + 1 )}$$

The variables coordinateX[i], coordinateY[i] and coordinateZ[i] indicating the x-axis coordinate, y-axis coordinate and z-axis coordinate of the i-th keypoint, respectively, are derived as follows:

When gfv_kp_pred_flag is equal to 0,

$$coordiateDeltaX [ i ] = \frac{\begin{matrix}( 1 - 2 * gfv\_coordinate \_x \_sign \_flag [ i ] ) * \\ gfv\_coordinate \_x \_abs [ i ] * CroppedWidth\end{matrix}}{1 ≪ ( gfv\_coordinate \_precision \_factor \_minus1 + 1 )}$$

$$coordiateDeltaY [ i ] = \frac{\begin{matrix}( 1 - 2 * gfv\_coordinate \_y \_sign \_flag [ i ] ) * \\ gfv\_coordinate \_y \_abs [ i ] * CroppedHeight\end{matrix}}{1 ≪ ( gfv\_coordinate \_precision \_factor \_minus1 + 1 )}$$

$$coordiateDeltaZ [ i ] = \frac{\begin{matrix}( 1 - 2 * gfv\_coordinate \_z \_sign \_flag [ i ] ) * \\ gfv\_coordinate \_z \_abs [ i ] * \\ ( gfv\_coordinate \_z \_max \_value \_minus1 + 1 )\end{matrix}}{1 ≪ ( gfv\_coordinate \_precision \_factor \_minus1 + 1 )}$$

when gfv_kp_pred_flag is equal to 1,

```
  if( gfv_base_pic_flag ) {
    coordinateX[ i ] = (( i > 0 ) ? coordinateX[ i − 1 ] : 0 ) + coordinateDeltaX[ i ]
    coordinateY[ i ] = (( i > 0 ) ? coordinateY[ i − 1 ] : 0 ) + coordinateDeltaY[ i ]
    coordinateZ[ i ] = (( i > 0 ) ? coordinateZ[ i − 1 ] : 0 ) + coordinateDeltaZ[ i ]
  }
  else {
    coordinateX[ i ] = BaseKpCoordinateX[ i ] + coordinateDeltaX[ i ]
    coordinateY[ i ] = BaseKpCoordinateY[ i ] + coordinateDeltaY[ i ]
    coordinateZ[ i ] = BaseKpCoordinateZ[ i ] + coordinateDeltaZ[ i ]
  }
  where BaseKpCoordinateX[ i ], BaseKpCoordinateY[ i ], BaseKpCoordinateZ[ i ]
  indicating the x-axis, y-axis and z-axis coordinates, respectively, of the i-th keypoint for the
  base picture are derived as follows:
if( gfv_base_pic_flag ) {
    BaseKpCoordinateX[ i ] = coordinateX[ i ]
    BaseKpCoordinateY[ i ] = coordinateY[ i ]
    BaseKpCoordinateZ[ i ] = coordinateZ[ i ]
}
```

gfv_matrix_present_flag equal to 1 indicates that matrix parameters are present. gfv_matrix_present_flag equal to 0 indicates that matrix parameters are not present.

gfv_matrix_element_precision_factor_minus1 plus 1 indicates the length, in bits, of gfv_matrix_element_dec[i][j][k][m].

gfv_num_matrix_types_minus1 plus 1 indicates the number of matrix types signalled in the SEI message. The value of gfv_matrix_type_num_minus1 shall be in the range of 0 to 2⁶−1, inclusive.

gfv_matrix_pred_flag equal to 1 indicates syntax elements gfv_matrix_element_int [i][j][k][m], gfv_matrix_element_dec [i][j][k][m] gfv_matrix_element_sign_flag [i][j][k][m] may be present. gfv_matrix_pred_flag equal to 0 indicates gfv_matrix_delta_element_int [i][j][k][m], gfv_matrix_delta_element_dec [i][j][k][m] are present and syntax element gfv_matrix_delta_element_sign_flag [i][j][k][m] may be present. When gfv_matrix_pred_flag is not present, the value of gfv_matrix_pred_flag is inferred to be 0.

gfv_matrix_type_idx[i] indicates the index of the i-th matrix type as specified in the following Table 13.

TABLE 13
Specification of gfv_matrix_type_idx

| Value | Specification |
|---|---|
| 0 | Affine translation matrix with the size of 2*2 or 3*3. |
| 1 | Covariance matrix with size of 2*2 or 3*3. |
| 2 | Mouth matrix representing mouth motion. |
| 3 | Eye matrix representing the open-close status and level of eyes. |
| 4 | Head rotation paramters with the size of 2*2 or 3*3 representing the head |
| | rotation in 2D space or 3D space. |
| 5 | Head translation matrix with the size of 1*2 or 1*3 representing head |
| | translationin 2D space or 3D space. |
| 6 | Head location matrix with size of 1*2 or 1*3 representing the head location |
| | in 2D space or 3D space. |
| 7 | Compact feature matrix with the size being specified by |
| | gfv_matrix_width_minus1[i] and gfv_matrix_height_minus1[i]. |
| 8 . . . 31 | Other matrix that may be used as determined by the application with the |
| | size being specified by gfv_matrix_width_minus1[i] and |
| | gfv_matrix_height_minus1[i]. |
| 32 . . . 63 | Reserved |

It is noted that the undefined matrxi type is used to represent the matrxi type rather than affine translation matrix, covariance matrix, rotation matrix, translation matrix and compact feature matrix. It is may be used by the user to extend the matrix type.

gfv_num_matrices_equal_to_num_kps_flag[i] equal to 1 indicates that the number of matrices of the i-th matrix type is equal to gfv_num_kps_minus1+1. gfv_num_matrices_equal_to_num_kps_flag[i] equal to 0 indicates the number of matrices of the i-th matrix type is not equal to gfv_num_coordinates_minus1+1.

gfv_num_matrices_info[i] provides information to derive the number of the matrices of the i-th matrix type.

gfv_matrix_width_minus1[i] plus 1 indicates the width of the matrix of the i-th matrix type.

gfv_matrix_height_minus1[i] plus 1 indicates the height of the matrix of the i-th matrix type.

gfv_matrix_for_3D_space_flag[i] equal to 1 indicates the matrix of the i-th matrix type is a matrix defined in three-dimensional space. gfv_matrix_for_3D_space_flag[i] equal to 0 indicates the matrix of the i-th matrix type is a matrix defined in two-dimensional space.

When gfv_matrix_width_minus1[i] is not present, it is inferred as follows. If gfv_matrix_type_idx[i] is equal to 0, 1 or 4, and one of coordinate_z_present_flag and gfv_matrix_for_3D_space_flag[i] is present and equal to 1, gfv_matrix_width_minus1[i] is inferred to be equal to 2. Otherwise, if matrix_type_idx[i] is equal to 0, 1 or 4, and one of coordinate_z_present_flag and gfv_matrix_for_3D_space_flag[i] is present and equal to 0, gfv_matrix_width_minus1[i] is inferred to be equal to 1. Otherwise (matrix_type_idx[i] is equal to 5 or 6), gfv_matrix_width_minus1[i] is inferred to be equal to 0.

When gfv_matrix_height_minus1[i] is not present, it is inferred as follows. If matrix_type_idx is equal to 0, 1, 4, 5 or 6, and one of gfv_coordinate_z_present_flag and gfv_matrix_for_3D_space_flag[i] is present and equal to 1, gfv_matrix_height_minus1[i] is inferred to be equal to 2. Otherwise (gfv_matrix_type_idx is equal to 0, 1, 4, 5 or 6, and one of gfv_coordinate_z_present_flag and gfv_matrix_for_3D_space_flag[i] is 0), gfv_matrix_height_minus1[i] is inferred to be equal to 1.

The variables matrixWidth[i] and matrixHeight[i] indicating the width and height of the matrix of the i-th matrix type are derived as follows:

$$matrixWidth [ i ] = gfv\_matrix \_width \_minus1 [ i ] + 1$$

$$matrixHeight [ i ] = gfv\_matrix \_height \_minus1 [ i ] + 1$$

gfv_num_matrices_minus1[i] plus 1 indicates the number of matrices of the i-th matrix type.

The variable numMatrices[i] indicating the number of the matrices of the i-th matrix type is derived as follows:

```
if( gfv_matrix_type_idx[ i ] == 0 || gfv_matrix_type_idx[ i ] == 1 ) {
  if( gfv_coordinate_present_flag )
      numMatrices[ i ] = gfv_num_matrices_equal_to_num_kps_flag[ i ] ?
gfv_num_kps_minus1 + 1 : ( gfv_num_matrices_info[ i ] < gfv_num_kp_minus1 ?
gfv_num_matrices_info [ i ] + 1 : gfv_num_matrices_info [ i ] + 2 )
  else
    numMatrices[ i ] = gfv_num_matrices_info[ i ] + 1
}
else if( gfv_matrix_type_idx[ i ] >= 2 && gfv_matrix_type_idx[ i ] < 7)
  numMatrices[ i ] = 1
else
  numMatrices[ i ] = gfv_num_matrices_minus1[ i ] + 1
```

In the disclosed embodiments, position (k, m) represents position at the k-th row and m-th column of the matrix.

gfv_matrix_element_int[i][j][k][m] indicates the integer part of the value of the matrix element at position (k, m) of the j-th matrix of the i-th matrix type.

gfv_matrix_element_dec[i][j][k][m] indicates the decimal part of the value of the matrix element at position (k, m) of the j-th matrix of the i-th matrix type.

gfv_matrix_element_sign_flag[i][j][k][m] indicates the sign of the matrix element at position (k, m) of the j-th matrix of the i-th matrix type. When gfv_matrix_element_sign_flag[i][j][k][m] is not present, it is inferred to be equal to 0.

gfv_matrix_element_int[i][j][k][m] indicates the integer part of the difference value of the matrix element at position (k, m) of the j-th matrix of the i-th matrix type.

gfv_matrix_element_dec[i][j][k][m] indicates the decimal part of the difference value of the matrix element at position (k, m) of the j-th matrix of the i-th matrix type.

gfv_matrix_element_sign_flag[i][j][k][m] indicates the sign of the difference value of the matrix element at position (k, m) of the j-th matrix of the i-th matrix type. When gfv_matrix_element_sign_flag[i][j][k][m] is not present, it is inferred to be equal to 0.

gfv_matrix_pred_flag indicates whether the element values of the matrices are signaled in a predictive way. If the flag is equal to 1, the difference of the element values of the matrices are signaled. The signaled difference value may be the differences between the element values of the matrices of the current picture and the element values of the matrices of the base picture. Alternatively, the signaled different value may be the difference between a value of an element of a matrix of a picture and a value of a previous element of the matrix of the picture. Also, first differences between the element values of the matrices of the current picture and the element values of the matrices of the base picture can be derived first, and then a second difference between the first difference value of a matrix element and the first difference value of a previous matrix element is derived and signaled.

As an example, the variable matrixElementDeltaVal[i][j][k][m] representing the difference value of the matrix element at position (k, m) of the j-th matrix of the i-th matrix type is derived as follows:

$$matrixElementDeltaVal [ i ] [ j ] [ k ] [ m ] = ( 1 - 2 * gfv\_matrix \_delta \_element \_sign \_flag [ i ] [ j ] [ k ] [ m ] ) * ( gfv\_matrix \_delta \_element \_int [ i ] [ j ] [ k ] [ m ] + \frac{gfv\_matrix \_delta \_element \_dec [ i ] [ j ] [ k ] [ m ]}{1 ≪ ( gfv\_matrix \_element \_precision \_factor \_minus1 + 1 )} )$$

The variable matrixElementVal[i][j][k][m] representing the value of the matrix element at position (k, m) of the j-th matrix of the i-th matrix type is derived as follows: when gfv_matrix_pred_flag is equal to 0

$$matrixElementVa l [ i ] [ j ] [ k ] [ m ] = ( 1 - 2 * gfv\_matrix \_element \_sign \_flag [ i ] [ j ] [ k ] [ m ] ) * ( gfv\_matrix \_element \_int [ i ] [ j ] [ k ] [ m ] + \frac{gfv\_matrix \_element \_dec [ i ] [ j ] [ k ] [ m ]}{1 ≪ ( gfv\_matrix \_element \_precision \_factor \_minus1 + 1 )} )$$

when gfv_matrix_pred_flag is equal to 1

matrixElementVal[ i][ j ][ k ][ m ] = BaseMatrixElementVal[ i][ j ][ k ][ m ] +
matrixElementDeltaVal[ i][ j ][ k ][ m ] +
if( gfv_base_pic_flag )
BaseMatrixElementVal[ i][ j ][ k ][ m ] = matrixElementVal[ i][ j ][ k ][ m ]

In another example, the variable matrixElementDeltaVal[i][j][k][m] representing the difference value of the matrix element at position (k, m) of the j-th matrix of the i-th matrix type is derived as follows:

$$matrixElementDeltaVal [ i ] [ j ] [ k ] [ m ] = ( 1 - 2 * gfv\_matrix \_delta \_element \_sign \_flag [ i ] [ j ] [ k ] [ m ] ) * ( gfv\_matrix \_delta \_element \_int [ i ] [ j ] [ k ] [ m ] + \frac{gfv\_matrix \_delta \_element \_de c [ i ] [ j ] [ k ] [ m ]}{1 ≪ ( gfv\_matrix \_element \_precision \_factor \_minus1 + 1 )} )$$

The variable matrixElementVal[i][j][k][m] representing the value of the matrix element at position (k, m) of the j-th matrix of the i-th matrix type is derived as follows: when gfv_matrix_pred_flag is equal to 0

$$matrixElementVal [ i ] [ j ] [ k ] [ m ] = ( 1 - 2 * gfv\_matrix \_element \_sign \_flag [ i ] [ j ] [ k ] [ m ] ) * ( gfv\_matrix \_element \_int [ i ] [ j ] [ k ] [ m ] + \frac{gfv\_matrix \_element \_dec [ i ] [ j ] [ k ] [ m ]}{1 ≪ ( gfv\_matrix \_element \_precision \_factor \_minus1 + 1 )} )$$

when gfv_matrix_pred_flag is equal to 1

```
matrixElementVal[ i][ j ][ k ][ m ] = BaseMatrixElementVal[ i][ j ][ k ][ m ] +
matrixElementDeltaVal[ i][ j ][ k ][ m ] +
if( gfv_base_pic_flag ) {
  for( k = 0; k < matrixHeight[ i ]; k++) {
    for( m = 0; m <matrixWidth[ i ]; m++ ) {
      tempVal[ i][ j ][ k ][ m ] = ((k==0) ? matrixElementVal[ i][ j ][ k ][ m ] :
(tempVal[ i][ j ][ k−1 ][ m ] + matrixElementVal[ i][ j ][ k ][ m ]))
    }
  }
  for( k = 0; k < matrixHeight[ i ]; k++) {
    for( m = 0; m <matrixWidth[ i ]; m++ ) {
      BaseMatrixElementVal[ i][ j ][ k ][ m ] = ((m==0) ?
tempVal[ i][ j ][ k ][ m ] : (BaseMatrixElementVal [ i][ j ][ k−1 ][ m ] +
tempVal[ i][ j ][ k ][ m ]))
    }
  }
}
```

gfv_nn_output_info_present_flag equal to 1 indicates the syntax elements gfv_nn_output_num_kps, gfv_nn_output_num_matrices, gfv_nn_output_matrix_width_minus1[i] and gfv_nn_output_matrix_height_minus1[i] may be present. gfv_nn_output_info_present_flag equal to 0 indicates the syntax elements gfv_nn_output_num_kps, gfv_nn_output_num_matrices, gfv_nn_output_matrix_width_minus1[i] and gfv_nn_output_matrix_height_minus1[i] are not present.

gfv_nn_output_num_kps indicates the number of keypoints output by TranslatorNN( ). The value of gfv_nn_output_num_kps shall be in the range of 0 to 2¹⁰, inclusive.

gfv_nn_output_num_matrices indicates the number of matrices output by TranslatorNN( ). The value of gfv_nn_output_num_matrices shall be in the range of 0 to 2¹⁰, inclusive.

gfv_nn_output_matrix_width_minus1[i] plus 1 indicates the width of the i-th matrix output by TranslatorNN( ). The value of gfv_nn_output_matrix_width_minus1[i] shall be in the range of 0 to 2¹⁰−1, inclusive.

gfv_nn_output_matrix_height_minus1[i] plus 1 indicates the height of the i-th matrix output by TranslatorNN( ). The value of gfv_nn_output_matrix_height_minus1[i] shall be in the range of 0 to 2¹⁰−1, inclusive.

The following process is used to generate a video picture:

```
DeriveSigParam( )
TranslatorNN (sigKeyPoint, sigMatrix)
DeriveInputTensors( )
if( gfv_base_pic_flag == 0 && gfv_drive_pic_fusion_flag == 0) {
  if(ChromaFormatIdc == 0 )
    GenerativeNN( inputBaseY, inputBaseKeyPoint, inputBaseMatrix, inputDriveKeyPoint,
inputDriveMatrix)
  else
    GenerativeNN( inputBaseY, inputBaseCb, inputBaseCr, inputBaseKeyPoint,
inputBaseMatrix, inputDriveKeyPoint, inputDriveMatrix)
}
else if(gfv_base_pic_flag == 0 && gfv_drive_pic_fusion_flag == 1) {
  if(ChromaFormatIdc == 0 )
    GenerativeNN( inputBaseY, inputDriveY, inputBaseKeyPoint, inputBaseMatrix,
inputDriveKeyPoint, inputDriveMatrix)
  else
    GenerativeNN( inputBaseY, inputBaseCb, inputBaseCr, inputDriveY, inputDriveCb,
inputDriveCr , inputBaseKeyPoint, inputBaseMatrix,, inputDriveKeyPoint,
inputDriveMatrix)
}
StoreOutputTensors( )
```

The process DeriveSigParam ( ) for deriving the inputs of TranslatorNN ( ) is specified as follows:

The keypoint coordinate array sigKeyPoint and the matrix sigMatrix are derived as follows:

```
if( gfv_coordinate_present_flag ) {
  for ( i=0; i< = gfv_num_kps_minus1; i++ ) {
    sigKeyPoint[ i ][ 0 ] = coordinateX[ i ]
    sigKeyPoint[ i ][ 1 ] = coordinateY[ i ]
    if ( gfv_coordinate_z_present_flag )
      sigKeyPoint[ i ][ 2 ] = coordinateZ[ i ]
  }
}
else {
  for ( i=0; i< = num_kps_minus1; i++ ) {
    sigKeyPoint [ i ][ 0 ] = 0
    sigKeyPoint [ i ][ 1 ] = 0
    if ( gfv_coordinate_z_present_flag )
      sigKeyPoint [ i ][ 2 ] = 0
  }
}
if( gfv_matrix_present_flag ) {
  for ( i=0; i<= gfv_num_matrix_types_minus1; i++ ) {
    for ( j=0; j< numMatrices[ i ]; j++ ) {
      for( k=0; k< matrixHeight [ i ]; k++ ) {
        for ( l=0;l< matrixWidth [ i ]; l++) {
          sigMatrix[ i ][ j ][ k ][ l ] = matrixElementVal[ i ][ j][ k][ l ]
        }
      }
    }
  }
}
else {
  for ( i=0; i<=gfv_num_matrix_types_minus1; i++ ) {
    for ( j=0; j< numMatrices[ i ]; j++ ) {
      for( k=0; k< matrixHeight [ i ]; k++ ) {
        for ( l=0;l< matrixWidth [ i ]; l++) {
          sigMatrix [ i ][ j ][ k ][ l ] = 0
        }
      }
    }
  }
}
```

As an example, TranslatorNN( ) is a process to translate the various formats of the facial parameters carried in the SEI message to the fixed format of the facial parameters to be input to the generative network to generate the output picture.

The input to TranslatorNN( ) includes sigKeyPoint and sigMatrix. And the output of TranslatorNN( ) includes convKeyPoint and convMatrix.

The process DeriveInputTensors( ) for deriving the inputs of GenerativeNN ( ) is specified as follows:

```
When gfv_base_pic_flag is equal to 1, the BasePicture input tensor inputBaseY, inputBaseCb
and inputBaseCr are derived as follows:
  for( x = 0; x< CroppedWidth; x++ ) {
    for ( y = 0; y< CroppedHeight; y++ ) {
      inputBaseY[ x ][ y ] = InpY( baseCroppedYPic[ x ][ y ] )
    }
  }
  if (ChromaFormatIdc !=0) {
    for( x=0; x< CroppedWidth/ SubWidthC; x++ ) {
      for ( y=0; y< CroppedHeight/ SubHeightC; y++ ) {
        inputBaseCb[ x][ y ] = InpC( baseCroppedCbPic[ x][ y ] )
        inputBaseCr[ x][ y ] = InpC( baseCroppedCrPic[ x ][ y ] )
      }
    }
  }
When gfv_drive_pic_fusion_flag is equal to 1, the DrivePicture luma sample array
inputDriveY, inputDriveCb and input DriveCr are derived as follows:
  for( x = 0; x< CroppedWidth; x++ ) {
    for ( y = 0; y< CroppedHeight; y++ ) {
      inputDriveY[ x ][ y ] = InpY( driveCroppedYPic[ x ][ y ] )
    }
  }
  if (ChromaFormatIdc !=0) {
    for( x=0; x< CroppedWidth/ SubWidthC; x++ ) {
      for ( y=0; y< CroppedHeight/ SubHeightC; y++ ) {
        InputDriveCb[ x][ y ] = InpC( driveCroppedCbPic[ x][ y ] )
        InputDriveCr[ x][ y ] = InpC( driveCroppedCrPic[ x ][ y ] )
      }
    }
  }
  When gfv_base_pic_flag is equal to 0, the keypoint coordinate array inputDriveKeyPoint and
  the matrix inputDriveMatrix for the current picture are derived as follows:
  for ( i = 0; i< = gfv_nn_output_num_kps; i++ ) {
      inputDriveKeyPoint[ i ][ 0 ] = convKeyPoint[ i ][ 0 ]
      inputDriveKeyPoint [ i ][ 1 ] = convKeyPoint[ i ][ 0 ]
      inputDriveKeyPoint [ i ][ 2 ] = convKeyPoint[ i ][ 0 ]
    }
  for( i=0; i<gfv_nn_output_num_matrices; i++)
    for( k = 0; k < gfv_nn_output_matrix_height_minus1[ i ]; k++ ) {
      for ( l = 0;l < gfv_nn_output_matrix_width_minus1[ i ]; l++)
        inputDriveMatrix[ i ][ k ][ l ] = convMatrix [ i ][ k ][ l ]
  }
  When gfv_base_pic_flag is equal to 1, the keypoint coordinate array inputBaseKeyPoint and
  the matrix inputBaseMatrix for the base picture are derived as follows:
  for ( i=0; i< = gfv_nn_output_num_kps; i++ ) {
      inputBaseKeyPoint[ i ][ 0 ] = convKeyPoint[ i ][ 0 ]
      inputBaseKeyPoint [ i ][ 1 ] = convKeyPoint[ i ][ 0 ]
      inputBaseKeyPoint [ i ][ 2 ] = convKeyPoint[ i ][ 0 ]
  }
  for( i=0; i<gfv_nn_output_num_matrices; i++)
    for( k = 0; k < gfv_nn_output_matrix_height_minus1[ i ]; k++ )
      for ( l = 0;l < gfv_nn_output_matrix_width_minus1[ i ]; l++)
        inputBaseMatrix[ i ][ k ][ l ] = convMatrix [ i ][ k ][ l ]
    }
  }
```

The functions InpY( ) and InpC( ) are specified as follows:

$$InpY ( x ) = x \div ( ( 1 ≪ {BitDepth}_{Y} ) - 1 )$$

$$InpC = x \div ( ( 1 ≪ {BitDepth}_{C} ) - 1 )$$

In another example, when the translator outputs the fixed format of facial parameters to be input to the generative network, it also outputs the information of the fixed format of facial parameter which it outputs, such as number of key-points, the number of matrices and the size of each matrix. Thus, this information does not need to be signaled in the SEI message. So, the syntax element gfv_nn_output_num_kps, gfv_nn_output_num_matrices, gfv_nn_output_matrix_width_minus1[i] and gfv_nn_output_matrix_height_minus1[i]can be skipped. In this example:

Inputs to TranslatorNN( ) are:
sigKeyPoint and sigMatrix

Outputs of TranslatorNN( ) are:
convKeyPoint, numConvKeyPoint
convMatrix, numConvMatrix and array convMatrixWidth[i] and convMatrixHeight[i](for i=0 to numConvMatrix−1 if numConvMatrix>0)

The process DeriveInputTensors( ) for deriving the inputs of GenerativeNN ( ) is specified as follows:

When gfv_base_pic_flag is equal to 0, the keypoint coordinate array inputDriveKeyPoint and the matrix inputDriveMatrix for the current picture are derived as follows:

```
for ( i = 0; i< = numConvKeyPoint; i++ ) {
    inputDriveKeyPoint[ i ][ 0 ] = convKeyPoint[ i ][ 0 ]
    inputDriveKeyPoint [ i ][ 1 ] = convKeyPoint[ i ][ 0 ]
    inputDriveKeyPoint [ i ][ 2 ] = convKeyPoint[ i ][ 0 ]
  }
for( i=0; i< numConvMatrix; i++)
  for( k = 0; k < convMatrixHeight[i]; k++ ) {
    for ( l = 0;l < convMatrixWidth[i]; l++)
      inputDriveMatrix[ i ][ k ][ l ] = convMatrix [ i ][ k ][ l ]
}
```

When gfv_base_pic_flag is equal to 1, the keypoint coordinate array inputBaseKeyPoint and the matrix inputBaseMatrix for the base picture are derived as follows:

```
for ( i=0; i< = numConvKeyPoint; i++ ) {
    inputBaseKeyPoint[ i ][ 0 ] = convKeyPoint[ i ][ 0 ]
    inputBaseKeyPoint [ i ][ 1 ] = convKeyPoint[ i ][ 0 ]
    inputBaseKeyPoint [ i ][ 2 ] = convKeyPoint[ i ][ 0 ]
}
for( i=0; i< numConvMatrix; i++)
  for( k = 0; k < convMatrixHeight[i]; k++ )
    for ( l = 0;l < convMatrixWidth[i]; l++)
      inputBaseMatrix[ i ][ k ][ l ] = convMatrix [ i ][ k ][ l ]
  }
}
```

GenerativeNN ( ) is a process to generate the sample values of an output picture corresponding to a driving picture. It is only invoked when gfc_base_pic_flag is equal to 0. Input value to GenerativeNN( ) and output values from GenerativeNN( ) is real numbers.

Inputs to GenerativeNN( ) are:
When gfv_base_pic_flag is equal to 0 and gfv_drive_pic_fusion_flag is equal to 0 and ChromaFormatIdc is equal to 0: inputBaseY, inputBaseKeyPoint, inputBaseMatrix, inputDriveKeyPoint, inputDriveMatrix.
When gfv_base_pic_flag is equal to 0 and gfv_drive_pic_fusion_flag is equal to 0 and ChromaFormatIdc is not equal to 0: inputBaseY, inputBaseCb, inputBaseCr, inputBaseKeyPoint, inputBaseMatrix, inputDriveKeyPoint, inputDriveMatrix.
When gfv_base_pic_flag is equal to 0 and gfv_drive_pic_fusion_flag is equal to 1 and ChromaFormatIdc is equal to 0: inputBaseY, inputDriveY, inputBaseKeyPoint, inputBaseMatrix, inputDriveKeyPoint, inputDriveMatrix.
When gfv_base_pic_flag is equal to 0 and gfv_drive_pic_fusion_flag is equal to 1 and ChromaFormatIdc is not equal to 0: inputBaseY, inputBaseCb, inputBaseCr, inputDriveY, inputDriveCb, inputDriveCr, inputBaseKeyPoint, inputBaseMatrix, inputDriveKeyPoint, inputDriveMatrix.

Outputs of GenerativeNN( ) are:
A luma sample array genY
When ChromaFormatIdc is not equal to 0, two chroma sample arrays genCb and genCr.

The process StoreOutputTensors( ) for deriving the output is specified as follows: when gfv_base_pic_flag is equal to 0, the output sample array outYPic[x][y], outCbPic[x][y], and outCrPic[x][y] are derived as follows:

```
      for(x=0; x< CroppedWidth; x++){
        for(y=0; y< CroppedHeight; y++){
          outputYPic[ x ][ y ] = OutY( genY[ x ][ y ] )
        }
      }
    if(ChromaFormatIdc != 0) {
      for(x=0; x< CroppedWidth/ SubWidthC; x++){
        for(y=0; y< CroppedHeight/ SubHeightC; y++){
          outputCbPic[ x ][ y ] = OutC( genCb[ x ][ y ] )
          outputCrPic[ x][ y ] = OutC( genCr[ x ][ y ] )
        }
      }
    }
    when gfv_base_pic_flag is equal to 1, the output sample array outYPic[ x ][ y ],
    outCbPic[ x ][ y ], and outCrPic[ x ][ y ] are derived as follows:
      for(x=0; x< CroppedWidth; x++){
        for(y=0; y< CroppedHeight; y++){
          outputYPic[ x ][ y ] = baseCroppedYPic [ x ][ y ]
        }
      }
if(ChromaFormatIdc != 0) {
  for(x=0; x< CroppedWidth/ SubWidthC; x++){
    for(y=0; y< CroppedHeight/ SubHeightC; y++){
      outputCbPic[ x ][ y ] = baseCroppedCbPic [ x ][ y ]
      outputCrPic[ x][ y ] = baseCroppedCbPic [ x ][ y ]
    }
  }
}
```

The functions OutY( ) and OutC( ) are specified as follows:

$$OutY ( x ) = Clip 3 ( 0 , ( 1 ≪ {BitDepth}_{Y} ) - 1 , x * ( ( 1 ≪ BitDept {h}_{Y} ) - 1 )$$

$$OutC ( x ) = Clip 3 ( 0 , ( 1 ≪ {BitDepth}_{C} ) - 1 , x * ( ( 1 ≪ BitDept {h}_{C} ) - 1 )$$

In some embodiments, a normalized value of keypoint coordinate is signalled. For signalling, the fixed length code is used for keypoint coordinates and the length of the code is also signalled. However, keypoints are not uniformly distributed in the picture. In some embodiments, more keypoints are in the centre area of the picture than boundary area. Thus, fixed length code is not efficient. Assuming the origin is the centre of the picture, there are more keypoints with coordinates close to 0 than to 1, which means the shorter code can be assigned to the coordinates with smaller absolute values and longer codes can be assigned to the coordinates with larger values. In the case of predictive signalling, the difference of the two coordinates is signalled. For example, a difference between the coordinate of current keypoint and the coordinate of the corresponding keypoint in the base picture or a difference between the coordinate of the current keypoint and the coordinate of the last keypoint is signalled. In this case, the distribution of the signalled values (i.e., difference of coordinate) is even sharper, i.e., more values are around 0. Thus, in some embodiments, exponential-golomb code is used for keypoint signalling. That is, smaller values have shorter codes and bigger values have longer codes.

In some embodiments, the matrix element value is divided into integer part and decimal part and these two parts are separately signalled. For the integer part, exponential-golomb code is used as the matrix value is non-uniformly distributed, the smaller values with higher possibilities. For the decimal part, the fixed length code is used. However, when predictive signalling is used (i.e., signalling the difference of the matrix element value instead of directly signalling matrix element value), the difference signalled is usually quite small, even less than 1. In that case, the decimal part is also not uniformly distributed. In this embodiment, in the case of predictive signalling, exponential-golomb code is used for the decimal part of matrix element signalling, and in the case of non-predictive signalling, fixed length code is used for the decimal part of matrix element signalling. The in these embodiments, the code for decimal part is dependent on whether the difference value is signalled or the absolute value is signalled.

In some embodiments, after the decoder decodes the GFV SEI message, the actual keypoint coordinate is calculated. That is, the range of x-axis is from −PicWidth/2 to PicWidth/2, the range of y-axis is from −PicHeight/2 to PicHeight/2, where PicWidth is the width of the picture and PicHeight is the height of the picture. The origin is in the center of the picture. While in some other embodiments, the output key coordinates are normalized to be from −1 to 1. And in this case, the picture width, picture height, the maximum z-axis value need to be inputted to generative model to generate the face picture.

Table 14 provides an example of syntax according to some embodiments.

TABLE 14
An example of syntax of the proposed face video generative compression SEI message

| | Descriptor |
|---|---|
| generative_face_video ( payloadSize ) { | |
| gfv_id | ue(v) |
| gfv_cnt | ue(v) |
| if( gfv_cnt = = 0 ) | |
| gfv_base_pic_flag /*indicate if current decoded output picture is a base | u(1) |
| picture*/ | |
| if( gfv_base_pic_flag ) { /*specify TranslatorNN( )*/ | |
| gfv_nn_present_flag | u(1) |
| if( gfv_nn_present_flag ) { | |
| gfv_nn_base_flag | u(1) |
| gfv_nn_mode_idc | ue(v) |
| if( gfv_nn_mode_idc = = 1) { | |
| while( !byte_aligned( ) ) | |
| gfv_nn_reserved_zero_bit_a | u(1) |
| gfv_nn_tag_uri | st(v) |
| gfv_nn_uri | st(v) |
| } | |
| } | |
| } else /* current decoded output picture is a driving picture*/ | |
| gfv_drive_pic_fusion_flag /*indicate if DrivePicture is input to | u(1) |
| GenerativeNN( )*/ | |
| gfv_low_confidence_face_parameter_flag | u(1) |
| gfv_coordinate_present_flag | u(1) |
| if( gfv_coordinate_present_flag ) { | |
| gfv_coordinate_precision_factor_minus1 | ue(v) |
| gfv_num_kp_minus1 | ue(v) |
| gfv_kp_pred_flag | u(1) |
| gfv_coordinate_z_present_flag | u(1) |
| if(gfv_coordinate_z_present_flag ) | |
| gfv_coordinate_z_max_value_minus1 | ue(v) |
| for( i = 0; i <= num_kp_minus1; i++ ) { | |
| if(!gfv_kp_pred_flag) { | |
| gfv_coordinate_x_abs[ i ] | ue(v) |
| if( gfv_coordinate_x_abs[ i ] ) | |
| gfv_coordinate_x_sign_flag[ i ] | u(1) |
| gfv_coordinate_y_abs[ i ] | ue(v) |
| if( gfv_coordinate_y_abs[ i ] ) | |
| gfv_coordinate_y_sign_flag[ i ] | u(1) |
| if( gfv_coordinate_z_present_flag ) { | |
| gfv_coordinate_z_abs[ i ] | ue(v) |
| if( gfv_coordinate_z_abs[ i ] ) | |
| gfv_coordinate_z_sign_flag[ i ] | u(1) |
| } | |
| } else { | |
| gfv_coordinate_dx_abs[ i ] | ue(v) |
| if(gfv_coordinate_dx_abs[ i ] ) | |
| gfv_coordinate_dx_sign_flag[ i ] | u(1) |
| gfv_coordinate_dy_abs[ i ] | ue(v) |
| if( gfv_coordinate_dy_abs[ i ] ) | |
| gfv_coordinate_dy_sign_flag[ i ] | u(1) |
| if( gfv_coordinate_z_present_flag ) { | |
| gfv_coordinate_dz_abs[ i ] | ue(v) |
| if( gfv_coordinate_dz_abs[ i ] ) | |
| gfv_coordinate_dz_sign_flag[ i ] | u(1) |
| } | |
| } | |
| } | |
| } | |
| gfv_matrix_present_flag | u(1) |
| if(gfv_matrix_present_flag ) { | |
| gfv_matrix_element_precision_factor_minus1 | ue(v) |
| gfv_num_matrix_types_minus1 | ue(v) |
| if( !gfv_base_pic_flag ) | |
| gfv_matrix_pred_flag | u(1) |
| for( i = 0; i <= num_matrix_types_minus1; i++ ) { | |
| gfv_matrix_type_idx[ i ] | u(6) |
| if( gfv_matrix_type_idx[ i ] == 0 \| \| gfv_matrix_type_idx[ i ] = = 1 ) { | |
| if( gfv_coordinate_present_flag ) | |
| gfv_num_matrices_equal_to_num_kps_flag[ i ] | u(1) |
| if(!gfv_num_matrices_equal_to_num_kps_flag[ i ] ) | |
| gfv_num_matrices_info[ i ] | ue(v) |
| }else | |
| if( gfv_matrix_type_idx[ i] = = 2 \| \| gfv_matrix_type_idx[ i] = = 3 \| \| | |
| gfv_matrix_type_idx[ i ] >= 7 ){ | |
| if( gfv_matrix_type_idx[ i] >=7) | |
| gfv_num_matrices_minus1[ i ] | ue(v) |
| gfv_matrix_width_minus1[ i ] | ue(v) |
| gfv_matrix_height_minus1[ i ] | ue(v) |
| }else | |
| if( gfv_matrix_type_idx[ i] >= 4 && gfv_matrix_type_idx[ i] <= 6 && | |
| !gfv_coordinate_present_flag ) | |
| gfv_matrix_for_3D_space_flag[ i ] | u(1) |
| for( j = 0; j < numMatrices[ i ]; j++ ) | |
| for( k = 0; k < matrixHeight[ i ]; k++ ) | |
| for( m = 0; m <matrix Width[ i ]; m++ ) { | |
| if( !gfv_matrix_pred_flag ) { | |
| gfv_matrix_element_int[ i ][ j ][ k ][ m ] | ue(v) |
| gfv_matrix_element_dec[ i ][ j ][ k ][ m ] | u (n) |
| if( gfv_matrix_element_int[ i][ j ][ k ][ m ] \| \| gfv_matrix_element_dec[ i ][ j ][ | |
| k ][ m ] ) | |
| gfv_matrix_element_sign_flag[ i ][ j ][ k ][ m ] | u(1) |
| } | |
| else { | |
| gfv_matrix_delta_element_int[ i ][ j ][ k ][ m ] | ue(v) |
| gfv_matrix_delta_element_dec[ i ][ j ][ k ][ m ] | ue(v) |
| if( gfv_matrix_delta_element_int[ i][ j ][ k ][ m ] \| \| | |
| gfv_matrix_delta_element_dec[ i ][ j ][ k ][ m ] ) | |
| gfv_matrix_delta_element_sign_flag[ i ][ j ][ k ][ m ] | u(1) |
| } | |
| } | |
| } | |
| } | |
| if( gfv_nn_present_flag ) | |
| if( gfv_nn_mode_idc = = 0 ) { | |
| while( !byte_aligned( ) ) | |
| gfv_nn_reserved_zero_bit_b | u(1) |
| for( i = 0; more_data_in_payload( ); i++ ) | |
| gfv_nn_payload_byte[ i ] | b(8) |
| } | |
| } | |

The generative face video (GFV) SEI message indicates facial parameters and specifies a facial parameter translator network, denoted as TranslatorNN(, that may be used to convert various formats of facial parameters signaled in the SEI message into a fixed format of parameters, and a face picture generator neural network, denoted as GenerativeNN( ), that may be used to generate output pictures using the fixed format of facial parameters and previously decoded output pictures.

Use of this SEI message requires the definition of the following variables:
Input and output picture width and height in units of luma samples, denoted herein by CroppedWidth and CroppedHeight, respectively.
Luma sample array baseCroppedYPic and chroma sample arrays baseCroppedCbPic and baseCroppedCrPic for a decoded output picture, denoted as BasePicture, corresponding to a source base picture.
Luma sample array driveCroppedYPic and chroma sample arrays driveCroppedCbPic and driveCroppedCrPic for a decoded output picture, denoted as DrivePicture, corresponding to a source driving picture.
Bit depth BitDepth_{Y} for the luma sample array of the input and output pictures.
Bit depth BitDepth_{C} for the chroma sample arrays, if any, of the input and output pictures.
A chroma format indicator, denoted herein by ChromaFormatIdc.

The variables SubWidthC and SubHeightC are derived from ChromaFormatIdc.

gfv_coordinate_precision_factor_minus1 plus 1 specifies the precision of keypoint coordinates.

gfv_kp_pred_flag equal to 1 indicates syntax elements gfv_coordinate_dx_abs[i], gfv_coordinate_dy_abs[i], and gfv_coordinate_dz_abs[i] are present and syntax elements gfv_coordinate_dx_sign_flag[i], gfv_coordinate_dy_sign_flag[i] and gfv_coordinate_dz_sign_flag[i] may be present. gfv_kp_pred_flag equal to 0 indicates gfv_coordinate_x_abs[i],gfv_coordinate_y_abs[i], and gfv_coordinate_z_abs[i] are present and syntax elements gfv_coordinate_x_sign_flag[i], gfv_coordinate_y_sign_flag[i] and gfv_coordinate_z_sign_flag[i] may be present.

gfv_coordinate_z_present_flag equal to 1 indicates that z-axis coordinate information of the keypoints is present. coordinate_z_present_flag equal to 0 indicates that the z-axis coordinate information of the keypoints is not present.

gfv_coordinate_z_max_value_minus1 plus 1 indicates the maximum absolute value of z-axis coordinates of keypoints.

When gfv_coordinate_z_max_value_minus1 is present, the variable CroppedDepth is equal to gfv_coordinate_z_max_value_minus1+1; otherwise CroppedDepth is equal to 0.

gfv_coordinate_x_abs[i] is used to derive the x-axis coordinate of the i-th keypoint.

gfv_coordinate_x_sign_flag[i] specifies the sign of the x-axis coordinate of the i-th keypoint. When gfv_coordinate_x_sign_flag[i] is not present, it is inferred to be equal to 0.

gfv_coordinate_y_abs[i] is used to derive y-axis coordinate of i-th keypoint.

gfv_coordinate_y_sign_flag[i] specifies the sign of the y-axis coordinate of the i-th keypoint. When gfv_coordinate_y_sign_flag[i] is not present, it is inferred to be equal to 0.

gfv_coordinate_z_abs[i] is used to derive z-axis coordinate of the i-th keypoint.

gfv_coordinate_z_sign_flag[i] specifies the sign of the z-axis coordinate of the i-th keypoint. When gfv_coordinate_z_sign_flag[i] is not present, it is inferred to be equal to 0.

gfv_coordinate_dx_abs[i] specifies a difference value that is used to derive x-axis coordinate of the i-th keypoint.

gfv_coordinate_dx_sign_flag[i] specifies the sign of the difference value of the x-axis coordinate of the i-th keypoint. When gfv_coordinate_dx_sign_flag[i] is not present, it is inferred to be equal to 0.

gfv_coordinate_dy_abs[i] specifies a difference value that is used to derive y-axis coordinate of the i-th keypoint.

gfv_coordinate_dy_sign_flag[i] specifies the sign of the difference value of the y-axis coordinate of the i-th keypoint. When gfv_coordinate_yd_sign_flag[i] is not present, it is inferred to be equal to 0.

gfv_coordinate_dz_abs[i] specifies a difference value that is used to derive z-axis coordinate of the i-th keypoint.

gfv_coordinate_dz_sign_flag[i] specifies the sign of the difference value of the z-axis coordinate of the i-th keypoint. When gfv_coordinate_dz_sign_flag[i] is not present, it is inferred to be equal to 0.

The variables coordinateDeltaX[i], coordinateDeltaY[i] and coordinateDeltaZ[i] indicating the difference value of normalized coordinate for x-axis, y-axis and z-axis of the i-th keypoint, respectively, are derived as follows:

```
  coordinateDeltaX[ i ] = (1 − 2 * gfv_coordinate_dx_sign_flag[ i ]) *
gfv_coordinate_dx_abs[ i ] ÷ (1 << (gfv_coordinate_precision_factor_minus1 + 1))
  coordinateDeltaY[i] = (1 − 2 * gfv_coordinate_dy_sign_flag[ i ]) *
gfv_coordinate_dy_abs[ i ] ÷ (1 << (gfv_coordinate_precision_factor_minus1 + 1))
  if (gfv_coordinate_z_present_flag )
    coordinateDeltaZ[i] = (1 − 2 * coordinate_dz_sign_flag[ i ]) *
gfv_coordinate_dz_abs[ i ] ÷ (1 << (gfv_coordinate_precision_factor_minus1 + 1))
```

The variables coordinateX[i], coordinateY[i] and when gfv_coordinate_z_present_flag is equal to 1, coordinateZ[i] indicating the normalized coordinate for x-axis, y-axis and z-axis coordinate of the i-th keypoint, respectively, are derived as follows.

When gfv_kp_pred_flag is equal to 0, the variables coordinateX[i], coordinateY[i], and coordinateZ[i] are derived as follows:

```
  coordinateX[ i ] = (1 − 2 * gfv_coordinate_dx_sign_flag[ i ]) *
gfv_coordinate_abs[ i ] ÷ (1 << (gfv_coordinate_precision_factor_minus1 + 1))
  coordinateY[i] = (1 − 2 * gfv_coordinate_dy_sign_flag[ i ]) * gfv_coordinate_abs[ i] ÷
(1 << (gfv_coordinate_precision_factor_minus1 + 1))
  if (gfv_coordinate_z_present_flag )
    coordinateZ[i] = (1 − 2 * coordinate_dz_sign_flag[ i ]) * gfv_coordinate_abs[ i ] ÷
(1 << (gfv_coordinate_precision_factor_minus1 + 1))
```

When gfv_kp_pred_flag is equal to 1, the variables coordinateX[i], coordinateY[i], and coordinateZ[i] are derived as follows:

```
if( gfv_base_pic_flag ) {
  coordinateX[ i ] = (( i > 0 ) ? coordinateX[ i − 1 ] : 0 ) + coordinateDeltaX[ i ]
  coordinateY[ i ] = (( i > 0 ) ? coordinateY[ i − 1 ] : 0 ) + coordinateDeltaY[ i ]
  if (gfv_coordinate_z_present_flag )
    coordinateZ[ i ] = (( i > 0 ) ? coordinateZ[ i − 1 ] : 0 ) + coordinateDeltaZ[ i ]
}
else {
  coordinateX[ i ] = BaseKpCoordinateX[ i ] + coordinateDeltaX[ i ]
  coordinateY[ i ] = BaseKpCoordinateY[ i ] + coordinateDeltaY[ i ]
  if (gfv_coordinate_z_present_flag )
    coordinateZ[ i ] = BaseKpCoordinateZ[ i ] + coordinateDeltaZ[ i ]
}
```

where BaseKpCoordinateX[i], BaseKpCoordinateY[i], BaseKpCoordinateZ[i] indicating the x-axis, y-axis and z-axis coordinates, respectively, of the i-th keypoint for the base picture are derived as follows:

```
if( gfv_base_pic_flag ) {
  BaseKpCoordinateX[ i ] = coordinateX[ i ]
  BaseKpCoordinateY[ i ] = coordinateY[ i ]
  if (gfv_coordinate_z_present_flag )
    BaseKpCoordinateZ[ i ] = coordinateZ[ i ]
}
```

gfv_matrix_present_flag equal to 1 indicates that matrix parameters are present. gfv_matrix_present_flag equal to 0 indicates that matrix parameters are not present.

gfv_matrix_element_precision_factor_minus1 plus 1 indicates the precision of matrix parameters.

gfv_matrix_pred_flag equal to 1 indicates syntax elements gfv_matrix_element_int [i][j][k][m], gfv_matrix_element_dec [i][j][k][m] are present and gfv_matrix_element_sign_flag [i][j][k][m] may be present. gfv_matrix_pred_flag equal to 0 indicates gfv_matrix_delta_element_int [i][j][k][m], gfv_matrix_delta_element_dec [i][j][k][m] are present and syntax element gfv_matrix_delta_element_sign_flag [i][j][k][m] may be present. When gfv_matrix_pred_flag is not present, it is inferred to be 0.

gfv_matrix_element_int[i][j][k][m] indicates the integer part of the value of the matrix element at position (m, k) of the j-th matrix of the i-th matrix type.

gfv_matrix_element_dec[i][j][k][m] indicates the decimal part of the value of the matrix element at position (m, k) of the j-th matrix of the i-th matrix type. The length of gfv_matrix_element_dec[i][j][k][m] is equal to gfv_matrix_element_precisionjfactor_minus1+1.

gfv_matrix_element_sign_flag[i][j][k][m] indicates the sign of the matrix element at position (m, k) of the j-th matrix of the i-th matrix type. When gfv_matrix_element_sign_flag[i][j][k][m] is not present, it is inferred to be equal to 0.

gfv_matrix_delta_element_int[i][j][k][m] indicates the integer part of the difference value of the matrix element at position (m, k) of the j-th matrix of the i-th matrix type.

gfv_matrix_delta_element_dec[i][j][k][m] indicates the decimal part of the difference value of the matrix element at position (m, k) of the j-th matrix of the i-th matrix type.

gfv_matrix_delta_element_sign_flag[i][j][k][m] indicates the sign of the difference value of the matrix element at position (m, k) of the j-th matrix of the i-th matrix type.

When gfv_matrix_element_sign_flag[i][j][k][m] is not present, it is inferred to be equal to 0.

The variable matrixElementDeltaVal[i][j][k][m] representing the difference value of the matrix element at position (m, k) of the j-th matrix of the i-th matrix type is derived as follows:

matrixElementDeltaVal[ i ][ j ][ k ][ m ] = (1 − 2 *
gfv_matrix_delta_element_sign_flag[ i ][ j ][ k ][ m ]) *
(gfv_matrix_delta_element_int[ i ][ j ][ k ][ m ] +
gfv_matrix_delta_element_dec[ i ][ j ][ k ][ m ] ÷ (1 <<
(gfv_matrix_element_precision_factor_minus1 + 1)))

The variable matrixElementVal[i][j][k][m] representing the value of the matrix element at position (m, k) of the j-th matrix of the i-th matrix type is derived as follows. When gfv_matrix_pred_flag is equal to 0, the variable matrixElementVal[i][j][k][m] is derived as:

matrixElementVal[ i][ j ][ k ][ m ] = (1 − 2 *
gfv_matrix_element_sign_flag[ i ][ j ][ k ][ m ]) *
(gfv_matrix_element_int[ i ][j ][ k ][ m ] + gfv_matrix_element_dec[ i ][ j ][ k ][ m ] ÷
(1 << (gfv_matrix_element_precision_factor_minus1 + 1)))
if( gfv_base_pic_flag )
BaseMatrixElementVal[ i][ j ][ k ][ m ] = matrixElementVal[ i][ j ][ k ][ m ]

When gfv_matrix_pred_flag is equal to 1, the variable matrixElementVal[i][j][k][m] is derived as:

matrixElementVal[ i][ j ][ k ][ m ] = BaseMatrixElementVal[ i][ j ][ k ][ m ] +
matrixElementDeltaVal[ i][ j ][ k ][ m ]

For a particular gfv_id value, the following process is used in increasing order of gfv_cnt to generate a video picture per each GFV SEI message that has gfv_base_pic_flag equal to 0 and a unique value of gfv_cnt within a picture unit:

```
DeriveSigParam( )
TranslatorNN (sigKeyPoint , sigMatrix)
DeriveInputTensors( )
if( gfv_base_pic_flag == 0 && gfv_drive_pic_fusion_flag == 0) {
  if(ChromaFormatIdc == 0 )
    GenerativeNN( inputBaseY, inputBaseKeyPoint, inputBaseMatrix, inputDriveKeyPoint,
inputDriveMatrix, CroppedWidth, CroppedHeight, CroppedDepth )
  else
    GenerativeNN( inputBaseY, inputBaseCb, inputBaseCr, inputBaseKeyPoint,
inputBaseMatrix, inputDriveKeyPoint, inputDriveMatrix, CroppedWidth, CroppedHeight,
CroppedDepth)
}
else if(gfv_base_pic_flag == 0 && gfv_drive_pic_fusion_flag == 1) {
  if(ChromaFormatIdc == 0 )
    GenerativeNN( inputBaseY, inputDriveY, inputBaseKeyPoint, inputBaseMatrix,
inputDriveKeyPoint, inputDriveMatrix, CroppedWidth, CroppedHeight, CroppedDepth)
  else
    GenerativeNN( inputBaseY, inputBaseCb, inputBaseCr, inputDriveY, inputDriveCb,
inputDriveCr , inputBaseKeyPoint, inputBaseMatrix,, inputDriveKeyPoint,
inputDriveMatrix, CroppedWidth, CroppedHeight, CroppedDepth)
}
Store OutputTensors( )
```

GenerativeNN ( ) is a process to generate the sample values of an output picture corresponding to a driving picture. It is only invoked when gfc_base_pic_flag is equal to 0. Input values to GenerativeNN( ) and output values from GenerativeNN( ) are real numbers.

Inputs to GenerativeNN( ) are identified as follows. When gfv_base_pic_flag is equal to 0 and gfv_drive_pic_fusion_flag is equal to 0 and ChromaFormatIdc is equal to 0, inputs to GenerativeNN( ) are: inputBaseY, inputBaseKeyPoint, inputBaseMatrix, inputDriveKeyPoint, inputDriveMatrix, CroppedWidth, CroppedHeight, CroppedDepth.

When gfv_base_pic_flag is equal to 0 and gfv_drive_pic_fusion_flag is equal to 0 and ChromaFormatIdc is not equal to 0, inputs to GenerativeNN( ) are: inputBaseY, inputBaseCb, inputBaseCr, inputBaseKeyPoint, inputBaseMatrix, inputDriveKeyPoint, inputDriveMatrix, CroppedWidth, CroppedHeight, CroppedDepth.

When gfv_base_pic_flag is equal to 0 and gfv_drive_pic_fusion_flag is equal to 1 and ChromaFormatIdc is equal to 0, inputs to GenerativeNN( ) are: inputBaseY, inputDriveY, inputBaseKeyPoint, inputBaseMatrix, inputDriveKeyPoint, inputDriveMatrix, CroppedWidth, CroppedHeight, CroppedDepth.

When gfv_base_pic_flag is equal to 0 and gfv_drive_pic_fusion_flag is equal to 1 and ChromaFormatIdc is not equal to 0, inputs to GenerativeNN( ) are: inputBaseY, inputBaseCb, inputBaseCr, inputDriveY, inputDriveCb, inputDriveCr, inputBaseKeyPoint, inputBaseMatrix, inputDriveKeyPoint, inputDriveMatrix, CroppedWidth, CroppedHeight, CroppedDepth.

Outputs of GenerativeNN( ) include a luma sample array genY, and when ChromaFormatIdc is not equal to 0, outputs of GenerativeNN(include two chroma sample arrays genCb and genCr.

Table 15 provides an example of syntax according to some embodiments.

TABLE 15
An example of syntax of the proposed face video generative compression SEI

| | Descriptor |
|---|---|
| generative_face_video ( payloadSize ) { | |
| gfv_id | ue(v) |
| gfv_cnt | ue(v) |
| if( gfv_cnt = = 0 ) | |
| gfv_base_pic_flag /* indicate if the current decoded output picture is a base | u(1) |
| picture */ | |
| if( gfv_base_pic_flag ) { /* specify TranslatorNN( ) */ | |
| gfv_nn_present_flag | u(1) |
| if( gfv_nn_present_flag ) { | |
| gfv_nn_mode_idc | ue(v) |
| if( gfv_nn_mode_idc = = 1 ) { | |
| while( !byte_aligned( ) ) | |
| gfv_nn_alignment_zero_bit_a | u(1) |
| gfv_nn_tag_uri | st(v) |
| gfv_nn_uri | st(v) |
| } | |
| } | |
| gfv_chroma_key_info_present_flag | u(1) |
| if( gfv_chroma_key_info_present_flag ) { | |
| for( c = 0; c < 3; c++ ) { | |
| gfv_chroma_key_value_present_flag[ c ] | u(1) |
| if( gfv_chroma_key_value_present_flag[ c ] ) | |
| gfv_chroma_key_value[ c ] | u(8) |
| } | |
| for( i = 0; i < 2; i++ ) { | |
| gfv_chroma_key_thr_present_flag[ i ] | u(1) |
| if( gfv_chroma_key_thr_present_flag[ i ] ) | |
| gfv_chroma_key_thr_value[ i ] | ue(v) |
| } | |
| } | |
| } else | |
| gfv_drive_pic_fusion_flag /* indicate if DrivePicture is input to | u(1) |
| GenerativeNN( ) */ | |
| gfv_low_confidence_face_parameter_flag | u(1) |
| gfv_coordinate_present_flag | u(1) |
| if( gfv_coordinate_present_flag ) { | |
| gfv_kps_pred_flag | u(1) |
| if( gfv_base_pic_flag \| \| !gfv_kps_pred_flag ) { | |
| gfv_coordinate_precision_factor_minus1 | ue(v) |
| gfv_num_kps_minus1 | ue(v) |
| gfv_coordinate_z_present_flag | u(1) |
| if(gfv_coordinate_z_present_flag ) | |
| gfv_coordinate_z_max_value_minus1 | ue(v) |
| } | |
| for( i = 0; i <= gfv_num_kps_minus1; i++ ) { | |
| if( !gfv_kps_pred_flag ) { | |
| gfv_coordinate_x_abs[ i ] | ue(v) |
| if( gfv_coordinate_x_abs[ i ] > 0) | |
| gfv_coordinate_x_sign_flag[ i ] | u(1) |
| gfv_coordinate_y_abs[ i ] | ue(v) |
| if( gfv_coordinate_y_abs[ i ] > 0) | |
| gfv_coordinate_y_sign_flag[ i ] | u(1) |
| if( gfv_coordinate_z_present_flag > 0 ) { | |
| gfv_coordinate_z_abs[ i ] | ue(v) |
| if( gfv_coordinate_z_abs[ i ] > 0) | |
| gfv_coordinate_z_sign_flag[ i ] | u(1) |
| } | |
| } else { | |
| gfv_coordinate_dx_abs[ i ] | ue(v) |
| if( gfv_coordinate_dx_abs[ i ] > 0) | |
| gfv_coordinate_dx_sign_flag[ i ] | u(1) |
| gfv_coordinate_dy_abs[ i ] | ue(v) |
| if( gfv_coordinate_dy_abs[ i ] > 0) | |
| gfv_coordinate_dy_sign_flag[ i ] | u(1) |
| if( gfv_coordinate_z_present_flag ) { | |
| gfv_coordinate_dz_abs[ i ] | ue(v) |
| if( gfv_coordinate_dz_abs[ i ] > 0) | |
| gfv_coordinate_dz_sign_flag[ i ] | u(1) |
| } | |
| } | |
| } | |
| } | |
| gfv_matrix_present_flag | u(1) |
| if(gfv_matrix_present_flag ) { | |
| if( !gfv_base_pic_flag ) | |
| gfv_matrix_pred_flag | u(1) |
| if( gfv_base_pic_flag \| \| !gfv_matrix_pred_flag ) { | |
| gfv_matrix_element_precision_factor_minus1 | ue(v) |
| gfv_num_matrix_types_minus1 | ue(v) |
| for( i = 0; i <= num_matrix_types_minus1; i++ ) { | |
| gfv_matrix_type_idx[ i ] | u(6) |
| if( gfv_matrix_type_idx[ i] = = 0 \| \| gfv_matrix_type_idx[ i ] = = 1) { | |
| if( gfv_coordinate_present_flag ) | |
| gfv_num_matrices_equal_to_num_kps_flag[ i ] | u(1) |
| if(!gfv_num_matrices_equal_to_num_kps_flag[ i ] ) | |
| gfv_num_matrices_info[ i ] | ue(v) |
| } else | |
| if( gfv_matrix_type_idx[ i] == 2 \| \| gfv_matrix_type_idx[ i] = = 3 \| \| | |
| gfv_matrix_type_idx[ i ] >= 7) { | |
| if( gfv_matrix_type_idx[ i] >= 7) | |
| gfv_num_matrices_minus1[ i ] | ue(v) |
| gfv_matrix_width_minus1[ i ] | ue(v) |
| gfv_matrix_height_minus1 [ i ] | ue(v) |
| } else | |
| if( gfv_matrix_type_idx[ i] >= 4 && gfv_matrix_type_idx[ i] <= 6 && | |
| !gfv_coordinate_present_flag ) | |
| gfv_matrix_for_3D_space_flag[ i ] | u(1) |
| } | |
| } | |
| for( i = 0; i <= num_matrix_types_minus1; i++ ) { | |
| for( j = 0; j < numMatrices[ i ]; j++ ) | |
| for( k = 0; k < matrixHeight[ i ]; k++ ) | |
| for( m = 0; m <matrix Width[ i ]; m++ ) { | |
| if( !gfv_matrix_pred_flag ) { | |
| gfv_matrix_element_int[ i ][ j ][ k ][ m ] | ue(v) |
| gfv_matrix_element_dec[ i ][ j ][ k ][ m ] | u(v) |
| if( gfv_matrix_element_int[ i][ j ][ k ][ m ] \| \| | |
| gfv_matrix_element_dec[ i ][ j ][ k ][ m ] ) | |
| gfv_matrix_element_sign_flag[ i ][ j ][ k ][ m ] | u(1) |
| } else { | |
| gfv_matrix_delta_element_int[ i ][ j ][ k ][ m ] | ue(v) |
| gfv_matrix_delta_element_dec[ i ][ j ][ k ][ m ] | ue(v) |
| if( gfv_matrix_delta_element_int[ i][ j ][ k ][ m ] \| \| | |
| gfv_matrix_delta_element_dec[ i ][ j ][ k ][ m ] ) | |
| gfv_matrix_delta_element_sign_flag[ i ][ j ][ k ][ m ] | u(1) |
| } | |
| } | |
| } | |
| } | |
| if( gfv_nn_present_flag ) | |
| if( gfv_nn_mode_idc = = 0 ) { | |
| while( !byte_aligned( ) ) | |
| gfv_nn_alignment_zero_bit_b | u(1) |
| for( i = 0; more_data_in_payload( ); i++ ) | |
| gfv_nn_payload_byte[ i ] | b(8) |
| } | |
| } | |

The generative face video (GFV) SEI message carries facial parameters and indicates a facial parameter translator network, denoted as TranslatorNN( ), that may be used to convert various formats of facial parameters signalled in the SEI message into a particular facial parameter format supported by the decoding system. A face picture generator neural network, denoted as GenerativeNN( ), may be used to generate output pictures using the facial parameters translated into the particular format and previously decoded output pictures.

When a picture unit contains a GFV SEI message with a particular gfv_id value and gfv_base_pic_flag equal to 1, the picture in the picture unit is referred to as a base picture for that particular gfv_id value.

When a picture unit contains a GFV SEI message with a particular gfv_id value and gfv_base_pic_flag equal to 0, and the picture unit does not contain a GFV SEI message with that particular gfv_id value and gfv_base_pic_flag equal to 1, the picture in the picture unit is referred to as a driving picture for that particular gfv_id value.

When a picture unit contains a GFV SEI message with a particular gfv_id value, gfv_base_pic_flag equal to 0, and gfv_drive_pic_fusion_flag equal to 1, and the picture unit does not contain a GFV SEI message with that particular gfv_id value and gfv_base_pic_flag equal to 1, the picture in the picture unit is referred to as a fusion picture for that particular gfv_id value.

In some embodiments, facial parameters could be determined from source pictures prior to encoding.

In some embodiments, previously decoded output pictures input to GenerativeNN( ) may be a base picture (a decoded output picture that provides the reference texture from which the face pictures may be generated) and, optionally, a picture that can be fused by GenerativeNN( ) to improve background texture and facial details. When the current picture is not a base picture, the GFV SEI message may be used to generate a face picture based on the previously decoded base picture, the facial parameters conveyed by the GFV SEI message, and, optionally, the current decoded picture for fusion purpose.

gfv_id contains an identifying number that may be used to identify face feature information and specify a neural network that may be used as TranslatorNN( ). The value of gfv_id shall be in the range of 0 to 2³²−2, inclusive. Values of gfv_id from 256 to 511, inclusive, and from 2³¹ to 2³²−2, inclusive, are reserved for future use by ITU-T|ISO/IEC. Decoders conforming to this edition of this document encountering a GFV SEI message with gfv_id in the range of 256 to 511, inclusive, or in the range of 2³¹ to 2³²−2, inclusive, shall ignore the SEI message.

gfv_cnt specifies a GFV SEI message instance count value for this gfv_id value within a picture unit.

The gfv_cnt of the first GFV SEI message, in decoding order, with a particular value of gfv_id within a picture unit shall be equal to 0. When gfv_cnt assigned to currGfvCnt is greater than 0, a GFV SEI message with the same gfv_id value and gfv_cnt equal to currGfvCnt−1 shall be present in the same picture unit and precede the current GFV SEI message in decoding order.

The value of gfv_cnt shall be in the range of 0 to 65,535, inclusive.

gfv_base_pic_flag equal to 1 indicates that the current decoded output picture corresponds to a base picture and this SEI message specifies the syntax elements for a base picture. gfv_base_pic_flag equal to 0 indicates that the current decoded output picture does not correspond to a base picture or this SEI message does not specify syntax elements for a base picture. When gfv_base_pic_flag is not present, it is inferred to be equal to 0.

When a GFV SEI message is the first GFV SEI message, in decoding order, that has a particular gfv_id value within the current CLVS, the value of gfv_base_pic_flag shall be equal to 1.

When a GFV SEI message with a particular gfv_id value has gfv_base_pic_flag equal to 1, the base picture for that particular gfv_id value, which is the current cropped decoded picture, remains valid for the current decoded picture and all subsequent decoded pictures of the current layer, in output order, until the end of the current CLVS or up to but excluding the decoded picture that is within the current CLVS, follows the current decoded picture in output order, and is associated with a GFV SEI message having that particular gfv_id value and gfv_base_pic_flag equal to 1, whichever is earlier.

gfv_nn_present_flag equal to 1 indicates that a neural network that may be used as a TranslatorNN( ) is contained or indicated by the SEI message. gfv_nn_present_flag equal to 0 indicates that a neural network that may be used as a TranslatorNN( ) is not contained or indicated by the SEI message. When gfv_nn_present_flag is not present, it is inferred to be 0.

When gfv_nn_present_flag is equal to 0 and TranslatorNN is referenced in the semantics of the GFV SEI message, the following constraint applies. If gfv_cnt is equal to 0, there shall be at least one GFV SEI message present in a preceding picture unit in output order in the current CLVS and having the same value of gfv_id as that in the current GFV SEI message and gfv_nn_present_flag equal to 1. Otherwise (gfv_cnt is greater than 0), there shall be at least one GFV SEI message that is present in either the current picture unit or a preceding picture unit in output order in the current CLVS and has the same value of gfv_id as that in the current GFV SEI message and gfv_nn_present_flag equal to 1.

When gfv_nn_present_flag is equal to 0 and TranslatorNN is referenced in the semantics of this SEI message, the following applies for deriving the applicable TranslatorNN. If gfv_cnt is greater than 0 and there exists one or more preceding GFV SEI messages in decoding order in the current picture unit that has the same value of gfv_id as that in the current GFV SEI message and gfv_nn_present_flag equal to 1, the applicable TranslatorNN is defined by the last preceding GFV SEI message in decoding order in the current picture unit that has the same value of gfv_id as that in the current GFV SEI message and gfv_nn_present_flag equal to 1. Otherwise, the applicable TranslatorNN is defined by a GFV SEI message that is present in the last preceding picture unit puB in output order in the current CLVS that has the same value of gfv_id as the current GFV SEI message and gfv_nn_present_flag equal to 1. When there are multiple such GFV SEI messages present in the picture unit puB that have the same value of gfv_id as the current GFV SEI message and gfv_nn_present_flag equal to 1, the applicable TranslatorNN is defined by the last of such GFV SEI messages in decoding order.

gfv_nn_mode_idc, gfv_nn_alignment_zero_bit_a, gfv_nn_tag_uri, gfv_nn_uri, gfv_nn_alignment_zero_bit_b, and gfv_nn_payload_byte[i] specify a neural network that may be used as a TranslatorNN( ). gfv_nn_mode_idc, gfv_nn_alignment_zero_bit_a, gfv_nn_tag_uri, gfv_nn_uri, gfv_nn_alignment_zero_bit_b, and gfv_nn_payload_byte[i] have the same syntax and semantics as nnpfc_base_flag, nnpfc_mode_idc, nnpfc_alignment_zero_bit_a, nnpfc_tag_uri, nnpfc_uri, nnpfc_alignment_zero_bit_b, and nnpfc_payload_byte[i], respectively.

The GFV SEI messages that are present in the same picture unit and have the same values of gfv_id and gfv_cnt shall have the same SEI payload content.

gfv_drive_pic_fusion_flag, when present, equal to 1 indicates that the current decoded picture, which corresponds to a driving picture that may be used for fusion, may be input to GenerativeNN( ). gfv_drive_pic_fusion_flag equal to 0 indicates that the current decoded picture should not be input to GenerativeNN( ).

In some embodiments, gfv_drive_pic_fusion_flag value of 1 can be used, for example, to indicate that the current decoded picture can be used to improve face details or handle background changes.

In some embodiments, when gfv_base_pic_flag is equal to 0 and gfv_drive_pic_fusion_flag is equal to 1, the GFV process takes three inputs: the base picture, features from keypoints and/or matrices carried in the GFV SEI message, and the current decoded picture that is a fusion picture, and outputs a picture that is generated by the GenerativeNN( ).

In some embodiments, when gfv_base_pic_flag is equal to 0 and gfv_drive_pic_fusion_flag is equal to 0, the GFV process takes twoinputs: the base picture and features from keypoints and/or matrices carried in the GFV SEI message, and outputs a picture that is generated by the GenerativeNN( ).

In some embodiments, when gfv_base_pic_flag is equal to 1, the GFV process directly outputs the cropped decoded picture.

When a GFV SEI message has gfv_base_pic_flag equal to 0 and gfv_drive_pic_fusion_flag equal to 0, the GFV SEI message pertains to the current decoded picture only.

When a GFV SEI message with a particular gfv_id value has gfv_base_pic_flag equal to 0 and gfv_drive_pic_fusion_flag equal to 1, the fusion picture for that particular gfv_id value, which is the current cropped decoded picture, remains valid for the current decoded picture and all subsequent decoded pictures of the current layer, in output order, until the end of the current CLVS or up to but excluding the decoded picture that is within the current CLVS, follows the current decoded picture in output order, and is associated with a GFV SEI message having that particular gfv_id value, whichever is earlier.

When a GFV SEI message gfvSeiA with a particular gfv_id value has gfv_cnt greater than 0 and a GFV SEI message gfvSeiB with the same gfv_id value in the same picture unit has gfv_base_pic_flag equal to 1 (i.e., the current decoded picture is a base picture), the GFV SEI message gfvSeiA shall have gfv_drive_pic_fusion_flag equal to 0.

gfv_coordinate_present_flag equal to 1 indicates that coordinate information of keypoints is present. gfv_coordinate_present_flag equal to 0 indicates that coordinate information of keypoints is not present.

It is a requirement of bitstream conformance that when gfv_matrix_type_idx[i] for any i from 0 to gfv_num_matrix_types_minus1 is equal to 0 or 1, the value of gfv_coordinate_present_flag shall be equal to 1.

gfv_kps_pred_flag equal to 1 indicates that the syntax elements gfv_coordinate_dx_abs[i],gfv_coordinate_dy_abs[i], and gfv_coordinate_dz_abs[i] are present and the syntax elements gfv_coordinate_dx_sign_flag[i], gfv_coordinate_dy_sign_flag[i] and gfv_coordinate_dz_sign_flag[i] may be present. gfv_kps_pred_flag equal to 0 indicates that the syntax elements gfv_coordinate_x_abs[i], gfv_coordinate_y_abs[i], and gfv_coordinate_z_abs[i] are present and the syntax elements gfv_coordinate_x_sign_flag[i], gfv_coordinate_y_sign_flag[i] and gfv_coordinate_z_sign_flag[i] may be present.

When gfv_coordinate_present_flag is equal to 1, gfv_base_pic_flag is equal to 0, and gfv_kps_pred_flag is equal to 1, there shall be a previous GFV SEI message in decoding order with the same gfv_id as the current GFV SEI message and gfv_base_pic_flag equal to 1 in the current CLVS.

gfv_coordinate_precision_factor_minus1 plus 1 indicates the precision of keypoint coordinates signalled in the SEI message. The value of gfv_coordinate_precision_factor_minus1 shall be in the range of 0 to 31, inclusive. When gfv_coordinate_present_flag is equal to 1, gfv_base_pic_flag is equal to 0, and gfv_kps_pred_flag is equal to 1, the value of gfv_coordinate_precision_factor_minus1 is inferred to be equal to the gfv_coordinate_precision_factor_minus1 of the previous GFV SEI message in decoding order with the same gfv_id as the current GFV SEI message and gfv_base_pic_flag equal to 1.

gfv_num_kps_minus1 plus 1 indicates the number of keypoints. The value of gfv_num_kps_minus1 shall be in the range of 0 to 2¹⁰−1, inclusive. When gfv_coordinate_present_flag is equal to 1, gfv_base_pic_flag is equal to 0, and gfv_kps_pred_flag is equal to 1, the value of gfv_num_kps_minus1 is inferred to be equal to the gfv_num_kps_minus1 of the previous GFV SEI message in decoding order with the same gfv_id as the current GFV SEI message and gfv_base_pic_flag equal to 1.

gfv_coordinate_z_present_flag equal to 1 indicates that z-axis coordinate information of the keypoints is present. gfv_coordinate_z_present_flag equal to 0 indicates that the z-axis coordinate information of the keypoints is not present. When gfv_coordinate_z_present_flag is not present, it is inferred as follows. If gfv_coordinate_present_flag is equal to 1, gfv_base_pic_flag is equal to 0, and gfv_kps_pred_flag is equal to 1, the value of coordinate_z_present_flag is inferred to be equal to the coordinate_z_present_flag of the previous GFV SEI message in decoding order with the same gfv_id as the current GFV SEI message and gfv_base_pic_flag equal to 1. Otherwise, if gfv_coordinate_present_flag is equal to 0, the value of coordinate_z_present_flag is inferred to be equal to 0.

When gfv_coordinate_present_flag is equal to 1, gfv_base_pic_flag is equal to 0, and gfv_kps_pred_flag is equal to 1, the value of coordinate_z_present_flag is inferred to be equal to the coordinate_z_present_flag of the previous GFV SEI message in decoding order with the same gfv_id as the current GFV SEI message and gfv_base_pic_flag equal to 1.

gfv_coordinate_z_max_value_minus1 plus 1 indicates the maximum absolute value of z-axis coordinates of keypoints. The value of gfv_coordinate_z_max_value_minus1 shall be in the range of 0 to 2¹⁶−1, inclusive. When gfv_coordinate_present_flag is equal to 1, gfv_base_pic_flag is equal to 0, and gfv_kps_pred_flag is equal to 1, the value of gfv_coordinate_z_max_value_minus1 is inferred to be equal to the gfv_coordinate_z_max_value_minus1, when present, in the previous GFV SEI message in decoding order with the same gfv_id as the current GFV SEI message and gfv_base_pic_flag equal to 1.

gfv_coordinate_x_abs[i] is used to derive the x-axis coordinate of the i-th keypoint. The value of gfv_coordinate_x_abs[i] shall be in the range of 0 to 2^{gfv_coordinate_precision_factor_minus1+1}, inclusive.

gfv_coordinate_x_sign_flag[i] specifies the sign of the x-axis coordinate of the i-th keypoint. When gfv_coordinate_x_sign_flag[i] is not present, it is inferred to be equal to 0.

gfv_coordinate_y_abs[i] is used to derive y-axis coordinate of i-th keypoint. The value of gfv_coordinate_y_abs[i] shall be in the range of 0 to 2^{gfv_coordinate_precision_factor_minus1+1}, inclusive.

gfv_coordinate_y_sign_flag[i] specifies the sign of the y-axis coordinate of the i-th keypoint. When gfv_coordinate_y_sign_flag[i] is not present, it is inferred to be equal to 0.

gfv_coordinate_z_abs[i] is used to derive z-axis coordinate of the i-th keypoint. The value of gfv_coordinate_z_abs[i] shall be in the range of 0 to 2^{gfc_coordinate_precision_factor_minus1+1}, inclusive.

gfv_coordinate_z_sign_flag[i] specifies the sign of the z-axis coordinate of the i-th keypoint. When gfv_coordinate_z_sign_flag[i] is not present, it is inferred to be equal to 0.

gfv_coordinate_dx_abs[i] specifies a difference value that is used to derive x-axis coordinate of the i-th keypoint. The value of gfv_coordinate_dx_abs[i] shall be in the range of 0 to 2^{gfv_coordinate_precision_factor_minus1+2}, inclusive.

gfv_coordinate_dx_sign_flag[i] specifies the sign of the difference value of the x-axis coordinate of the i-th keypoint. When gfv_coordinate_dx_sign_flag[i] is not present, it is inferred to be equal to 0.

gfv_coordinate_dy_abs[i] specifies a difference value that is used to derive y-axis coordinate of the i-th keypoint. The value of gfv_coordinate_dy_abs[i] shall be in the range of 0 to 2^{gfv_coordinate_precision_factor_minus1+2}, inclusive.

gfv_coordinate_dy_sign_flag[i] specifies the sign of the difference value of the y-axis coordinate of the i-th keypoint. When gfv_coordinate_yd_sign_flag[i] is not present, it is inferred to be equal to 0.

gfv_coordinate_dz_abs[i] specifies a difference value that is used to derive z-axis coordinate of the i-th keypoint. The value of gfv_coordinate_dz_abs[i] shall be in the range of 0 to 2^{gfv_coordinate_precision_factor_minus1+2}, inclusive.

gfv_coordinate_dz_sign_flag[i] specifies the sign of the difference value of the z-axis coordinate of the i-th keypoint. When gfv_coordinate_dz_sign_flag[i] is not present, it is inferred to be equal to 0.

If gfv_coordinate_z_max_value_minus1 is present, the variable CroppedDepth is set equal to gfv_coordinate_z_max_value_minus1+1. Otherwise, CroppedDepth is set equal to 0.

When gfv_kps_pred_flag is equal to 1, the variables coordinateDeltaX[i], coordinateDeltaY[i] and coordinateDeltaZ[i] indicating the delta x-axis coordinate, delta y-axis coordinate and delta z-axis coordinate of the i-th keypoint, respectively, are derived as follows:

```
coordinateDeltaX[ i ] = ( 1 − 2 * gfv_coordinate_dx_sign_flag[ i ] ) *
gfv_coordinate_dx_abs[ i ] ÷
    ( 1 << ( gfv_coordinate_precision_factor_minus1 + 1 ) )
coordinateDeltaY[ i ] = ( 1 − 2 * gfv_coordinate_dy_sign_flag[ i ] ) *
gfv_coordinate_dy_abs[ i ] ÷
    ( 1 << ( gfv_coordinate_precision_factor_minus1 + 1 ) )
if( gfv_coordinate_z_present_flag )
  coordinateDeltaZ[ i ] = ( 1 − 2 * gfv_coordinate_dz_sign_flag[ i ] ) *
gfv_coordinate_dz_abs[ i ] ÷
    ( 1 << ( gfv_coordinate_precision_factor_minus1 + 1 ) )
```

The variables coordinateX[i], coordinateY[i], and, when gfv_coordinate_z_present_flag is equal to 1, coordinateZ[i] indicating the x-axis coordinate, y-axis coordinate and z-axis coordinate of the i-th keypoint, respectively, are derived as follows:

If gfv_kps_pred_flag is equal to 0, the following applies:

```
coordinateX[ i ] = ( 1 − 2 * gfv_coordinate_x_sign_flag[ i ] ) * gfv_coordinate_x_abs[ i ] ÷
  ( 1 << ( gfv_coordinate_precision_factor_minus1 + 1 ) )
coordinateY[ i ] = ( 1 − 2 * gfv_coordinate_y_sign_flag[ i ] ) * gfv_coordinate_y_abs[ i ] ÷
  ( 1 << ( gfv_coordinate_precision_factor_minus1 + 1 ) )
if ( gfv_coordinate_z_present_flag )
  coordinateZ[ i ] = ( 1 − 2 * gfv_coordinate_z_sign_flag[ i ] ) *
gfv_coordinate_z_abs[ i ] ÷
  ( 1 << ( gfv_coordinate_precision_factor_minus1 + 1 ) )
```

Otherwise (gfv_kps_pred_flag is equal to 1), the following applies:

```
if( gfv_base_pic_flag ) {
  coordinateX[ i ] = (( i > 0 ) ? coordinateX[ i − 1 ] : 0 ) + coordinateDeltaX[ i ]
  coordinateY[ i ] = (( i > 0 ) ? coordinateY[ i − 1 ] : 0 ) + coordinateDeltaY[ i ]
  if (gfv_coordinate_z_present_flag )
    coordinateZ[ i ] = (( i > 0 ) ? coordinateZ[ i − 1 ] : 0 ) + coordinateDeltaZ[ i ]
} else if( gfv_cnt = = 0 ) {
  coordinateX[ i ] = BaseKpCoordinateX[ i ] + coordinateDeltaX[ i ]
  coordinateY[ i ] = BaseKpCoordinateY[ i ] + coordinateDeltaY[ i ]
  if (gfv_coordinate_z_present_flag )
    coordinateZ[ i ] = BaseKpCoordinateZ[ i ] + coordinateDeltaZ[ i ]
} else {
  coordinateX[ i ] = PrevKpCoordinateX[ i ] + coordinateDeltaX[ i ]
  coordinateY[ i ] = PrevKpCoordinateY[ i ] + coordinateDeltaY[ i ]
  coordinateZ[ i ] = PrevKpCoordinateZ[ i ] + coordinateDeltaZ[ i ]
}
```

The following applies for derivation of the variables BaseKpCoordinateX[i], BaseKpCoordinateY[i], BaseKpCoordinateZ[i], PrevKpCoordinateX[i], PrevKpCoordinateY[i], and PrevKpCoordinateZ[i]:

```
if( gfv_base_pic_flag ) {
  PrevKpCoordinateX[ i ] = BaseKpCoordinateX[ i ] = coordinateX[ i ]
  PrevKpCoordinateY[ i ] = BaseKpCoordinateY[ i ] = coordinateY[ i ]
  if (gfv_coordinate_z_present_flag )
    PrevKpCoordinateZ[ i ] = BaseKpCoordinateZ[ i ] = coordinateZ[ i ]
} else {
  PrevKpCoordinateX[ i ] = coordinateX[ i ]
  PrevKpCoordinateY[ i ] = coordinateY[ i ]
  PrevKpCoordinateZ[ i ] = coordinateZ[ i ]
}
```

gfv_matrix_present_flag equal to 1 indicates that matrix parameters are present. gfv_matrix_present_flag equal to 0 indicates that matrix parameters are not present. When gfv_coordinate_present_flag is equal to 0, gfv_matrix_present_flag shall be equal to 1.

gfv_matrix_pred_flag equal to 1 indicates that the syntax elements gfv_matrix_element_int[i][j][k][m] and gfv_matrix_element_dec [i][j][k][m] are present and the syntax element gfv_matrix_element_sign_flag[i][j][k][m] may be present. gfv_matrix_pred_flag equal to 0 indicates that the syntax elements gfv_matrix_delta_element_int[i][j][k][m] and gfv_matrix_delta_element_dec[i][j][k][m] are present and the syntax element gfv_matrix_delta_element_sign_flag [i][j][k][m] may be present. When gfv_matrix_pred_flag is not present, it is inferred to be 0.

When gfv_matrix_present_flag is equal to 1, gfv_base_pic_flag is equal to 0, and gfv_matrix_pred_flag is equal to 1, there shall be a previous GFV SEI message in decoding order with the same gfv_id as the current GFV SEI message and gfv_base_pic_flag equal to 1 in the current CLVS.

gfv_matrix_element_precision_factor_minus1 plus 1 indicates the precision of matrix elements signalled in the SEI message. The value of gfv_matrix_element_precision_factor_minus1 shall be in the range of 0 to 31, inclusive. When gfv_matrix_present_flag is equal to 1, gfv_base_pic_flag is equal to 0, and gfv_matrix_pred_flag is equal to 1, the value of gfv_matrix_element_precision_factor_minus1 is inferred to be equal to the gfv_matrix_element_precision_factor_minus1 of the previous GFV SEI message in decoding order with the same gfv_id as the current GFV SEI message and gfv_base_pic_flag equal to 1.

gfv_num_matrix_types_minus1 plus 1 indicates the number of matrix types signalled in the SEI message. The value of gfv_num_matrix_types_minus1 shall be in the range of 0 to 2⁶−1, inclusive. It is a requirement of bitstream conformance that when gfv_matrix_present_flag is equal to 1, gfv_matrix_pred_flag is equal to 1 and gfv_base_pic_flag is equal to 0, the value of gfv_num_matrix_types_minus1 shall be equal to the value of gfv_num_matrix_types_minus1 in each of the preceding GFV SEI message in decoding order in the current CLVS which has the same gfv_id value as the gfv_id value in the current SEI and has gfv_base_pic_flag equal to 1. When gfv_matrix_present_flag is equal to 1, gfv_base_pic_flag is equal to 0, and gfv_matrix_pred_flag is equal to 1, the value of gfv_matrix_type_num_minus1 is inferred to be equal to the gfv_matrix_type_num_minus1 of the previous GFV SEI message in decoding order with the same gfv_id as the current GFV SEI message and gfv_base_pic_flag equal to 1.

gfv_matrix_type_idx[i] indicates the index of the i-th matrix type. The value of gfv_matrix_type_idx[i] shall be in the range of 0 to 63, inclusive. In bitstreams conforming to this version of this Specification, the value of gfv_matrix_type_idx[i] shall be in the range of 0 to 31, inclusive. Decoders conforming to this version of this Specification shall allow gfv_matrix_type_idx[i] to be greater than 31 to appear in the bitstream and the decoder shall ignore all information for the i-th type of matrix for which gfv_matrix_type_idx[i] is greater than 31.

gfv_num_matrices_equal_to_num_kps_flag[i] equal to 1 indicates that the number of matrices of the i-th matrix type is equal to gfv_num_kps_minus1+1. gfv_num_matrices_equal_to_num_kps_flag[i] equal to 0 indicates the number of matrices of the i-th matrix type is not equal to gfv_num_kps_minus1+1. If gfv_matrix_present_flag is equal to 1, gfv_base_pic_flag is equal to 0, gfv_matrix_pred_flag is equal to 1, gfv_matrix_type_idx[i] is equal to 0 or 1, and gfv_coordinate_present_flag is equal to 1, the value of gfv_num_matrices_equal_to_num_kps_flag[i] is inferred to be equal to the gfv_num_matrices_equal_to_num_kps_flag[i], when present, in the previous GFV SEI message in decoding order with the same gfv_id as the current GFV SEI message and gfv_base_pic_flag equal to 1. Otherwise, when gfv_num_matrices_equal_to_num_kps_flag[i] is not present, its value is inferred to be equal to 0.

gfv_num_matrices_info[i] provides information to derive the number of the matrices of the i-th matrix type. The value of gfv_num_matrices_info[i] shall be in the range of 0 to 2¹⁰−1, inclusive. When gfv_matrix_present_flag is equal to 1, gfv_base_pic_flag is equal to 0, gfv_matrix_pred_flag is equal to 1, gfv_matrix_type_idx[i] is equal to 0 or 1, and either gfv_coordinate_present_flag is equal to 0 or gfv_num_matrix_equal_to_num_kps_flag[i] is equal to 0, the value of gfv_num_matrices_info[i] is inferred to be equal to the gfv_num_matrices_info[i], when present, in the previous GFV SEI message in decoding order with the same gfv_id as the current GFV SEI message and gfv_base_pic_flag equal to 1.

gfv_matrix_width_minus1[i] plus 1 indicates the width of the matrix of the i-th matrix type. The value of gfv_matrix_width_minus1[i] shall be in the range of 0 to 2¹⁰−1, inclusive. When gfv_matrix_present_flag is equal to 1, gfv_matrix_pred_flag is equal to 0, gfv_matrix_pred_flag is equal to 1, and gfv_matrix_type_idx[i] is equal to 2 or 3 or is greater than or equal to 7, the value of gfv_matrix_width_minus1[i] is inferred to be equal to the gfv_matrix_width_minus1[i], when present, in the previous GFV SEI message in decoding order with the same gfv_id as the current GFV SEI message and gfv_base_pic_flag equal to 1.

gfv_matrix_height_minus1[i] plus 1 indicates the height of the matrix of the i-th matrix type. The value of gfv_matrix_height_minus1[i] shall be in the range of 0 to 2¹⁰−1, inclusive. When gfv_matrix_present_flag is equal to 1, gfv_base_pic_flag is equal to 0, gfv_matrix_pred_flag is equal to 1, and gfv_matrix_type_idx[i] is equal to 2 or 3 or is greater than or equal to 7, the value of gfv_matrix_height_minus1[i] is inferred to be equal to the gfv_matrix_height_minus1[i], when present, in the previous GFV SEI message in decoding order with the same gfv_id as the current GFV SEI message and gfv_base_pic_flag equal to 1.

gfv_matrix_for_3D_space_flag[i] equal to 1 indicates the matrix of the i-th matrix type is a matrix defined in three-dimensional space. gfv_matrix_for_3D_space_flag[i] equal to 0 indicates the matrix of the i-th matrix type is a matrix defined in two-dimensional space.

If gfv_matrix_present_flag is equal to 1, gfv_coordinate_present_flag is equal to 0, gfv_matrix_type_idx[i] is equal to 4, 5, or 6, the inference of gfv_matrix_for_3D_space_flag[i] is conducted when it is not present. The inference is as follows. If gfv_matrix_present_flag is equal to 1, gfv_base_pic_flag is equal to 0, gfv_matrix_pred_flag is equal to 1, gfv_matrix_type_idx[i] is equal to 4, 5, or 6, and gfv_coordinate_present_flag is equal to 0, the value of gfv_matrix_for_3D_space_flag[i] is inferred to be equal to the gfv_matrix_for_3D_space_flag[i], when present, in the previous GFV SEI message in decoding order with the same gfv_id as the current GFV SEI message and gfv_base_pic_flag equal to 1. Otherwise, if gfv_matrix_present_flag is equal to 1, gfv_coordinate_present_flag is equal to 0, gfv_matrix_type_idx[i] is equal to 4, 5, or 6, the value of gfv_matrix_for_3D_space_flag[i] is inferred to be equal to 0.

If gfv_base_pic_flag is 1 or gfv_matrix_pred_flag is equal to 0, the inference of gfv_matrix_width_minus1[i] is conducted when gfv_matrix_present_flag is equal to 1 and gfv_matrix_width_minus1[i] is not present. In that case, the value of gfv_matrix_width_minus1[i] is inferred as follows. If gfv_matrix_type_idx[i] is equal to 0 or 1, gfv_matrix_width_minus1[i] is inferred to be equal to coordinate_z_present_flag+1. Otherwise, if gfv_matrix_type_idx[i] is equal to 4, gfv_matrix_width_minus1[i] is inferred to be equal to (coordinate_z_present_flag ∥ gfv_matrix_for_3D_space_flag[i])+1. Otherwise (gfv_matrix_type_idx[i] is equal to 5 or 6), gfv_matrix_width_minus1[i] is inferred to be equal to 0.

If gfv_base_pic_flag is 1 or gfv_matrix_pred_flag is equal to 0, the inference of gfv_matrix_height_minus1[i] is conducted when gfv_matrix_present_flag is equal to 1 and gfv_matrix_height_minus1[i] is not present. In that case, the value of gfv_matrix_height_minus1[i] is inferred as follows. If gfv_matrix_type_idx is equal to 0 or 1, gfv_matrix_height_minus1[i] is inferred to be equal to gfv_coordinate_z_present_flag+1. Otherwise (gfv_matrix_type_idx is equal to 4, 5 or 6 and one of gfv_coordinate_z_present_flag and gfv_matrix_for_3D_space_flag[i] is 0), gfv_matrix_height_minus1[i] is inferred to be equal to (gfv_coordinate_z_present_flag∥ gfv_matrix_for_3D_space_flag[i])+1.

The variables matrixWidth[i] and matrixHeight[i] indicating the width and height of the matrix of the i-th matrix type are derived as follows:

```
if( gfv_matrix_pred_flag ) {
  matrixWidth[ i ] = BaseMatrixWidth[ i ]
  matrixHeight[ i ] = BaseMatrixHeight[ i ]
} else {
  matrixWidth[ i ] = gfv_matrix_width_minus1[ i ] + 1
  matrixHeight[ i ] = gfv_matrix_height_minus1[ i ] + 1
}
if( gfv_base_pic_flag ) {
  BaseMatrixWidth[ i ] = matrixWidth[ i ]
  BaseMatrixHeight[ i ] = matrixHeight[ i ]
}
```

When gfv_matrix_type_idx[i] is equal to 4, 5, or 6, the dimension of the matrix can be decided according to the dimension of the keypoint. If the keypoints have z-axis coordinate (i.e., the 3-D keypoints are used and signaled), the matrix is also defined in three-dimensional space and thus the width and height of the matrix are 3. Otherwise, the matrix is defined in two-dimensional space and thus the width and the height of the matrix are 2. Thus, the dimensions of the matrix can be inferred based on the keypoint dimensions. So in some embodiments, the inference of the gfv_matrix_for_3D_space_flag[i] is based on gfv_coordinate_z_present_flag.

gfv_matrix_for_3D_space_flag[i] equal to 1 indicates the matrix of the i-th matrix type is a matrix defined in three-dimensional space. gfv_matrix_for_3D_space_flag[i] equal to 0 indicates the matrix of the i-th matrix type is a matrix defined in two-dimensional space. When gfv_maxtrix_present_flag is equal to 1, gfv_matrix_pred_flag is equal to 0, gfv_matrix_type_idx is equal to 4, 5 or 6 and gfv_coordinate_present_flag is equal to 1, the value of gfv_maxtrix_for_3D_space_flag [i] is inferred to be equal to gfv_coordinate_z_present_flag. The modifications to the existing semantics are italicized.

In case that the value of gfv_matrix_for_3D_space_flag being inferred to be equal to gfv_coordinate_z_present_flag, the value of gfv_matrix_width_minus1[i] and gfv_matrix_width_minus1[i]can be inferred as follows.

When gfv_maxtrix_present_flag is equal to 1, gfv_matrix_pred_flag is equal to 0 and gfv_matrix_width_minus1[i] is not present, the value of gfv_matrix_width_minus1[i] is inferred as follows. If gfv_matrix_type_idx[i] is equal to 0 or 1, gfv_matrix_width_minus1[i] is inferred to be equal to gfv_coordinate_z_present_flag+1. Otherwise, if gfv_matrix_type_idx[i] is equal to 4, gfv_matrix_width_minus1[i] is inferred to be equal to fv_matrix_for_3D_space_flag[i]+1. Otherwise (gfv_matrix_type_idx[i] is equal to 5 or 6), gfv_matrix_width_minus1[i] is inferred to be equal to 0.

When gfv_matrix_present_flag is equal to 1, gfv_matrix_pred_flag is equal to 0 and gfv_matrix_height_minus1[i] is not present, the value of gfv_matrix_height_minus1[i] is inferred as follows. If gfv_matrix_type_idx is equal to 0 or 1, gfv_matrix_height_minus1[i] is inferred to be equal to gfv_coordinate_z_present_flag+1. Otherwise (gfv_matrix_type_idx is equal to 4, 5 or 6), gfv_matrix_height_minus1[i] is inferred to be equal to gfv_matrix_for_3D_space_flag[i]+1.

gfv_num_matrices_minus1[i] plus 1 indicates the number of matrices of the i-th matrix type. The value of gfv_num_matrices_minus1[i] shall be in the range of 0 to 2¹⁰−1, inclusive. When gfv_matrix_present_flag is equal to 1, gfv_base_pic_flag is equal to 0, gfv_matrix_pred_flag is equal to 1, and gfv_matrix_type_idx[i] is greater than or equal to 7, the value of gfv_num_matrices_minus1[i] is inferred to be equal to the gfv_num_matrices_minus1[i], when present, in the previous GFV SEI message in decoding order with the same gfv_id as the current GFV SEI message and gfv_base_pic_flag equal to 1.

The variable numMatrices[i] indicating the number of the matrices of the i-th matrix type is derived as follows:

```
if( gfv_matrix_pred_flag )
  numMatrices[ i ] = BaseNumMatrices[ i ]
else if( gfv_matrix_type_idx[ i ] = = 0 | | gfv_matrix_type_idx[ i ] = = 1 ) {
  if( gfv_coordinate_present_flag )
    numMatrices[ i ] = gfv_num_matrices_equal_to_num_kps_flag[ i ] ?
gfv_num_kps_minus1 + 1:
      ( gfv_num_matrices_info[ i ] < gfv_num_kps_minus1 ? gfv_num_matrices_info
[ i ] + 1:
      gfv_num_matrices_info [ i ] + 2 )
  else
    numMatrices[ i ] = gfv_num_matrices_info[ i ] + 1
} else if( gfv_matrix_type_idx[ i ] >= 2 && gfv_matrix_type_idx[ i ] < 7 )
  numMatrices[ i ] = 1
else
  numMatrices[ i ] = gfv_num_matrices_minus1[ i ] + 1
if( gfv_base_pic_flag )
  BaseNumMatrices[ i ] = numMatrices[ i ]
```

Considering that when gfv_matrix_type_idx[i] is equal to 0 or 1, the coordinates of the keypoints must be signaled. The derivation of variable numMatrices[i]can be simplified as follows:

```
if( gfv_matrix_pred_flag )
  numMatrices[ i ] = BaseNumMatrices[ i ]
else if( gfv_matrix_type_idx[ i ] = = 0 | | gfv_matrix_type_idx[ i ] = = 1 ) {
  numMatrices[ i ] = gfv_num_matrices_equal_to_num_kps_flag[ i ] ?
gfv_num_kps_minus1 + 1:
    ( gfv_num_matrices_info[ i ] < gfv_num_kps_minus1 ? gfv_num_matrices_info
[ i ] + 1: gfv_num_matrices_info [ i ] + 2 )
} else if( gfv_matrix_type_idx[ i ] >= 2 && gfv_matrix_type_idx[ i ] < 7 )
  numMatrices[ i ] = 1
else
  numMatrices[ i ] = gfv_num_matrices_minus1[ i ] + 1
```

It is a requirement of bitstream conformance that when gfv_matrix_pred_flag is equal to 1 and gfv_base_pic_flag is equal to 0, the values of numMatrices[i], matrixWidth[i], and matrixHeight[i] for i in the range of 0 to gfv_num_matrix_types_minus1, inclusive shall be respectively equal to the values of numMatrices[i], matrixWidth[i], and matrixHeight[i] for i in the range of 0 to gfv_num_matrix_types_minus1, inclusive in each of the preceding GFV SEI message in decoding order in the current CLVS which has the same gfv_id value as the gfv_id value in the current SEI and has gfv_base_pic_flag equal to 1.

gfv_matrix_element_int[i][j][k][m] indicates the integer part of the value of the matrix element at position (m, k) of the j-th matrix of the i-th matrix type. The value of gfv_matrix_element_int[i][j][k][m] shall be in the range of 0 to 2³²−2, inclusive.

gfv_matrix_element_dec[i][j][k][m] indicates the decimal part of the value of the matrix element at position (m, k) of the j-th matrix of the i-th matrix type. The length of gfv_matrix_element_dec[i][j][k][m] is gfv_matrix_element_precision_factor_minus1+1 bits.

gfv_matrix_element_sign_flag[i][j][k][m] indicates the sign of the matrix element at position (m, k) of the j-th matrix of the i-th matrix type. When gfv_matrix_element_sign_flag[i][j][k][m] is not present, it is inferred to be equal to 0.

gfv_matrix_delta_element_int[i][j][k][m] indicates the integer part of the difference value of the matrix element at position (m, k) of the j-th matrix of the i-th matrix type. The value of gfv_matrix_delta_element_int[i][j][k][m] shall be in the range of 0 to 2³²−2, inclusive.

gfv_matrix_delta_element_dec[i][j][k][m] indicates the decimal part of the difference value of the matrix element at position (m, k) of the j-th matrix of the i-th matrix type. The value of gfv_matrix_delta_element_dec[i][j][k][m] shall be in the range of 0 to 2^{gfv_matrix_element_precision_factor_minus1+1}−1, inclusive.

gfv_matrix_delta_element_sign_flag[i][j][k][m] indicates the sign of the difference value of the matrix element at position (m, k) of the j-th matrix of the i-th matrix type. When gfv_matrix_element_sign_flag[i][j][k][m] is not present, it is inferred to be equal to 0.

When gfv_matrix_pred_flag is equal to 1, the variable matrixElementDeltaVal[i][j][k][m] representing the difference value of the matrix element at position (m, k) of the j-th matrix of the i-th matrix type is derived as follows:

matrixElementDeltaVal[ i][ j ][ k ][ m ] = (1 − 2 *
gfv_matrix_delta_element_sign_flag[ i ][ j ][ k ][ m ]) *
(gfv_matrix_delta_element_int[ i ][ j ][ k ][ m ] +
(gfv_matrix_delta_element_dec[ i ][ j ][ k ][ m ] ÷ (1 <<
gfv_matrix_element_precision_factor_minus1 + 1))

The variable matrixElementVal[i][j][k][m] representing the value of the matrix element at position (m, k) of the j-th matrix of the i-th matrix type is derived as follows. If gfv_matrix_pred_flag is equal to 0, the following applies:

```
  matrixElementVal[ i][ j ][ k ][ m ] = (1 − 2 *
  gfv_matrix_element_sign_flag[ i ][ j ][ k ][ m ]) *
  (gfv_matrix_element_int[ i ][ j ][ k ][ m ] + (gfv_matrix_element_dec[ i ][ j ][ k ][ m ] ÷
  (1 << gfv_matrix_element_precision_factor_minus1 + 1))
  if( gfv_base_pic_flag )
    BaseMatrixElementVal[ i][ j ][ k ][ m ] = matrixElementVal[ i][ j ][ k ][ m ]
Otherwise (gfv_matrix_pred_flag is equal to 1), the following applies:
  if( gfv_cnt = = 0 )
    matrixElementVal[ i][ j ][ k ][ m ] = BaseMatrixElementVal[ i][ j ][ k ][ m ] +
      matrixElementDeltaVal[ i][ j ][ k ][ m ]
  else
    matrixElementVal[ i][ j ][ k ][ m ] = PrevMatrixElementVal[ i][ j ][ k ][ m ] +
      matrixElementDeltaVal[ i][ j ][ k ][ m ]
The following applies:
  if( gfv_base_pic_flag )
    PrevMatrixElementVal[ i][ j ][ k ][ m ] = BaseMatrixElementVal[ i][ j ][ k ][ m ] =
      matrixElementVal[ i][ j ][ k ][ m ]
  else
    PrevMatrixElementVal[ i][ j ][ k ][ m ] = matrixElementVal[ i][ j ][ k ][ m ]
```

For a particular gfv_id value, the generation process is invoked in increasing order of gfv_cnt to generate a video picture per each GFV SEI message that has gfv_base_pic_flag equal to 0 and a unique value of gfv_cnt within a picture unit.

The output order of GFV-generated pictures corresponding to the GFV SEI messages in a picture unit with the same gfv_id value and different gfv_cnt values shall be in increasing order of the gfv_cnt values. For any two pictures picA and picB wherein picA precedes picB in output order, any GFV-generated picture corresponding to a GFV SEI message with a particular gfv_id value and associated with picA shall precede, in output order, any GFV-generated picture corresponding to a GFV SEI message with the particular gfv_id value and associated with picB.

In order to allow signal multiple GFV SEI messages with different payload contents within in picture unit, the constraint is modified as follows (the modifications to the existing proposal are italicized).

The following applies on the content of scalable-nested and non-scalable-nested SEI messages applying to the same OLS or layer. When there are multiple SEI messages with a particular value of payloadType not equal to any of 4, 5, 133, 210, 211, N1 (N1 is the payload type value of GFV SEI message) and N2 (N2 is the payload type value of GFVE SEI message) that are associated with a particular AU or DU and apply to a particular OLS, layer, or subpicture, regardless of whether some or all of these SEI messages are scalable-nested, the SEI messages shall have the same SEI payload content. When there are multiple SEI messages with payloadType equal to 211 and the same nnpfa_target_id value that are associated with a particular AU or DU and apply to a particular OLS or layer, regardless of whether some or all of these SEI messages are scalable-nested, the SEI messages shall have the same SEI payload content.

Generative face video enhancement (GFVE) SEI message is to signal the enhancement information to enhance the face picture generated by the associated GFV SEI message. The prediction scheme is also used in the signaling of GFVE SEI message where the matrix information is only signaled in the GFVE SEI with base picture flag equal to 1, and for the following GFVE SEI message, there is no need to signal those information (including gfve_matrix_element_precision_factor_minus1, gfve_num_matrices_minus1, gfve_matrix_height_minus1[i] and gfve_matrix_width_minus1[i]).

gfve_matrix_element_precision_factor_minus1 plus 1 indicates quantization factor of matrix elements signalled in the SEI message. The value of gfve_matrix_element_precision_factor_minus1 shall be in the range of 0 to 31, inclusive. When gfve_matrix_present_flag is equal to 1, and gfve_matrix_pred_flag is equal to 1, the value of gfve_matrix_element_precision_factor_minus1 is inferred to be equal to the gfve_matrix_element_precision_factor_minus1 of the previous GFVE SEI message in decoding order with the same gfve_id as the current GFVE SEI message and gfve_base_pic_flag equal to 1. The modifications to the existing semantics are italicized.

gfve_num_matrices_minus1 plus 1 specifies the number of matrices signalled in the SEI message. The value of gfve_num_matrices_minus1 shall be in the range of 0 to 2¹⁰−1, inclusive. When gfve_matrix_present_flag is equal to 1, and gfve_matrix_pred_flag is equal to 1, the value of gfve_num_matrices_minus1 is inferred to be equal to the gfve_num_matrices_minus1 of the previous GFVE SEI message in decoding order with the same gfve_id as the current GFVE SEI message and gfve_base_pic_flag equal to 1. The modifications to the existing semantics are italicized.

gfve_matrix_height_minus1[i] plus 1 indicates the height of the i-th matrix. The value of gfve_matrix_height_minus1[i] shall be in the range of 0 to 2¹⁰−1, inclusive. When gfve_matrix_present_flag is equal to 1, and gfve_matrix_pred_flag is equal to 1, the value of gfve_num_matrix_height_minus1 [i] is inferred to be equal to the gfve_num_matrix_height_minus1[i] of the previous GFVE SEI message in decoding order with the same gfve_id as the current GFVE SEI message and gfve_base_pic_flag equal to 1. The modifications to the existing semantics are italicized.

gfve_matrix_width_minus1[i] plus 1 indicates the width of the i-th matrix. The value of gfve_matrix_width_minus1[i] shall be in the range of 0 to 2¹⁰−1, inclusive. When gfve_matrix_present_flag is equal to 1, and gfve_matrix_pred_flag is equal to 1, the value of gfve_num_matrix_width_minus1[i] is inferred to be equal to the gfve_num_matrix_width_minus1[i] of the previous GFVE SEI message in decoding order with the same gfve_id as the current GFVE SEI message and gfve_base_pic_flag equal to 1. The modifications to the existing semantics are italicized.

To allow GFV and GFVE SEI messages to be embedded into HEVC bitstream, the interfaces of GFV and GFVE SEI messages are provided for HEVC. The following table shows the GFV SEI message bitstream where 223 is the payload type of GFV SEI message and 224 is the payload type of GFVE SEI message.

Table 16 provides an example of syntax according to some embodiments.

TABLE 16
An example of General SEI message syntax

Descriptor

```
sei_payload( payloadType, payloadSize ) {
...
  else /* nal_unit_type = = SUFFIX_SEI_NUT */
    if( payloadType = = 3 )
      filler_payload( payloadSize )
    else if( payloadType = = 4 )
      user_data_registered_itu_t_t35( payloadSize )
    else if( payloadType = = 5)
      user_data_unregistered( payloadSize )
    else if( payloadType = = 17)
      progressive_refinement_segment_end( payloadSize )
    else if( payloadType = = 22 )
      post_filter_hint( payloadSize )
    else if( payloadType = = 132)
      decoded_picture_hash( payloadSize )
    else if( payloadType = = 146 )
      coded_region_completion( payloadSize )
    else if( payloadType = = 210 ) /* Specified in Rec. ITU-T H.274 | ISO/IEC
23002-7 */
      nn_post_filter_characteristics( payloadSize )
    else if( payloadType = = 211 ) /* Specified in Rec. ITU-T H.274 | ISO/IEC
23002-7 */
      nn_post_filter_activation( payloadSize )
    else if( payloadType = = 222 ) /* Specified in Rec. ITU-T H.274 | ISO/IEC
23002-7 */
      digitally_signed_content_verification( payloadSize )
    else if( payloadType = = 223 ) /* Specified in Rec. ITU-T H.274 | ISO/IEC
23002-7 */
      generative_face_video( payloadSize )
    else if( payloadType = = 224 ) /* Specified in Rec. ITU-T H.274 | ISO/IEC
23002-7 */
      generative_face_video_enhancement( payloadSize )
    else
      reserved_sei_message( payloadSize )
...
```

For purposes of interpretation of the generative face video SEI message in HEVC, the following variables are specified. CroppedWidth is set equal to (pic_width_in_luma_samples−SubWidthC*(conf_win_right_offset+conf_win_left_offset)) and CroppedHeight is set equal to (pic_height_in_luma_samples−SubHeightC*(conf_win_bottom_offset+conf_win_top_offset)). Luma sample array CroppedYPic and chroma sample arrays CroppedCbPic and CroppedCrPic are set to be the 2-dimensional arrays of decoded sample values of the Y, Cb and Cr components, respectively, of the cropped decoded picture resulting from decoding the picture unit that includes the generative face video SEI message. BitDepth_{y} is set equal to BitDepth_{Y}·BitDepth_{C} is set equal to BitDepth_{C}. ChromaFormatIdc is set equal to chroma_format_idc.

For purposes of interpretation of the generative face video enhancement SEI message, the following variables are specified: CroppedWidth is set equal to (pic_width_in_luma_samples−SubWidthC*(conf_win_right_offset+conf_win_left_offset)) and CroppedHeight is set equal to (pic_height_in_luma_samples−SubHeightC*(conf_win_bottom_offset+conf_win_top_offset)). BitDepth_{Y} is set equal to BitDepth_{Y}. BitDepth_{C} is set equal to BitDepth_{C}. ChromaFormatIdc is set equal to chroma_format_idc.

When GFV and GFVE SEI messages are incorporated into VVC, the SingleLayerSeiList, VclAssociatedSeiList and PicUnitRepConSeiList are extended to included GFV and GFVE SEI message.

To allow GFV and GFVE SEI messages to be embedded into AVC bitstream, the interfaces of GFV and GFVE SEI messages are provided for VVC. The following table shows the GFV SEI message bitstream where 223 is the payload type of GFV SEI message and 224 is the payload type of GFVE SEI message.

Table 17 provides an example of syntax according to some embodiments.

TABLE 17
An example of General SEI message syntax

| | C | Descriptor |
|---|---|---|
| sei_payload( payloadType, payloadSize ) { | | |
| ... | | |
| else if( payloadType = = 216 ) /* Specified in Rec. ITU-T H.274 \| | | |
| ISO/IEC 23002-7 */ | | |
| source_picture_timing_info( payloadSize ) | | |
| else if( payloadType = = 218 ) /* Specified in Rec. ITU-T H.274 \| | | |
| ISO/IEC 23002-7 */ | | |
| modality_info( payloadSize ) | | |
| else if( payloadType = = 220 ) /* Specified in Rec. ITU-T H.274 \| | | |
| ISO/IEC 23002-7 */ | | |
| digitally_signed_content_initialization( payloadSize ) | | |
| else if( payloadType = = 221 ) /* Specified in Rec. ITU-T H.274 \| | | |
| ISO/IEC 23002-7 */ | | |
| digitally_signed_content_selection( payloadSize ) | | |
| else if( payloadType = = 222 ) /* Specified in Rec. ITU-T H.274 \| | | |
| ISO/IEC 23002-7 */ | | |
| digitally_signed_content_verification( payloadSize ) | | |
| else if( payloadType = = 223 ) /* Specified in Rec. ITU-T H.274 \| | | |
| ISO/IEC 23002-7 */ | | |
| generative_face_video( payloadSize ) | | |
| else if( payloadType = = 224 ) /* Specified in Rec. ITU-T H.274 \| | | |
| ISO/IEC 23002-7 */ | | |
| generative_face_video_enhancement( payloadSize ) | | |
| else | | |
| reserved_sei_message( payloadSize ) | 5 | |
| if( !byte_aligned( ) ) { | | |
| bit_equal_to_one /* equal to 1 */ | 5 | f(1) |
| while( !byte_aligned( ) ) | | |
| bit_equal_to_zero /* equal to 0 */ | 5 | f(1) |
| } | | |
| } | | |

For purposes of interpretation of the generative face video SEI message in AVC, the following variables are specified. CroppedWidth and CroppedHeight, set as specified by Equations 7-23 and 7-24, respectively. Luma sample array CroppedYPic and chroma sample arrays CroppedCbPic and CroppedCrPic are set to be the 2-dimensional arrays of decoded sample values of the Y, Cb and Cr components, respectively, of the cropped decoded picture resulting from decoding the picture unit that includes the generative face video SEI message. BitDepthY is set equal to BitDepthY. BitDepthC is set equal to BitDepthC. ChromaFormatIdc is set equal to chroma_format_idc.

For purposes of interpretation of the generative face video enhancement SEI message, the following variables are specified. CroppedWidth and CroppedHeight, set as specified by following equations, respectively.

CroppedWidth=PicWidthInSamples−CropUnitX*(frame_crop_left_offset+frame_crop_right_offset)

CroppedHeight=16*FrameHeightInMbs−CropUnitY*(frame_crop_top_offset+frame_crop_bottom_offset)

BitDepthY is set equal to BitDepthY. BitDepthC is set equal to BitDepthC ChromaFormatIdc is set equal to chroma_format_idc.

If payloadType is equal to 2, 6, 7, 9, 10, 11, 12, 13, 14, 15, 16, 17, 18, 21, 23, 45, 47, 137, 142, 144, 147, 148, 149, 150, 151, 154, 155, 156, 200, 201, 202, 205, 210, 211, 212, 218, 223 or 224, the following applies. If the SEI message is not included in a scalable nesting SEI message, it applies to the dependency representations of the current access unit that have dependency_id equal to 0. The semantics of these SEI messages apply to the bitstream that would be obtained by invoking the bitstream extraction process with dIdTarget equal to 0. All syntax elements and derived variables that are referred to in the semantics are syntax elements and variables for dependency representations with dependency_id equal to 0. All SEI messages that are referred to are SEI messages that apply to dependency representations with dependency_id equal to 0. Otherwise (the SEI message is included in a scalable nesting SEI message), the scalable nesting SEI message containing the SEI message shall have all_layer_representations_in_au_flag equal to 1 or, when all_layer_representations_in_au_flag is equal to 0, all values of sei_quality_id[i] present in the scalable nesting SEI message shall be equal to 0. The SEI message that is included in the scalable nesting SEI message applies to all dependency representations of the current access unit for which dependency_id is equal to any value of sei_dependency_id[i] with i in the range of 0 to num_layer_representations_minus1, inclusive. For each value of i in the range of 0 to num_layer_representations_minus1, inclusive, the semantics apply to the bitstream that would be obtained by invoking the bitstream extraction process with dIdTarget equal to sei_dependency_id[i]. All syntax elements and derived variables that are referred to are syntax elements and variables for dependency representations with dependency_id equal to sei_dependency_id[i]. All SEI messages that are referred to in clause D.2 are SEI messages that apply to dependency representations with dependency_id equal to sei_dependency_id[i].

For the semantics of SEI messages with payloadType in the range of 0 to 23, inclusive, or equal to 45, 47, 137, 142,144,147, 148, 149, 150, 151, 154, 155, 156,200,201,202,205,210, 211, 212, or 218, 223 or 224, SVC sequence parameter set is substituted for sequence parameter set; the parameters of the picture parameter set RBSP and SVC sequence parameter set RBSP that are in effect are specified.

When an SEI NAL unit contains an SEI message with payloadType in the range of 24 to 35, inclusive, it shall not contain any SEI message that has payloadType less than 24 or equal to 45,47, 137, 142, 144, 147, 148, 149, 150, 151, 154, 155, 156,200,201,202,205,210,211,212, or 218, 223 or 224 that is not included in a scalable nesting SEI message, and the first SEI message in the SEI NAL unit shall have payloadType in the range of 24 to 35, inclusive.

The data distribution modeling of generative reconstruction could be inaccurate compared to their original distribution, due to the generative training process. Such an inaccurate data distribution modeling could result in unpleasant subjective distortions, such as color deviation, in final reconstructed videos. To solve the problem of generative color deviation of the generated pictures, it is proposed to utilize channel-wise distribution calibration as a post-processing step after the face picture generation, which can leverage the distribution parameters of decoded picture to adjust the color distribution of generated inter frames. Similar with the facial parameters used in the face picture generation, the indication of the color calibration and information used in the color calibration can also be signaled in the SEI message.

In some embodiments, a flag is signaled in the SEI message to indicate whether color calibration is applied to the picture generated with the current SEI message (namely the current generated picture). And this flag is only signaled when the current GFV SEI message does not correspond to the base picture. If the flag is true, the color calibration is applied. The calibration can be based on the current decoded picture. In another embodiment, a flag is signaled in the SEI message to indicate whether the current decoded picture is used for calibration. If the flag is true, the color calibration is applied on the current generated picture by using the current decoded picture. For example, the decoded picture is analyzed and the mean and variance of each color component of the decoded picture is calculated. Then based on the mean and variance, the sample values of the generated picture are adjusted so that the generated picture has the same mean and variance of the sample values with the decoded picture. In these two embodiments, there is no additional information to be signaled as the calibration parameters are derived from the decoded picture by the decoder. The syntax and semantics are as follows.

TABLE 18
Exemplary syntax for color calibration

| | Descriptor |
|---|---|
| generative_face_video ( payloadSize ) { | |
| ... | |
| if(!gfv_base_pic_flag) | |
| gfv_colour_calibration_flag | u(1) |

gfv_colour_calibration_flag equal to 1 indicates that the color calibration is applied on the generated picture output by GenerativeNN( ). gfv_colour_calibration_flag equal to 1 indicates that the color calibration is not applied on the generated picture output by GenerativeNN( ). When not present, the value of gfv_colour_calibration_flag is inferred to be 0.

Alternatively, gfv_colour_calibration_flag equal to 1 indicates that the current decoded picture is used for colour calibration of the generated pictures output by GenerativeNN( ). gfv_colour_calibration_flag equal to 0 indicates that the current decoded picture may or may not be used for colour calibration of the generated pictures output by GenerativeNN( ).

However, as the decoded pictures have coding distortion, the calibration parameters derived from the decoded picture may not be accurate. In another embodiment, the calibration parameters are determined by the encoder and signaled in the SEI message. As the encoder can derive the calibration parameters from the original pictures, the accuracy of the calibration parameters increases. The calibration parameters derived in this embodiment, for example, can be the mean and variance of sample values for each color component. In this embodiment, if the GFV SEI message does not correspond to a base picture, a flag is signaled to indicate whether the color parameters for calibration are present in the SEI message or not. If the flag is equal to 1, the color parameters for calibration is signaled. And then in the decoder side, after generation the picture, the decoder applies color calibration on the generated picture by with the calibration parameters signalled in the SEI message. The syntax and the semantics are as follows.

TABLE 19
Exemplary syntax for color calibration

| | Descriptor |
|---|---|
| generative_face_video ( payloadSize ) { | |
| ... | |
| if(!gfv_base_pic_flag){ | |
| gfv_colour_calibration_flag | u(1) |
| if ( gfv_colour_calibration_flag ) { | |
| for ( i=0; i < 3; i++ ) { | |
| gfv_colour_mean [i] | ue(v) |
| gfv_colour_var[i] | ue(v) |
| } | |
| } | |
| } | |
| ... | |

gfv_colour_calibration_flag equal to 1 indicates that the colour calibration is applied on the current generated picture output by GenerativeNN( ). gfv_colour_calibration_flag equal to 1 indicates that the colour calibration is not applied on the current generated picture output by GenerativeNN( ). When not present, the value of gfv_colour_calibration_flag is inferred to be 0.

gfv_colour_mean [i] is the mean of the sample values for the i-th color component used for colour calibration. The value of gfv_colour_mean [i] shall be in the range of 0 to (1<<bitDepth)−1.

gfv_colour_var [i] is the variance of the sample values for the i-th color component used for colour calibration. The value of gfv_colour_var [i] shall be in the range of 0 to 1<<(bitDepth−1).

In some embodiments, the calibration parameters can be either derived by decoder or signaled in the SEI message. To indicate these two approaches, a calibration mode index is signaled. First, a calibration flag is signaled to indicate whether color calibration is applied or not. If the flag is equal to 1, a calibration mode index is signaled. When the mode index is equal to 1, no calibration information needs to be signaled. The decoder can derive the calibration from the current decoded picture. When the mode index is equal to 2, the calibration parameters of each color component are signaled. The decoder applied the calibration on the current generated picture based on the parameters signaled. In some embodiments, whether the calibration is applied and in which approach the calibration is applied can be jointly indicated. That is, signaling an index in the SEI message. When the index is equal to 0, the color calibration is not applied. When the index is non-zero, the calibration is applied to the current generated picture. When the index is 1, the calibration is applied to the current generated picture but the calibration parameters are not signaled. When the index is 2, the calibration is applied to the current generated picture and the calibration parameters are signaled.

TABLE 20
Exemplary syntax for color calibration

| | Descriptor |
|---|---|
| generative_face_video ( payloadSize ) { | |
| gfv_id | ue(v) |
| gfv_cnt | ue(v) |
| ... | |
| gfv_colour_calibration_flag | u(1) |
| if ( gfv_colour_calibration_flag ) { | |
| gfv_colour_calibration_idc | u(3) |
| if ( gfv_coluor_calibration_idc == 1 ) { | |
| gfv_colour_bitdepth_minus8 | ue(v) |
| for ( i=0; i < 3; i++ ) { | |
| gfv_colour_mean [i] | u(v) |
| gfv_colour_var[i] | ue(v) |
| } | |
| } | |
| ... | |

gfv_colour_calibration_flag equal to 1 indicates that the colour calibration is applied on the generated picture output by GenerativeNN( ). gfv_colour_calibration_flag equal to 1 indicates that the colour calibration is not applied on the generated picture output by GenerativeNN( ).

gfv_colour_calibration_idc equal to 1 indicates the parameters of the colour calibration applied to the current generated picture is unspecified and colour calibration applied to the current generated picture is not defined.

gfv_colour_calibration_idc equal to 2 indicates the parameters of the colour calibration applied to the current generated picture may be derived based on the current decoded picture and the colour calibration applied to the current generated picture is based on the parameters derived from the current decoded picture. gfv_colour_calibration_idc equal to 3 indicates and the parameters of the colour calibration applied to the current generated picture are signalled and the colour calibration applied to the current generated picture is based on the calibration parameters signaled.

gfv_colour_bitdepth_minus8 plus 8 specifies the length, in bits, of the gfv_colour_mean [i] syntax element. The value of shall be in the range of 0 to 8.

gfv_colour_mean [i] is the mean of the sample values for the i-th colour component used for colour calibration.

gfv_colour_var [i] is the variance of the sample values for the i-th colour component used for colour calibration. The value of gfv_colour_var [i] shall be in the range of 0 to 1<<(bitDepth−1).

The calibration parameters derived based on the current decoded pictures can be mean and variance of sample values of each colour component. Denote the width of the decoded picture and generated picture as picWidth, the height of the decoded picture and generated picture as picHeight, the mean of the decoded picture as m₀, the variance of the decoded picture as v₀, and the mean of generated picture as mi, and the variance of the generated picture vi are derived as follows:

```
m₀ = 0
v₀ = 0
m₁ = 0
v₁ = 0
for ( x = 0; x< picWidth; x++ )
  for( y = 0; y< picHeight; y++ ) {
    m₀ = m₀ + d[ x ][ y ]
    m₁ = m₁ + g[ x ][ y ]
}
m₀ = m₀ ÷ (picWidth × picHeight)
m₀ = m₀ ÷ (picWidth × picHeight)
for ( x = 0; x< picWidth; x++ )
  for( y = 0; y< picHeight; y++ ) {
    v₀ = v₀ + (d[ x ][ y ] − m₀) × (d[ x ][ y ] − m₀)
    v₁ = v₁ + (g[ x ][ y ] − m₁) × (g[ x ][ y ] − m₁)
}
v₀ = (v₀÷ (picWidth × picHeight))^{1/2}
v₁ = (v₁÷ (picWidth × picHeight))^{1/2}
```

where d[x][y] is the value of the sample at (x, y) of the decoded picture for a certain color component, and g[x][y] is the value of the sample at (x, y) of the generated picture for a certain color component.

After parameter derivation, the following process is to adjust the sample value of generated picture to align the mean and variance of the generated picture with the mean and variance of the decoded picture.

```
for ( x = 0; x< picWidth; x++ )
  for( y = 0; y< picHeight; y++ ) {
    c[x][y] = (g[x][y] − m1) ÷ v₁ × v₀ + m₀
}
```

where c[x][y] is the sample value after color calibration.

In some embodiments, a non-transitory computer-readable storage medium storing a bitstream is also provided. The bitstream can be encoded and decoded according to the above-described generative face video supplemental enhancement information (SEI) messages (e.g., as shown in method 500 and 600 in FIG. 5 and FIG. 6). As explained above, the bitstream can be generated based on an input video sequence, and stored in a non-transitory computer-readable medium. The bitstream stored in the non-transitory computer-readable storage medium includes the SEI message including one or more face information parameters, and an identifying number indicator for identifying the SEI message and indicating whether the SEI message matches with a generative network. At least one of the one or more face information parameters can be used for reconstructing a face picture using the generative network. In some embodiments, the bitstream may include a syntax element of the SEI message signaling one or more normalized values of one or more keypoint coordinates.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

The embodiments may further be described using the following clauses:
1. A method for decoding a bitstream, the method comprising:
receiving a bitstream; and
decoding, using coded information of the bitstream, one or more pictures,
wherein the decoding of the one or more pictures comprises:
   determining whether a generative face video supplemental enhancement information (SEI) message matches with a generative network; and
   in response to the generative face video SEI message matches with the generative network, decoding the SEI message, wherein the decoding of the SEI message comprises:
      determining a face information parameter and a base picture associated with the SEI message; and
      reconstructing a face picture based on the face information parameter and the base picture.
2. The method of clause 1, wherein the decoding of the SEI message comprises:
decoding a syntax element of the SEI message signaling one or more normalized values of one or more keypoint coordinates.
3. The method of clause 1 or 2, wherein the decoding of the SEI message comprises:
decoding a syntax element of the SEI message signaling a difference between a first coordinate of a first keypoint and a second coordinate of a second keypoint.
4. The method of any of clauses 1-3, wherein the decoding of the SEI message comprises:
decoding a first syntax element of the SEI message signaling an integer part of a matrix element in a facial matrix and a second syntax element of the SEI message signaling a decimal part of the matrix element in the facial matrix.
5. The method of any of clauses 1-4, wherein the reconstructing of the face picture comprising:
reconstructing the face picture based on one or more normalized keypoint coordinates in the SEI message, a picture width, a picture height, and a maximum z-axis value inputted to the generative network.
6. The method of any of clauses 1-5, wherein the decoding of the SEI message comprises:
decoding a syntax element of the SEI message signaling a flag indicating whether a current output picture corresponds to a base picture.
7. The method of any of clauses 1-6, wherein the decoding of the SEI message comprises:
decoding a syntax element of the SEI message signaling one or more keypoint coordinates using exponential-golomb code.
8. The method of any of clauses 1-7, wherein the face information parameter associated with the SEI message is representative of a face feature.
9. The method of clause 8, wherein the face feature comprises at least one of a 2D keypoint, a 2D landmark, a 3D keypoint, or a facial semantics.
10. A method for encoding a video sequence into a bitstream, the method comprising:
receiving a video sequence; and
encoding one or more pictures of the video sequence by:
   encoding one or more face information parameters in a supplemental enhancement information (SEI) message; and
   encoding an identifying number indicator for identifying the SEI message and indicating whether the SEI message matches with a generative network;
   wherein at least one of the one or more face information parameters is used for reconstructing a face picture using the generative network.
11. The method of clause 10, wherein the encoding comprises:
coding a syntax element of the SEI message signaling one or more normalized values of one or more keypoint coordinates.
12. The method of clause 10 or 11, wherein the encoding comprises:
coding a syntax element of the SEI message signaling a difference between a first coordinate of a first keypoint and a second coordinate of a second keypoint.
13. The method of any of clauses 10-12, wherein the encoding comprises:
coding a first syntax element of the SEI message signaling an integer part of a matrix element in a facial matrix and a second syntax element of the SEI message signaling a decimal part of the matrix element in the facial matrix.
14. The method of any of clauses 10-13, wherein the face picture is reconstructed based on one or more normalized keypoint coordinates in the SEI message, a picture width, a picture height, and a maximum z-axis value inputted to the generative network.
15. The method of any of clauses 10-14, wherein the encoding comprises:
coding a syntax element of the SEI message signaling a flag indicating whether a current output picture corresponds to a base picture.
16. The method of any of clauses 10-15, wherein the encoding comprises:
coding a syntax element of the SEI message signaling one or more keypoint coordinates using exponential-golomb code.
17. The method of any of clauses 10-16, wherein the face information parameter associated with the SEI message is representative of a face feature.
18. The method of any of clause 17, wherein the face feature comprises at least one of a 2D keypoint, a 2D landmark, a 3D keypoint, or a facial semantics.
19. A method of storing a bitstream of a video, the metho comprising:
generating a bitstream based on an input video sequence, wherein the bitstream comprises:
   a supplemental enhancement information (SEI) message comprising one or more face information parameters, wherein at least one of the one or more face information parameters is used for reconstructing a face picture using a generative network; and
   an identifying number indicator for identifying the SEI message and indicating whether the SEI message matches with the generative network; and storing the bitstream in a non-transitory computer-readable medium.
20. The method of clause 19, wherein the bitstream further comprises:
a syntax element of the SEI message signaling one or more normalized values of one or more keypoint coordinates.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for decoding a bitstream, the method comprising:
receiving a bitstream; and
decoding, using coded information of the bitstream, one or more pictures,
wherein the decoding of the one or more pictures comprises:
determining whether a generative face video supplemental enhancement information (SEI) message matches with a generative network; and
in response to the generative face video SEI message matches with the generative network, decoding the SEI message, wherein the decoding of the SEI message comprises:
determining a face information parameter and a base picture associated with the SEI message; and
reconstructing a face picture based on the face information parameter and the base picture.

2. The method of claim 1, wherein the decoding of the SEI message comprises:
decoding a syntax element of the SEI message signaling one or more normalized values of one or more keypoint coordinates.

3. The method of claim 1, wherein the decoding of the SEI message comprises:
decoding a syntax element of the SEI message signaling a difference between a first coordinate of a first keypoint and a second coordinate of a second keypoint.

4. The method of claim 1, wherein the decoding of the SEI message comprises:
decoding a first syntax element of the SEI message signaling an integer part of a matrix element in a facial matrix and a second syntax element of the SEI message signaling a decimal part of the matrix element in the facial matrix.

5. The method of claim 1, wherein the reconstructing of the face picture comprising:
reconstructing the face picture based on one or more normalized keypoint coordinates in the SEI message, a picture width, a picture height, and a maximum z-axis value inputted to the generative network.

6. The method of claim 1, wherein the decoding of the SEI message comprises:
decoding a syntax element of the SEI message signaling a flag indicating whether a current output picture corresponds to a base picture.

7. The method of claim 1, wherein the decoding of the SEI message comprises:
decoding a syntax element of the SEI message signaling one or more keypoint coordinates using exponential-golomb code.

8. The method of claim 1, wherein the face information parameter associated with the SEI message is representative of a face feature.

9. The method of claim 8, wherein the face feature comprises at least one of a 2D keypoint, a 2D landmark, a 3D keypoint, or a facial semantics.

10. A method for encoding a video sequence into a bitstream, the method comprising:
receiving a video sequence; and
encoding one or more pictures of the video sequence by:
encoding one or more face information parameters in a supplemental enhancement information (SEI) message; and
encoding an identifying number indicator for identifying the SEI message and indicating whether the SEI message matches with a generative network;
wherein at least one of the one or more face information parameters is used for reconstructing a face picture using the generative network.

11. The method of claim 10, wherein the encoding comprises:
coding a syntax element of the SEI message signaling one or more normalized values of one or more keypoint coordinates.

12. The method of claim 10, wherein the encoding comprises:
coding a syntax element of the SEI message signaling a difference between a first coordinate of a first keypoint and a second coordinate of a second keypoint.

13. The method of claim 10, wherein the encoding comprises:
coding a first syntax element of the SEI message signaling an integer part of a matrix element in a facial matrix and a second syntax element of the SEI message signaling a decimal part of the matrix element in the facial matrix.

14. The method of claim 10, wherein the face picture is reconstructed based on one or more normalized keypoint coordinates in the SEI message, a picture width, a picture height, and a maximum z-axis value inputted to the generative network.

15. The method of claim 10, wherein the encoding comprises:
coding a syntax element of the SEI message signaling a flag indicating whether a current output picture corresponds to a base picture.

16. The method of claim 10, wherein the encoding comprises:
coding a syntax element of the SEI message signaling one or more keypoint coordinates using exponential-golomb code.

17. The method of claim 10, wherein the face information parameter associated with the SEI message is representative of a face feature.

18. The method of claim 17, wherein the face feature comprises at least one of a 2D keypoint, a 2D landmark, a 3D keypoint, or a facial semantics.

19. A method of storing a bitstream of a video, the method comprising:
generating a bitstream based on an input video sequence, wherein the bitstream comprises:
a supplemental enhancement information (SEI) message comprising one or more face information parameters, wherein at least one of the one or more face information parameters is used for reconstructing a face picture using a generative network; and
an identifying number indicator for identifying the SEI message and indicating whether the SEI message matches with the generative network; and
storing the bitstream in a non-transitory computer-readable medium.

20. The method of claim 19, wherein the bitstream further comprises:
a syntax element of the SEI message signaling one or more normalized values of one or more keypoint coordinates.
